(19) United States
(12) Patent Application Publication
(10) Pub. No.: US 2026/0242174 A1
(43) Pub. Date: Aug. 20, 2026

(54) LIQUID DISCHARGE HEAD AND LIQUID DISCHARGE APPARATUS

(71) Applicants: Shimtaro NAKAMURA, Yokahama, Kanagawa (JP); Keisuke SUGIYAMA, Yokohama, Kanagawa (JP); Shintaro NAKAMURA, Yokohama, Kanagawa (JP); Kei SASAKI, Yokohama, Kanagawa (JP)

(72) Inventors: Shintaro NAKAMURA, Kanagawa (JP); Kei SASAKI, Kanagawa (JP); Shohei SAITO, Kanagawa (JP); Keisuke SUGIYAMA, Kanagawa (JP)

(21) Appl. No.: 19/471,158

(22) PCT Filed: May 30, 2024
(86) PCT No.: PCT/IB2024/055235

§ 371 Date: Sep. 30, 2025

(30) Foreign Application Priority Data
May 31, 2023 (JP) 2023-090506
Apr. 4, 2024 (JP) 2024-060765

(51) Int. Cl. B65H 37/04

(52) U.S. Cl. CPC B65H 37/04; B65H 2301/5142; B65H 2553/80; B65H 2557/20; B65H 2801/24

(57) ABSTRACT

A media processing apparatus includes a liquid applier, a post-processing device, a first liquid storage, a liquid supply portion, and a first liquid-level detector. The liquid applier includes a liquid applying member to apply liquid to a medium. The liquid supply portion includes a distal end connected to the liquid applying member and a base end to be immersed in the liquid stored in the first liquid storage. The first liquid-level detector detects a liquid level of the liquid stored in the first liquid storage. The first liquid-level detector includes first to third liquid-level detecting members. A lower end of the second liquid-level detecting member and a lower end of the third liquid-level detecting member are disposed in substantially a same range including a position of the base end in a vertical direction. A lower end of the first liquid-level detecting member is disposed above substantially the same range.

### TECHNICAL FIELD

The present disclosure relates to a media processing apparatus and an image forming system incorporating the media processing apparatus.

### BACKGROUND ART

Media processing apparatuses are known in the related art that bind sheet-shaped media, on which images are formed by image forming apparatuses, into a bundle of media. Since sheets of paper are widely known as an example of sheet-shaped media, a “sheet bundle” that is a stack of sheets of paper is used as an example of a bundle of sheet-shaped media in the following description. Some media processing apparatuses include a crimper that can perform so-called “crimp binding” without metal binding needles from a viewpoint of resource saving and reduction in environmental load. Specifically, the crimper sandwiches a sheet bundle with serrate binding teeth to press and deform the sheet bundle.

An increased number of sheets of the sheet bundle hamper the binding teeth in biting into the sheet bundle and may cause some sheets to peel off from the bound sheets. Thus, the crimp binding has some difficulties in keeping the sheet bundle bound as appropriate. Accordingly, some media processing apparatuses that performs crimp binding include a liquid applying processing unit that applies liquid in an amount corresponding to the number of sheets to be bound to a position (hereinafter referred to as a “binding position”) where the binding teeth contact the sheet bundle in order to facilitate the binding teeth to bite into the sheet bundle (see, for example, Patent Literature (PTL) 1).

In the media processing apparatus of PTL 1, a liquid-level sensor that detects the amount of treatment liquid flowing into a storage container is disposed for the purpose of making the amount of treatment liquid applied constant by detecting the amount of liquid in the storage container and controlling the height of liquid level. The liquid-level sensor detects the height of liquid level by the current flowing when a voltage is applied to the electrode pins.

### CITATION LIST

### Patent Literature

[PTL 1]

Japanese Unexamined Patent Application Publication No. 2018-8264

### SUMMARY OF INVENTION

### Technical Problem

However, since the liquid-level sensor of PTL 1 detects the liquid level in a container different from the storage container accommodating a liquid supply roller, it is difficult to say that the liquid-level sensor can accurately detect whether the liquid supply roller is immersed in the liquid in the storage container.

The present disclosure has been made to solve the above-mentioned problem, and an object of the present disclosure is to provide a technique for appropriately detecting whether a base end of a liquid supply portion is immersed in liquid in a media processing apparatus that applies the liquid to a medium by a liquid applier including a liquid applying member to which the liquid is supplied through the liquid supply portion.

### Solution to Problem

In order to solve the above-described problem, one aspect of the present disclosure provides a media processing apparatus includes a liquid applier, a post-processing device, a first liquid storage, a liquid supply portion, and a first liquid-level detector. The liquid applier includes a liquid applying member to apply liquid to a medium. The post-processing device processes a plurality of media including the medium to which the liquid has been applied by the liquid applier. The first liquid storage stores the liquid applied to the medium by the liquid applier. The liquid supply portion includes a distal end connected to the liquid applying member and a base end to be immersed in the liquid stored in the first liquid storage. The first liquid-level detector detects a liquid level of the liquid stored in the first liquid storage. The first liquid-level detector includes a first liquid-level detecting member, a second liquid-level detecting member, and a third liquid-level detecting member. A lower end of the second liquid-level detecting member and a lower end of the third liquid-level detecting member are disposed in substantially a same range including a position of the base end of the liquid supply portion in a vertical direction. A lower end of the first liquid-level detecting member is disposed above substantially the same range.

### Advantageous Effects of Invention

According to the present disclosure, in a media processing apparatus that applies liquid to a medium by a liquid applier including a liquid applying member to which the liquid is supplied through a liquid supply portion, it is possible to appropriately detect whether a base end of the liquid supply portion is immersed in the liquid.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a diagram illustrating an overall configuration of an image forming system.

FIG. 2 is a diagram illustrating an internal structure of a post-processing apparatus according to a first embodiment.

FIG. 3 is a schematic view of an edge binder viewed from upstream in a conveyance direction.

FIG. 4 is a schematic view of an edge binder viewed from the side on which a liquid applier is located in a main scanning direction.

FIGS. 5A and 5B are schematic diagrams illustrating a configuration of a crimper of an edge binder.

FIG. 6 is a schematic view of a staple binder viewed from upstream in a conveyance direction.

FIG. 7 is a schematic view of a staple binder according to a modification, viewed from upstream in a conveyance direction.

FIG. 8 is a diagram illustrating a hardware configuration for executing a control process executed in a post-processing apparatus.

FIG. 9 is a flowchart of a binding process performed by an edge binder.

FIGS. 10A, 10B, and 10C are diagrams illustrating the positions of a liquid applier and a crimper during a binding process by an edge binder.

FIGS. 11A and 11B are diagrams each illustrating a location and configuration of a second liquid storage tank in a post-processing apparatus.

FIG. 12 is a diagram illustrating a configuration in which a second liquid storage tank in a post-processing apparatus is detachably attached to a second-liquid-storage-tank fixer and a configuration in which the second liquid storage tank is replenished with liquid.

FIG. 13 is a diagram illustrating a configuration of a liquid applier.

FIGS. 14A, 14B, 14C, and 14D are diagrams illustrating a change in liquid level of a first liquid storage and detection of the liquid level.

FIGS. 15A and 15B are diagrams illustrating an arrangement of a liquid-level detecting member of a first liquid storage.

FIGS. 16A, 16B, 16C, and 16D are diagrams illustrating the presence or absence of liquid absorbed in a first liquid supply portion and a configuration of a liquid-level detecting member.

FIG. 17 including FIGS. 17A and 17B is a flowchart of filling supply control.

FIG. 18 is a flowchart of additional supply control.

FIG. 19 is a flowchart of liquid supply operation selection.

FIG. 20 is a flowchart of an operation of checking the failure of a liquid-level detecting member.

FIGS. 21A and 21B are diagrams illustrating a configuration of a liquid-level detector of a second-liquid-storage-tank fixer.

FIG. 22 is a flowchart of a control of liquid supply from a second liquid storage tank to a first liquid storage tank.

FIG. 23 is a diagram illustrating a method of determining whether liquid is usable and a method of setting a threshold value used for the determination.

FIG. 24 is a flowchart of liquid refill notification control.

FIG. 25 is a flowchart of liquid supply operation check.

FIGS. 26A and 26B are diagrams illustrating an outline of a liquid discharge operation which is one of liquid supply-and-discharge modes.

FIG. 27 is a flowchart illustrating a process of control of a liquid discharge operation.

FIG. 28 is a detailed flowchart of liquid discharge control.

FIG. 29 is a diagram illustrating an example of a selection input screen of a liquid supply mode.

FIG. 30 is a schematic view of an edge binder according to another embodiment.

FIG. 31 is a schematic view of a configuration of a liquid applier pivot assembly.

FIG. 32 is a schematic view of a configuration of a liquid applier pivot assembly.

FIGS. 33A and 33B are diagrams illustrating a configuration of a posture changing member.

FIGS. 34A, 34B, 34C, 34D, 34E, and 34F are diagrams illustrating a changing operation of a posture changing lever by a posture changing member.

FIGS. 35A, 35B, 35C, 35D, 35E, 35F, 35G, and 35H are diagrams illustrating an operation of changing a crimper and a liquid applier to an inclined binding posture and an inclined application posture, respectively.

FIGS. 36A, 36B, 36C, and 36D are diagrams illustrating an operation of changing a crimper and a liquid applier to a parallel binding posture and a parallel application posture, respectively.

FIGS. 37A, 37B, 37C, 37D, and 37E are diagrams illustrating an operation of parallel binding by a crimper and a liquid applier.

FIG. 38 is a diagram illustrating an internal structure of a post-processing apparatus according to a second embodiment.

FIGS. 39A, 39B, and 39C are schematic views of an internal tray according to the second embodiment, viewed from a thickness direction of a sheet.

FIG. 40 is a schematic view of a crimper according to the second embodiment, viewed from upstream in a conveyance direction.

FIGS. 41A and 41B are schematic views of a liquid applier according to the second embodiment, viewed from a thickness direction of a sheet.

FIGS. 42A, 42B, and 42C are cross-sectional views of the liquid applier taken along a line XXV-XXV of FIG. 41A;

FIGS. 43A, 43B, and 43C are cross-sectional views of the liquid applier taken along a line XXVI-XXVI of FIG. 41A.

FIG. 44 is a block diagram illustrating a hardware configuration of a control block of the post-processing apparatus according to the second embodiment.

FIG. 45 is a flowchart of post-processing of the post-processing apparatus according to the second embodiment.

FIG. 46 is a diagram illustrating an overall configuration of an image forming system according to a modification.

FIGS. 47A and 47B are schematic views of a post-processing apparatus including controllers according to a first modification.

FIGS. 48A and 48B are schematic views of a post-processing apparatus including controllers according to a second modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. Referring now to the drawings, embodiments of the present disclosure are described below. As used herein, the singular forms “a,” “an,” and “the” are intended to include the plural forms as well, unless the context clearly indicates otherwise. Hereinafter, a liquid discharge head according to an embodiment of the present disclosure provided in a liquid discharge apparatus will be described.

The present disclosure is not limited to the embodiments described below and may be other embodiments than the embodiments described below. The following embodiments may be modified by, for example, addition, modification, or omission within the scope that would be obvious to one skilled in the art. Any aspect having function and effect according to the present disclosure are included within the scope of the present disclosure.

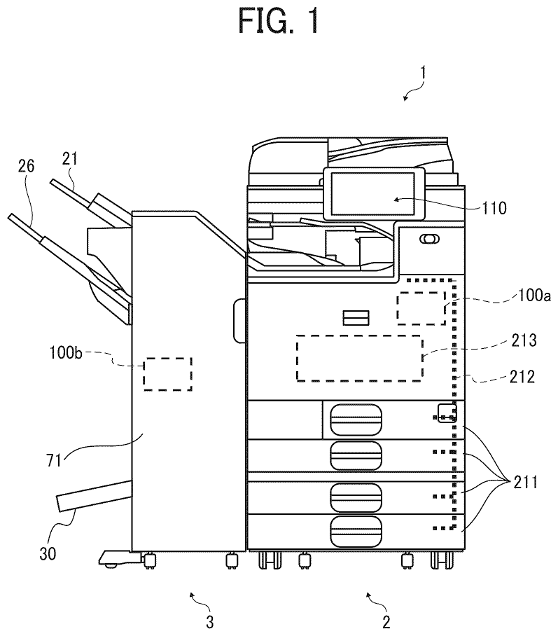

A description is given below of an image forming system 1 according to an embodiment of the present disclosure, with reference to the drawings. FIG. 1 is a schematic view of an overall configuration of the image forming system 1. The image forming system 1 has, for example, an image forming function of forming an image on a sheet P as an example of a sheet-shaped medium and a post-processing function of performing post-processing on the sheet P on which the image has been formed. As illustrated in FIG. 1, the image forming system 1 includes an image forming apparatus 2 having the image forming function and a post-processing apparatus 3 serving as a media processing apparatus having the post-processing function according to an embodiment of the present disclosure. In the image forming system 1, the image forming apparatus 2 and the post-processing apparatus 3 operate in conjunction with each other.

In the present embodiment, the sheet-shaped medium or sheet-shaped medium to be processed in the image forming system 1 is described on the assumption that the medium is a sheet of “paper”. However, the object to be processed according to the present embodiment is not limited to a sheet of paper. For example, any type of medium may be used as long as an image can be formed on the medium according to an image forming process. The medium includes a medium which can be an object of the folding process or the binding process, and the material or the specification is not limited.

The image forming apparatus 2 forms an image on the sheet P and ejects the sheet P having the image to the post-processing apparatus 3. The image forming apparatus 2 includes an accommodation tray 211 that accommodates sheets P, a conveyor 212 that conveys a sheet P from the accommodation tray 211, and an image forming device 213 that forms an image on the sheet P conveyed by the conveyor 212. The image former 213 may be an inkjet system that forms an image using ink or an electrophotographic system that forms an image using toner. The image forming apparatus 2 also includes a controller 100a that controls various operations of the conveyor 212 and the image former 213. Since the image forming apparatus 2 has a typical configuration, a detailed description of the configuration and functions of the image forming apparatus 2 are omitted.

Sheets of paper are widely known as an example of sheet-shaped media. In the following description, a sheet-shaped medium as a medium to be processed is referred to as a “sheet P.” Further, in the following description, a bundle of sheets of paper as a plurality of media is an example of a “sheet bundle Pb.”

A description is given below of a post-processing apparatus 3 according to a first embodiment.

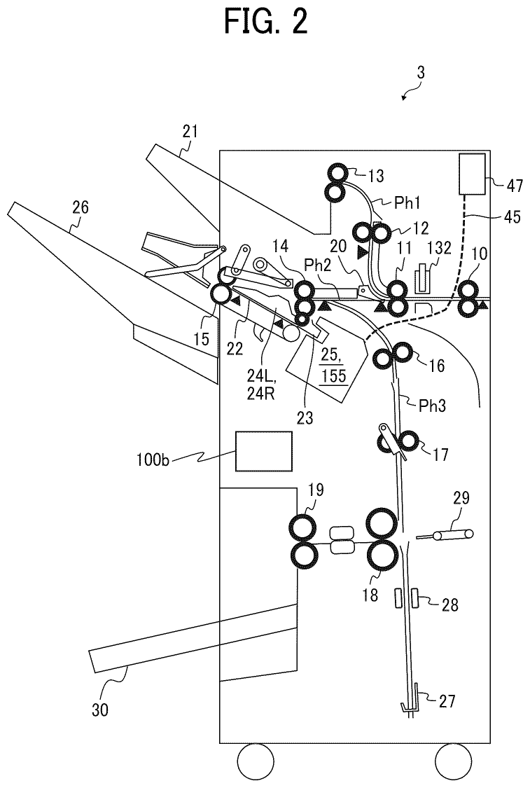

FIG. 2 is a diagram illustrating an internal configuration of the post-processing apparatus 3 according to the first embodiment of the present disclosure. The post-processing apparatus 3 has a function that performs post-processing on the sheet P on which an image is formed by the image forming apparatus 2. An example of the post-processing according to the first embodiment is a binding process as a “crimp binding process” that binds, without staples, a plurality of sheets P on each of which an image is formed as a bundle of sheets, which may be referred to as a sheet bundle. Another example of the post-processing according to the first embodiment is a binding process as a “stapling process” that binds, with staples, a plurality of the sheets P on each of which an image is formed as a bundle of sheets P (i.e., sheet bundle). In the following description, the bundle of sheets may be referred to as a “sheet bundle Pb” as a bundle of media.

In the present embodiment, a description is typically given of liquid application in a crimp binding process. However, liquid application performed in a stapling process is similar to the liquid application in the crimp binding process. In the following description, the term “binding process” indicates both the “crimp binding process” and the “stapling process”, and is not limited to any particular binding method (whether a staple is used or pressing deformation is performed).

More specifically, the “crimp binding process” according to the present embodiment is a process in which pressure is applied to a binding position corresponding to a part of a sheet bundle Pb, the binding position is deformed (pressure-deformed), and the fibers of overlapping sheets P are entangled with each other, thus binding the sheets P together. The crimp binding process partially binds the overlapping portions of the sheets P together to form a sheet bundle Pb. This crimp binding process is hereinafter referred to as “crimp binding”. The binding process ((including both the crimp binding and the staple binding) that is executable by the post-processing apparatus 3 includes edge binding and saddle binding. The edge binding is a process to bind an end (including an edge) of the sheet bundle Pb. The saddle binding (center binding) is a process to bind the center of the sheet bundle Pb.

The post-processing apparatus 3 includes conveyance roller pairs 10 to 19 (an example of conveyors), a switching member 20, and a controller 100b (an example of a control device). The controller 100b controls the operations of, for example, the conveyance roller pairs 10 to 19 (an example of conveyors), and the switching member 20. Details of the controller 100b will be described below. The conveyance roller pairs 10 to 19 convey, inside the post-processing apparatus 3, a sheet P supplied from the image forming apparatus 2. Specifically, the conveyance roller pairs 10 to 13 convey the sheet P along a first conveyance passage Ph1. The conveyance roller pairs 14 and 15 convey the sheet P along a second conveyance passage Ph2. The conveyance roller pairs 16 to 19 convey the sheet P along a third conveyance passage Ph3. A hole punch 132 is disposed between the conveyance roller pairs 10 and 11. The hole punch 132 performs punching on the sheet P conveyed by the conveyance roller pairs 10 and 11.

The first conveyance passage Ph1 is a passage extending to a first ejection tray 21 from a supply port through which the sheet P is supplied from the image forming apparatus 2. The second conveyance passage Ph2 is a passage branching from the first conveyance passage Ph1 between the conveyance roller pairs 11 and 14 in the conveyance direction of the sheet and extending to a second ejection tray 26 via the internal sheet tray 22. The third conveyance passage Ph3 is a passage branching from the first conveyance passage Ph1 between the conveyance roller pairs 11 and 14 in the conveyance direction of the sheet and extending to a third sheet ejection tray 30.

The switching member 20 is disposed at a branching position of the first conveyance passage Ph1 and the second conveyance passage Ph2. The switching member 20 can be switched between a first position and a second position. The switching member 20 in the first position guides the sheet P to be ejected to the first ejection tray 21 through the first conveyance passage Ph1. The switching member 20 in the second position guides the sheet P conveyed through the first conveyance passage Ph1 to the second conveyance passage Ph2. At the timing when the trailing end of the sheet P entering the second conveyance passage Ph2 passes between the rollers of the conveyance roller pair 11, the conveyance roller pair 14 is rotated in the reverse direction so that the sheet P is guided to the third conveyance passage Ph3. The post-processing apparatus 3 further includes a plurality of sensors that detects the positions of the sheet P in the first conveyance passage Ph1, the second conveyance passage Ph2, and the third conveyance passage Ph3. Each of the multiple sensors is indicated by a black triangle in FIG. 2.

The post-processing apparatus 3 includes a first ejection tray 21. The sheet P that is output through the first conveyance passage Ph1 is placed on the first ejection tray 21. Among the sheet P supplied from the image forming apparatus 2, the sheet P on which the binding operation is not performed is ejected to the first ejection tray 21.

The post-processing apparatus 3 further includes the internal tray 22 serving as a placement tray, an edge-binding end fence 23, side fences 24L and 24R, an edge binder 25, a staple binder 155, and a second ejection tray 26. The internal tray 22, the edge-binding end fence 23, the side fences 24L and 24R, the edge binder 25, and the staple binder 155 perform edge binding on the sheet bundle Pb including the multiple sheets P conveyed from the second conveyance path Ph2 to the internal tray 22. Among the sheets P supplied from the image forming apparatus 2, the sheet bundle Pb subjected to the edge binding is ejected to the second ejection tray 26.

The “edge binding process” here means a binding process performed by the edge binder 25 and the staple binder 155. Examples of the “edge binding process” include, but not limited to, “parallel binding process,” “oblique binding process,” and “vertical binding process.” The “parallel binding process” is a process of binding the sheet bundle Pb along one side of the sheet bundle Pb parallel to the main scanning direction. The “oblique binding process” is a process of binding a corner of the sheet bundle Pb. The “vertical binding process” is a process of binding the sheet bundle Pb along one side of the sheet bundle Pb parallel to the conveyance direction.

In the following description, a direction in which the sheet P is conveyed from the conveyance roller pair 15 toward the edge-binding end fence 23 is defined as a “conveyance direction.” In other words, the “conveyance direction” herein corresponds to a direction in which the sheet P that has been output from the image forming apparatus 2 is moved toward the second ejection tray 26 by, for example, the conveyance roller pair 10, is changed to move toward the edge-binding end fence 23 by the conveyance roller pair 15 in a direction different from the above-described direction. The direction that is orthogonal to both the conveyance direction and a thickness direction of the sheet P is defined as a “main scanning direction” or a “width direction of the sheet P.”

The sheets P that are sequentially conveyed through the second conveyance passage Ph2 are temporarily placed on the internal tray 22 serving as a placement tray. The edge-binding end fence 23 aligns the position, in the conveyance direction, of the sheet P or the sheet bundle Pb placed on the internal tray 22. The side fences 24L and 24R align the position, in the main scanning direction, of the sheet P or the sheet bundle Pb placed on the internal tray 22. The edge binder 25 and the staple binder 155 perform edge binding on the sheet bundle Pb aligned by the edge-binding end fence 23 and the side fences 24L and 24R. The conveyance roller pair 15 ejects the sheet bundle Pb subjected to the edge binding to the second ejection tray 26.

The post-processing apparatus 3 further includes a saddle-binding end fence 27, a saddle binder 28, a sheet folding blade 29, and the third ejection tray 30. The saddle-binding end fence 27, the saddle binder 28, and the sheet folding blade 29 perform the saddle binding on the sheet bundle Pb of the sheets P that are conveyed through the third conveyance passage Ph3. Among the sheets P supplied from the image forming apparatus 2, the sheet bundle Pb subjected to the saddle binding is ejected to the third ejection tray 30.

The saddle-binding end fence 27 aligns the positions of the sheets P that are sequentially conveyed through the third conveyance passage Ph3, in a direction in which the sheets P are conveyed. The saddle-binding end fence 27 can move between a binding position where the saddle-binding end fence 27 causes the center of the sheet bundle Pb to face the saddle binder 28 and a folding position where the saddle-binding end fence 27 causes the center of the sheet bundle Pb to face the sheet folding blade 29. The saddle binder 28 binds the center of the sheet bundle Pb aligned by the saddle-binding end fence 27 at the binding position. The sheet folding blade 29 folds, in half, the sheet bundle Pb placed on the saddle-binding end fence 27 at the folding position and causes the conveyance roller pair 18 to nip the sheet bundle Pb. The conveyance roller pairs 18 and 19 eject the sheet bundle Pb subjected to the saddle binding to the third ejection tray 30.

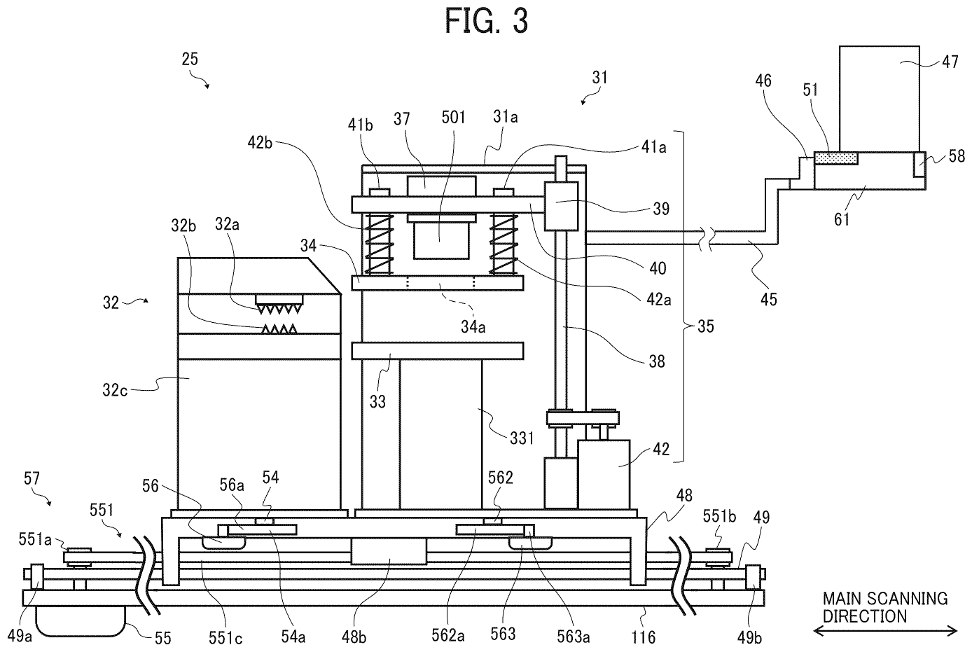

In addition, the post-processing apparatus 3 includes a liquid applying member 501 (a part of the liquid applier), a liquid supply member 50 (a part of the liquid supply portion), and a first liquid storage tank 44 (a first liquid storage) in the edge binder 25. The first liquid storage tank 44 and the liquid supply member 50 are omitted in FIG. 3. The post-processing apparatus 3 includes a liquid supply passage 45 (a part of the liquid supplier), a liquid supply pump 46 (a part of the liquid supplier), a second liquid storage tank 47 (a part of the second liquid storage), and a second-liquid-storage-tank fixer 61 (a part of the second liquid storage) as a configuration for replenishing the first liquid storage tank 44 with the liquid. The liquid that is stored in the second liquid storage tank 47 is supplied to the first liquid storage tank 44 through the second-liquid-storage-tank fixer 61, the liquid supply pump 46, and the liquid supply path 45.

A detailed description is given below of the edge binder 25.

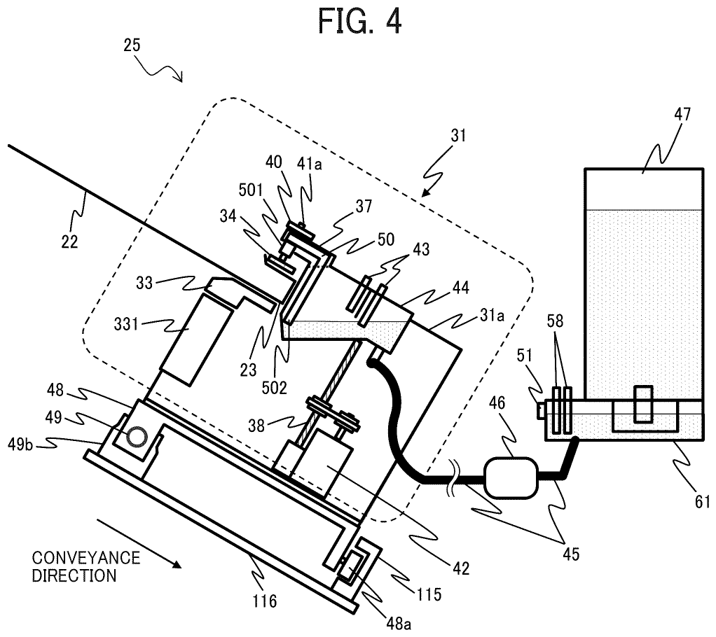

FIG. 3 is a schematic diagram illustrating an upstream side of the edge binder 25 in the conveyance direction. The edge binder 25 performs liquid application and crimp binding illustrated in FIG. 2. FIG. 4 is a schematic view of a liquid applier 31 of the edge binder 25 when viewed from the main scanning direction. As illustrated in FIG. 3, the edge binder 25 includes the liquid applier 31 that applies liquid to the sheet P or the sheet bundle Pb, and a crimper 32 that is an example of a post-processing device and performs crimping binding on the sheet bundle Pb. The liquid applier 31 and the crimper 32 are disposed downstream from the internal tray 22 in the conveyance direction and adjacent to each other in the main scanning direction.

As illustrated in FIG. 4, the liquid applier 31 applies the liquid stored in the first liquid storage tank 44 to the sheet P or the sheet bundle Pb placed on the internal tray 22. The application of the liquid to the sheet P or the sheet bundle Pb by the liquid applier 31 and the operation of the liquid applier 31 in applying the liquid are referred to as “liquid application” below. The liquid applying operation of the liquid applier 31 involving control processing is referred to as a “liquid application process”.

More specifically, the liquid that is stored in the first liquid storage tank 44 as liquid for the “liquid application” includes, as a main component, the liquid state of a compound of hydrogen and oxygen compound represented by the chemical formula H₂O. The liquid hydrogen-oxygen compound is at any temperature. For example, the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid that is stored in the first liquid storage tank 43 may include an additive in addition to the main component. The liquid that is stored in the first liquid storage tank 44 may include residual chlorine used as tap water. Preferably, for example, the liquid that is stored in the first liquid storage tank 44 may include, as an additive, a colorant, a penetrant, a pH adjuster, a preservative such as phenoxyethanol, a drying inhibitor such as glycerin, or a combination thereof. Furthermore, because water is used as a component of ink used for inkjet printers or ink used for water-based pens, such water or ink may be used for the “liquid application”.

The water is not limited to the specific examples described above. The water may be water in a broad sense such as hypochlorous acid water or an ethanol aqueous solution diluted for disinfection. However, tap water may be used simply to enhance the binding strength after the binding process because tap water is easy to obtain and store. A liquid including water as a main component as exemplified above enhances the binding strength of the sheet bundle Pb, as compared with a liquid of which the main component is not water.

A description is given of a configuration of the liquid applier 31.

As illustrated in FIGS. 3 and 4, the liquid applier 31 is movable in the main scanning direction together with the crimper 32 by a driving force transmitted from an edge binder movement motor 55. The liquid applier 31 includes a lower pressure plate 33 serving as a receptacle for the sheet P or the sheet bundle Pb, an upper pressure plate 34, and a liquid-applier movement assembly 35. The components of the liquid applier 31 (the lower pressure plate 33, the upper pressure plate 34, the liquid-applier movement assembly 35, and the liquid-applier movement motor 42) are held by the liquid application frame 31a and the base 48.

A liquid applier shaft 562 including a drive transmission gear 562a is fixed to a bottom face of the liquid application frame 31a that holds the components of the liquid applier 31. The liquid applier shaft 562 and the drive transmission gear 562a are held by the base 48 on which the liquid application frame 31a is disposed, so as to be rotatable in the forward and reverse directions. The drive transmission gear 562a meshes with an output gear 563a of a liquid applier pivot motor 563. The liquid applier 31 can be rotated in the forward and reverse directions about the liquid applier shaft 562 on the base 48 by a driving force transmitted from the liquid applier pivot motor 563 to the liquid applier shaft 562 via the output gear 563a and the drive transmission gear 562a.

The lower pressure plate 33 and the upper pressure plate 34 are disposed downstream from the internal tray 22 in the conveyance direction. The sheets P or the sheet bundle Pb that is placed on the internal tray 22 is also placed on the lower pressure plate 33. The lower pressure plate 33 is disposed on a lower pressure plate holder 331. The upper pressure plate 34 is movable in the thickness direction of the sheet P or the sheet bundle Pb at a position where the upper pressure plate 34 faces the sheet P or the sheet bundle Pb placed on the internal tray 22. In other words, the lower pressure plate 33 and the upper pressure plate 34 are disposed to face each other in the thickness direction of the sheet P or the sheet bundle Pb with the sheet P or the sheet bundle Pb placed on the internal tray 22 and interposed between the lower pressure plate 33 and the upper pressure plate 34. In the following description, the thickness direction of the sheet P or the sheet bundle Pb may be referred to simply as “thickness direction.” The upper pressure plate 34 has a through hole 34a penetrating in the thickness direction at a position where the through hole 34a faces a liquid applying member 501, which is a part of the liquid applier 31, held via a holder 37 attached to a base plate 40. The liquid applying member 501 is one end portion of a liquid supply member 50 (liquid absorber) described below and corresponds to a tip portion of the liquid supply member 50.

The liquid-applier movement assembly 35 moves the upper pressure plate 34, the base plate 40, the holder 37, the liquid applying member 501, the liquid supply member 50, and the first liquid storage tank 44 in the thickness direction of the sheet P or the sheet bundle Pb. The liquid-applier movement assembly 35 according to the present embodiment moves the upper pressure plate 34, the base plate 40, the holder 37, the liquid applying member 501, the liquid supply member 50, and the first liquid storage tank 44 in conjunction with each other with a single liquid-applier movement motor 42. The liquid-applier movement assembly 35 includes, for example, a liquid-applier movement motor 42, a trapezoidal screw 38, a nut 39, the base plate 40, columns 41a and 41b, and coil springs 42a and 42b.

The liquid-applier movement motor 42 generates a driving force to move the upper pressure plate 34, the base plate 40, the holder 37, the liquid applying member 501, the liquid supply member 50, and the first liquid storage tank 44. The trapezoidal screw 38 extends in the thickness direction of the sheet P or the sheet bundle Pb and is supported to the liquid application frame 31a such that the trapezoidal screw 38 is rotatable in the forward and reverse directions. The trapezoidal screw 38 is coupled to an output shaft of the liquid-applier movement motor 42 via, for example, a pulley and a belt. The nut 39 is screwed to the trapezoidal screw 38. The trapezoidal screw 38 is rotated in the forward and reverse directions by the driving force transmitted from the liquid-applier movement motor 42. The rotation of the trapezoidal screw 38 causes the nut 39 to reciprocate on the trapezoidal screw 38.

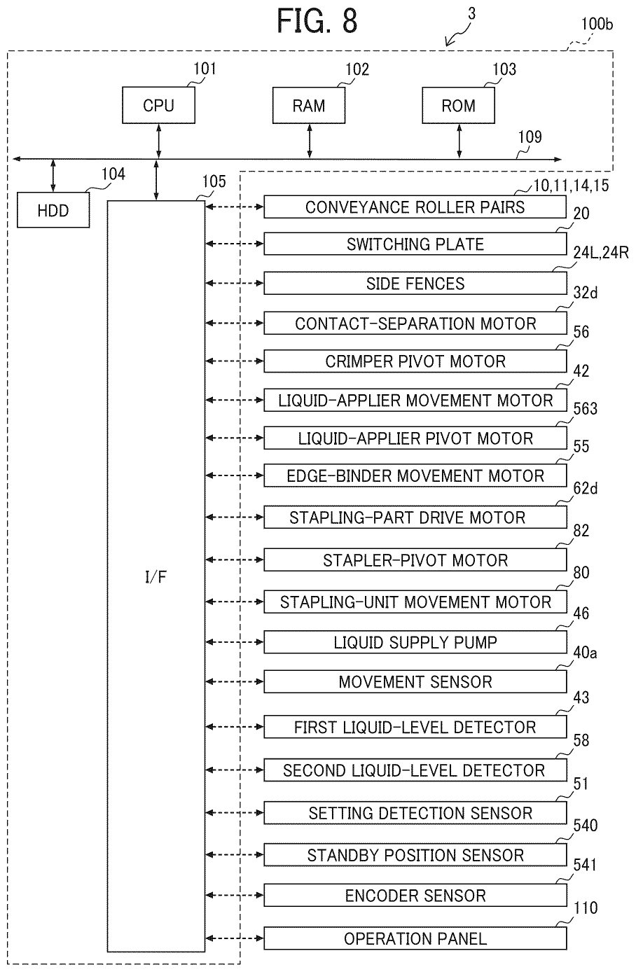

The base plate 40 is positioned apart from the upper pressure plate 34. The base plate 40 holds the liquid applying member 501 with the tip portion of the liquid applying member 501 protruding from the base plate 40 toward the upper pressure plate 34. The base plate 40 is coupled to the trapezoidal screw 38 via the nut 39 such that base plate 40 can reciprocate along the trapezoidal screw 38 as the trapezoidal screw 38 rotates in the forward and reverse directions. The position of the base plate 40 in the thickness direction of the sheet P or the sheet bundle Pb is detected by a movement sensor 40a (see FIG. 8).

The columns 41a and 41b project from the base plate 40 toward the upper pressure plate 34 around the tip portion of the liquid applying member 501. The columns 41a and 41b can relatively move with respect to the base plate 40 in the thickness direction. The columns 41a and 41b hold the upper pressure plate 34 with the respective ends closer to the lower pressure plate 33 than the other ends of the columns 41a and 41b. The other ends of the columns 41a and 41b opposite the ends closer to the lower pressure plate 33 are provided with stoppers that prevent the columns 41a and 41b from being removed from the base plate 40. The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid applier 31 applies liquid to the sheet P or the sheet bundle Pb placed on the internal tray 22. Specifically, the liquid applier 31 brings the liquid applying member 501 into contact with the sheet P or the sheet bundle Pb to apply the liquid to at least one sheet P of the sheet bundle Pb.

The liquid applier 31 includes a first liquid-level detector 43 (an example of a first liquid-level detector), a first liquid storage tank 44, a liquid applying member 501, a liquid supply member 50, and a holder 37. The first liquid storage tank 44 stores the liquid to be applied to the sheet P or the sheet bundle Pb. The liquid stored in the first liquid storage tank 44 is detected by the first liquid-level detector 43. The first liquid storage tank 44 is coupled to the base plate 40 via the holder 37.

The liquid applying member 501 applies the liquid stored in the first liquid storage tank 44 to the sheet P or the sheet bundle Pb. The liquid applying member 501, the liquid supply member 50 (liquid absorber) disposed in close contact with the liquid applying member 501, and the first liquid storage tank 44 are held by the holder 37. The holder 37 is held by the base plate 40. The liquid supply member 50 has one end connected to the liquid applying member 501 and the other end immersed in the liquid stored in the first liquid storage tank 44. In other words, the second end of the liquid supply member 50 corresponds to the base end 502 that draws up the liquid and supplies the liquid to the liquid applying member 501. The liquid applying member 501 and the liquid supply member 50 are made of a material (e.g., sponge or fiber) having a high liquid absorption rate, such as an elastic resin formed of open cells. However, at least one of the liquid applying member 501 or the liquid supply member 50 is not limited to a particular kind as long as the at least one of the liquid applying member 501 or the liquid supply member 50 is made of a material having a property of absorbing and holding the liquid and has a property of being crushable in accordance with a pressing force applied when the at least one of the liquid applying member 501 or the liquid supply member 50 is in contact with the sheet P. In other words, the material may be any material as long as the material can absorb or draw up liquid by capillary action.

Accordingly, when the other end portion (the base end 502) of the liquid supply member 50 is immersed in the liquid stored in the first liquid storage tank 44, the liquid supply member 50 sucks up the liquid by capillary action. In other words, the liquid stored in the first liquid storage tank 44 is sucked up from the base end 502 of the liquid supply member 50, and the sucked liquid is supplied to the liquid applying member 501 that is coupled to the tip portion via the liquid supply member 50. Then, the liquid stored in the first liquid storage tank 44 is drawn up to the liquid applying member 501 in close contact with one end portion of the liquid supply member 50, and thus the liquid level (stored liquid amount) of the liquid stored in the first liquid storage tank 44 detected by the first liquid-level detector 43 is lowered. As a result, the liquid is supplied from the second liquid storage tank 47 to the first liquid storage tank 44 by the liquid supply pump 46.

The liquid applying member 501 and the liquid supply member 50 are formed as separate bodies as described above. Thus, the liquid applying member 501 can be attached to the liquid supply member 50. As a result, for example, when the liquid applying member 501 is deformed by the repetition of the liquid applying operation and turns into a state in which an appropriate amount of liquid cannot be applied to the sheet P or the sheet bundle Pb, only the liquid applying member 501 can be replaced. Such a configuration can contribute to reduction in running cost for the user.

Although the case where the liquid supply member 50 and the liquid applying member 501 are separate bodies has been described above, the liquid supply member 50 and the liquid applying member 501 may be integrally formed of a material having the same properties (for example, a material having a high liquid absorption rate). In other words, the liquid applying member 501 may be part of the liquid supply member 50. In such a case, liquid can be supplied from the liquid supply member 50 to the liquid applying member 501 more smoothly by the capillary action and a reduction in cost can be achieved.

At this time, the liquid applying member 501 draws up the liquid stored in the first liquid storage tank 44. By so doing, the amount of liquid (liquid level) in the first liquid storage tank 44 temporarily decreases to the level below the reference liquid level described below. In response to this decrease of liquid in the first liquid storage tank 44, a series of liquid supply operations for feeding liquid from the second liquid storage tank 47 to the first liquid storage tank 44 is performed. This series of liquid supply operations is mainly performed at the time of activation of the post-processing apparatus 3 or at the time of start of execution of the binding processing involving liquid application in the post-processing apparatus 3, and corresponds to the liquid supply operations for bringing the liquid application using the liquid applying member 501 to be executable. In the following description, the liquid supply operation is referred to as a “filling supply operation.” Details of the filling supply operation will be described later.

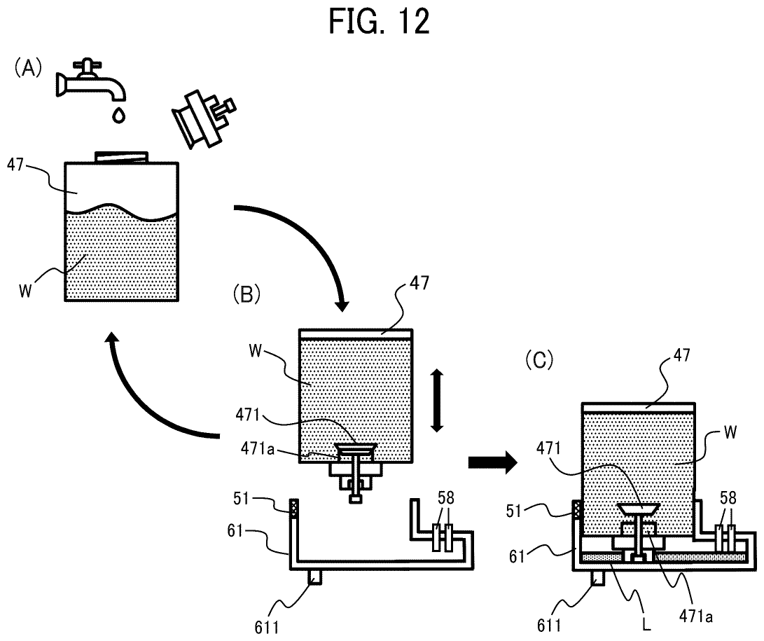

The edge binder 25 or the post-processing apparatus 3 is provided with the second liquid storage tank 47. The second liquid storage tank 47 is detachably attached to the second-liquid-storage-tank fixer 61 (a part of the second liquid storage) disposed in the edge binder 25 or the post-processing apparatus 3 (see FIG. 12). The second liquid storage tank 47 is fixed (set) to the second-liquid-storage-tank fixer 61 (a part of the second liquid storage) at a given position. Thus, the liquid already stored in the second liquid storage tank 47 can be supplied to the first liquid storage tank 44.

The operation to supply liquid from the second liquid storage tank 47 to the first liquid storage tank 44 by the liquid supply pump 46 is executed in response to a decrease in the stored liquid amount (liquid level) in the first liquid storage tank 44. The stored liquid amount (liquid level) of the first liquid storage tank 44 is reduced by the liquid being consumed by liquid application by the liquid applier 31. In other words, the operation of supplying liquid from the second liquid storage tank 47 to the first liquid storage tank 44 corresponds to the liquid supply operation needed for the execution of the job including liquid application by the liquid applier 31.

This liquid supply operation corresponds to an operation of replenishing liquid to the first liquid storage tank 44 so as to add liquid each time the stored liquid amount (liquid level) of the first liquid storage tank 44 falls below a reference liquid level, which is described below. In the following description, the liquid supply operation is referred to as a “additional supply operation.” Details of the additional supply operation will be described later.

When the second liquid storage tank 47 is set in the second-liquid-storage-tank fixer 61, the second-liquid-storage-tank fixer 61 is filled with a certain amount of the liquid in the second liquid storage tank 47. The second-liquid-storage-tank fixer 61 includes a setting detection sensor 51 (an example of a setting detector) (see part (B) of FIG. 12). When the setting detection sensor 51 detects the set state of the second liquid storage tank 47 to the second-liquid-storage-tank fixer 61 (see part (C) of FIG. 12), a signal indicating the set state is transmitted to the controller 100b, which is described below. Thus, the controller 100b detects whether the second liquid storage tank 47 is set on the second-liquid-storage-tank fixer 61.

The first liquid storage tank 44 and the second liquid storage tank 47 are coupled to each other by the liquid supply passage 45. The liquid supply pump 46 is disposed near the second-liquid-storage-tank fixer 61. As the liquid supply pump 46 is driven, the liquid stored in the second liquid storage tank 47 is supplied (replenished) from the second liquid storage tank 47 to the first liquid storage tank 44 via the liquid supply passage 45. Accordingly, the second-liquid-storage-tank fixer 61 is a component of the liquid supplier that executes a liquid supply operation to supply liquid from the second liquid storage tank 47 to the first liquid storage tank 44. The liquid supply passage 45 includes a flexible material. According to such a configuration, even if the first liquid storage tank 44 is moved by the liquid applier movement assembly 35, liquid can be supplied from the second liquid storage tank 47 to the first liquid storage tank 44.

The amount of liquid supplied from the second liquid storage tank 47 to the first liquid storage tank 44 can be controlled in accordance with the detection result of the first liquid-level detector 43. In other words, the controller 100b, which is described below, determines whether the stored liquid amount (liquid level) in the first liquid storage tank 44 based on the detection result of the first liquid-level detector 43. In accordance with the determined stored liquid amount (liquid level) of the first liquid storage tank 44, the controller 100b controls the operation speed and time of the liquid supply pump 46. By so doing, the controller 100b can adjust the amount of liquid to be replenished to the first liquid storage tank 44 to maintain the stored liquid amount (liquid level) in the first liquid storage tank 44 at a constant level of liquid.

A description is given below of the configuration of the crimper 32.

As illustrated in FIG. 3, the crimper 32 as a post-processing device presses and deforms at least a portion (liquid application position) of the sheet bundle Pb, to which liquid has been applied by the liquid applier 31, by serrated upper crimping teeth 32a and lower crimping teeth 32b, and crimps the sheets P of the portion to bind the sheet bundle Pb. In other words, the crimper 32 can bind the sheet bundle Pb without staples. The components of the crimper 32 such as the upper crimping teeth 32a and the lower crimping teeth 32b are disposed on a crimping frame 32c. In the following description, such a way of pressing and deforming a given position on the sheet bundle Pb to bind the sheet bundle Pb may be referred to as “crimp binding.” In other words, the crimper 32 crimps and binds the sheet bundle Pb or performs the crimp binding on the sheet bundle Pb. The crimping and binding operation of the crimper 32 that involves control processing is referred to as “crimp binding process”.

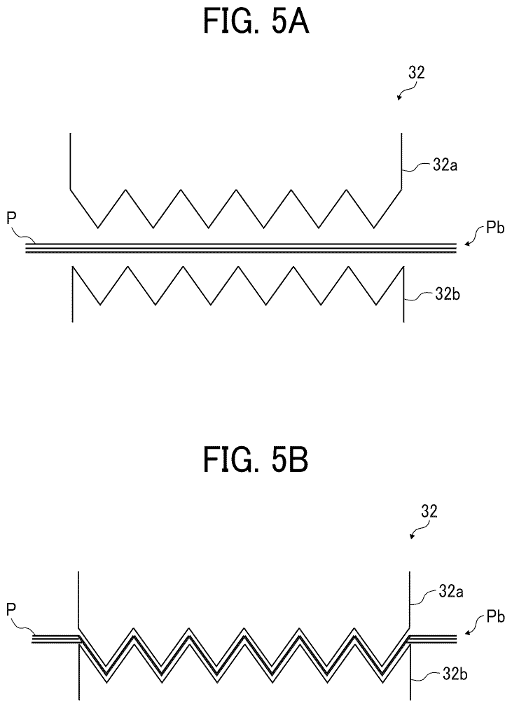

FIGS. 5A and 5B are schematic diagrams illustrating the configuration of the crimper 32. As illustrated in FIGS. 5A and 5B, the crimper 32 includes the upper crimping teeth 32a and the lower crimping teeth 32b. The upper crimping teeth 32a and the lower crimping teeth 32b are disposed to face each other in the thickness direction of the sheet bundle Pb with the sheet bundle Pb supported by the internal tray 22 interposed between the upper crimping teeth 32a and the lower crimping teeth 32b. The upper crimping teeth 32a and the lower crimping teeth 32b have respective serrate faces facing each other. The serrate face of each of the upper crimping teeth 32a and the lower crimping teeth 32b includes concave portions and convex portions alternately formed. The concave portions and the convex portions of the upper crimping teeth 32a are shifted from those of the lower crimping teeth 32b such that the upper crimping teeth 32a are engaged with the lower crimping teeth 32b. The upper crimping teeth 32a and the lower crimping teeth 32b are brought into contact with and separated from each other by the driving force of a contact-separation motor 32d illustrated in FIG. 8.

In the process of supplying the sheets P of the sheet bundle Pb to the internal tray 22, the upper crimping teeth 32a and the lower crimping teeth 32b are separated from each other as illustrated in FIG. 5A. When all the sheets P of the sheet bundle Pb are placed on the internal tray 22, the upper crimping teeth 32a and the lower crimping teeth 32b are engaged with each other as illustrated in FIG. 5B by the driving force of the contact-separation motor 32d to press and deform the sheet bundle Pb in the thickness direction. As a result, the sheet bundle Pb held in the internal tray 22 is crimped and bound. The sheet bundle Pb thus crimped and bound is ejected to the second ejection tray 26 by the conveyance roller pair 15.

The configuration of the crimper 32 as a crimping assembly is not limited to the configuration of a moving assembly exemplified in the present embodiment, and may be any other suitable structure in which the upper crimping teeth 32a and the lower crimping teeth 32b of the crimping assembly engage with each other. For example, the crimping assembly may bring the upper crimping teeth 32a and the lower crimping teeth 32b into contact with each other and separate the upper crimping teeth 32a and the lower crimping teeth 32b from each other with a link mechanism and a driving source that simply rotates in the forward direction or that rotates the forward and backward directions (e.g., the crimping assembly disclosed in Japanese Patent No. 6057167). Alternatively, the crimping assembly may employ a linear motion system to linearly bring the upper crimping teeth 32a and the lower crimping teeth 32b into contact with each other and separate the upper crimping teeth 32a and the lower crimping teeth 32b from each other with a screw assembly that converts the forward and backward rotational motions of a driving source into linear reciprocating motion.

As illustrated in FIG. 3, the edge binder 25 includes an edge binder movement assembly 57. The edge binder movement assembly 57 moves the edge binder 25 (in other words, the liquid applier 31 and the crimper 32) in the main scanning direction along the downstream end of the sheet P, which is placed on the internal tray 22, in the conveyance direction. The edge binder movement assembly 57 includes, for example, the base 48, a guide shaft 49, the edge binder movement motor 55, and a driving force transmission assembly 551 that transmits the driving force of the edge binder movement motor 55 to the base 48, and a standby position sensor 540 (see FIG. 8).

The liquid applier 31 and the crimper 32 are attached to the base 48 such that the liquid applier 31 and the crimper 32 are adjacent to each other in the main scanning direction. As illustrated in FIGS. 3 and 4, the guide shaft 49 is disposed at a position on the upstream side of a binding assembly base 116 in the conveyance direction of the sheet P and is held by multiple guide shaft brackets 49a and 49b at both ends in the main scanning direction. The guide shaft 49 is disposed on the binding assembly base 116 to extend in the main scanning direction, and holds the base 48 to be movable in the main scanning direction. As illustrated in FIG. 4, the guide rail 115 is disposed a downstream end of the binding assembly base 116 in the conveyance direction and extends in the main scanning direction. The guide rail 115 has a to-be-fitted portion 115a that fits a scanning roller 48a, which is rotatably disposed on the base 48, across the main scanning direction. In other words, the base 48 is movably held by the guide shaft 49 and the guide rail 115 in the main scanning direction on the binding assembly base 116.

The edge binder movement motor 55 generates a driving force to move the edge binder 25. The driving force transmission assembly 551 transmits the driving force of the edge binder movement motor 55 to the base 48 via pulleys 551a and 551b, a timing belt 551c, and a fastening portion 48b that fastens the base 48 and the timing belt 551c. As a result, the liquid applier 31 and the crimper 32 integrated by the base 48 move in the main scanning direction along the guide shaft 49.

The edge binder movement motor 55 according to the present embodiment is, for example, a servo motor that can stop the edge binder 25 at a target position (for example, the first binding position B1 and a second binding position B2 described below) without returning the edge binder 25 to an origin position (for example, a standby position HP described below) each time the edge binder 25 is moved.

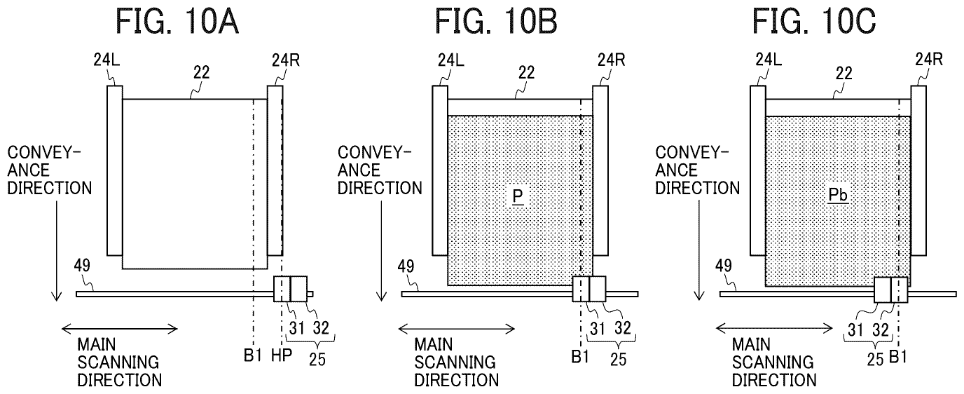

The post-processing apparatus 3 further includes a standby position sensor 540 and an encoder sensor 541. The standby position sensor 540 is, for example, a light-shielding optical sensor (see FIG. 8) to detect that the edge binder 25 has reached a standby position HP (see FIG. 10A). The encoder sensor 541 (see FIG. 8) is attached to an output shaft of the edge binder movement motor 55. The controller 100b, which will be described below, detects that the edge binder 25 has reached the standby position HP, based on a detection result of the standby position sensor 540. The controller 100b also counts pulse signals output from the encoder sensor 541 to ascertain the current position of the edge binder 25 moved from the standby position HP.

However, a specific method of stopping the edge binder 25 at the target position without returning the edge binder 25 to the standby position HP is not limited to the aforementioned example. As another example, the post-processing apparatus 3 may include a sensor that detects that the edge binder 25 has reached a predetermined target position.

As illustrated in FIG. 3, a crimper shaft 54 provided with a drive transmission gear 54a is fixed to a bottom face of the crimping frame 32c that holds the components of the crimper 32. The crimper shaft 54 and the drive transmission gear 54a are held by the base 48 on which the crimping frame 32c is disposed, so as to be rotatable in the forward and reverse directions. The drive transmission gear 54a meshes with an output gear 56a of a crimper pivot motor 56. The crimper 32 can be rotated in the forward and reverse directions about the crimper shaft 54 on the base 48 by a driving force transmitted from the crimper pivot motor 56 to the crimper shaft 54 via the output gear 56a and the drive transmission gear 54a.

In the above description, the edge binder 25 has a configuration of moving along the guide shaft 49 with the crimper 32 and the liquid applier 31 being integrated, the embodiments of the present disclosure are not limited to the above-described configuration. For example, the crimper 32 and the liquid applier 31 may have a configuration of moving separately from each other.

A description is given of a staple binder 155.

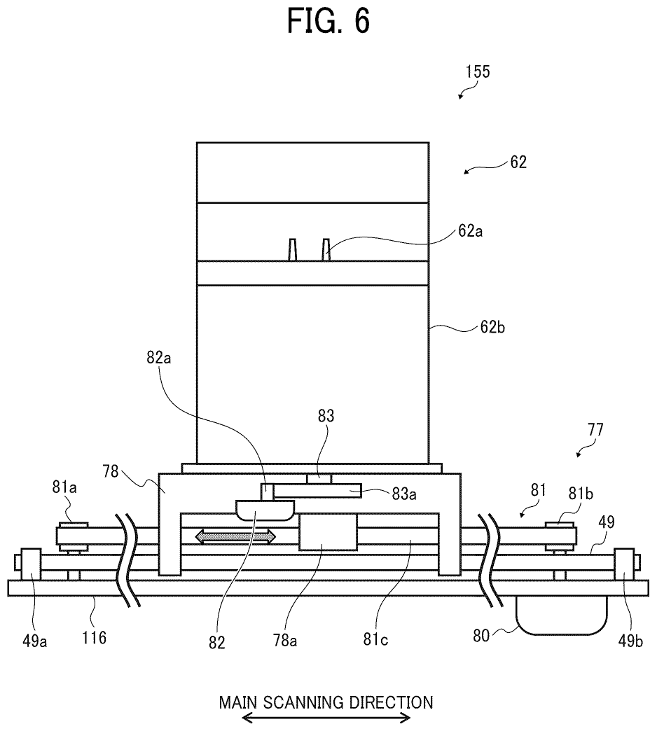

Specifically, a detailed description is now given of the staple binder 155 having a function of executing a stapling process. FIG. 6 is a schematic diagram illustrating the staple binder 155, viewed from the upstream side of the staple binder 155 in the conveyance direction. The staple binder 155 includes a stapler 62 that binds the sheet bundle Pb with staples. The stapler 62 is disposed downstream from the internal tray 22 in the conveyance direction and spaced apart from the edge binder 25 in the main scanning direction.

The stapler 62 serving as a post-processing device has a configuration of performing so-called “stapling” (i.e., stapling process) to bind the sheet bundle Pb with a staple or staples. More specifically, the stapler 62 includes a stapling-part drive motor 62d illustrated in FIG. 8. The stapling-part drive motor 62d drives a stapling part 62a. The driving force of the stapling-part drive motor 62d causes a staple loaded in the stapling part 62a to penetrate through a sheet bundle Pb, so that the stapling part 62a binds the sheet bundle Pb. Since the stapler 62 has a typical configuration, a detailed description thereof will be omitted unless otherwise required.

As illustrated in FIG. 6, the staple binder 155 includes a staple binder movement assembly 77. The staple binder movement assembly 77 moves the staple binder 155 in the main scanning direction along a downstream end in the conveyance direction of the sheet P or the sheet bundle Pb placed on the internal tray 22. The staple binder movement assembly 77 includes, for example, a base 78, the guide shaft 49, a staple binder movement motor 80, and a driving force transmission assembly 81. The driving force transmission assembly 81 transmits a driving force of the staple binder movement motor 80 to the base 78 via pulleys 81a and 81b, a timing belt 81c, and a fastening portion 78a that fastens the base 78 and the timing belt 81c. A stapler shaft 83 including a drive transmission gear 83a is fixed to a bottom face of a stapling frame 62b that holds the components of the stapler 62.

The stapler shaft 83 and the drive transmission gear 83a are held by the base 78 on which the stapling frame 62b is disposed, so as to be rotatable in the forward and reverse directions. The drive transmission gear 83a is engaged with an output gear 82a of the stapler pivot motor 82. The stapler 62 can be rotated in the forward and reverse directions about the stapler shaft 83 on the base 78 by a driving force transmitted from the stapler pivot motor 82 to the stapler shaft 83 via the output gear 82a and the drive transmission gear 83a.

The edge binder 25 and the staple binder 155 are supported by the common guide shaft 49. In other words, the edge binder movement assembly 57 and the staple binder movement assembly 77 move the edge binder 25 and the staple binder 155 in the main scanning direction along the common guide shaft 49. The edge binder movement assembly 57 and the staple binder movement assembly 77 can separately move the edge binder 25 and the staple binder 155.

A description is given of a modification of the staple binder 155.

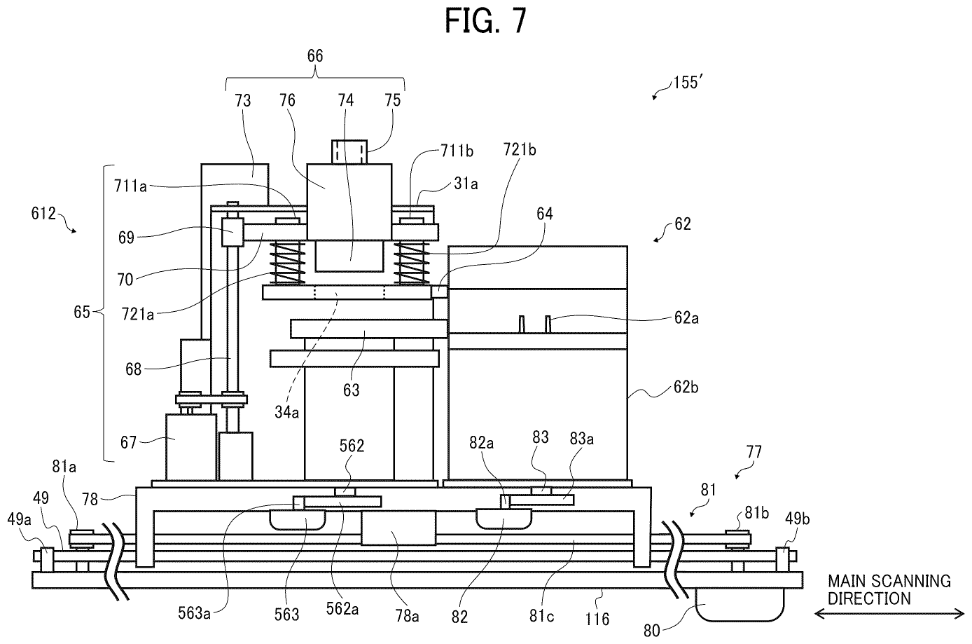

FIG. 7 illustrates a staple binder 155′ as a modification of the staple binder 155. More specifically, FIG. 7 is a schematic diagram illustrating of the staple binder 155′ as viewed from the upstream side in the conveyance direction. The staple binder 155′ is different from the staple binder 155 in that the staple binder 155′ includes a second liquid applier 612 in addition to the stapler 62. As illustrated in FIG. 7, the staple binder 155′ includes the second liquid applier 612 and the stapler 62. The second liquid applier 612 and the stapler 62 are disposed downstream from the internal tray 22 in the conveyance direction and adjacent to each other in the main scanning direction.

The second liquid applier 612 executes liquid application of applying liquid stored in a third liquid storage tank 73 to the sheet P or the sheet bundle Pb supported on the internal tray 22. A given area including a position to which the liquid is applied on the sheet P or the sheet bundle Pb by the second liquid applier 612 corresponds to a binding position to be stapled by the stapler 62. As illustrated in FIG. 7, the second liquid applier 612 includes a second lower pressure plate 63, a second upper pressure plate 64, a second liquid applier movement assembly 65, and a second liquid application assembly 66. The second liquid applier movement assembly 65 includes, for example, a second liquid-applier movement motor 67, a second trapezoidal screw 68, a second nut 69, a second base plate 70, second columns 711a and 711b, and second coil springs 721a and 721b.

The second liquid application assembly 66 includes the third liquid storage tank 73, a second liquid supply member 75, a second liquid applying member 74, and a second joint 76. Since the second liquid application assembly 66 and the liquid application assembly of the liquid applier 31 (including the first liquid storage tank 44, the liquid supply member 50, the liquid applying member 501, and the holder 37) illustrated in FIGS. 3 and 4 have common configurations, redundant descriptions thereof will be omitted unless otherwise required. Since the configuration of the stapler 62 is like the configuration of the staple binder 155 illustrated in FIG. 6, a detailed description thereof is omitted below unless otherwise required. Since the second liquid applier 612 and the liquid applier 31 that are illustrated in FIG. 3 have common pivot mechanisms, redundant descriptions thereof will be omitted unless otherwise required. The pivot mechanism of the second liquid applier 612 includes a liquid applier pivot motor 563, an output gear 563a, drive transmission gear 562a, and a liquid applier shaft 562.

In the binding process, the staple binder 155′ that is illustrated in FIG. 7 performs the liquid application process on the sheet P to loosen and soften the binding position, allowing the staple to easily pass through the sheet bundle Pb. As a result, the number of sheets to be bound per sheet bundle Pb can be increased as compared with a case where the stapling process is performed without applying the liquid.

A description is given below of a configuration of a control block of the post-processing apparatus 3.

A description is given below of a control block of the post-processing apparatus 3, with reference to FIG. 8. FIG. 8 is a block diagram illustrating a hardware configuration for executing control processing in the post-processing apparatus 3. As illustrated in FIG. 8, the post-processing apparatus 3 includes a central processing unit (CPU) 101, a random-access memory (RAM) 102, a read-only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic device and controls the overall operation of the post-processing apparatus 3. The RAM 102 is a volatile storage medium that allows data to be read and written at high speed. The CPU 101 uses the RAM 102 as a working area for data processing. The ROM 103 is a read-only non-volatile storage medium that stores programs such as firmware. The HDD 104 is a non-volatile storage medium that allows data to be read and written and has a relatively large storage capacity. The HDD 104 stores, for example, an operating system (OS), various control programs, and application programs.

By an arithmetic function of the CPU 101, the post-processing apparatus 3 processes, for example, a control program stored in the ROM 103 and an information processing program (application program) loaded into the RAM 102 from a storage medium such as the HDD 104. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU 101, the RAM 102, the ROM 103, the HDD 104, and the I/F 105 constitute at least part of a controller 100b serving as a control device that controls the operation of the post-processing apparatus 3.

The I/F 105 is an interface that connects the conveyance roller pairs 10, 11, 14, and 15, the switching member 20, the side fences 24L and 24R, the contact-separation motor 32d, the crimper pivot motor 56, the liquid applier movement motor 42, the liquid applier pivot motor 563, the edge binder movement motor 55, the stapling-part drive motor 62d, the stapler pivot motor 82, the staple binder movement motor 80, the liquid supply pump 46, the movement sensor 40a, the first liquid-level detector 43, the second liquid-level detector 58, the setting detection sensor 51, the standby position sensor 540, the encoder sensor 541, and an operation panel 110 to the common bus 109.

The controller 100b controls, via the I/F 105, the operations of the conveyance roller pairs 10, 11, 14, and 15, the switching member 20, the side fences 24L and 24R, the contact-separation motor 32d, the crimper pivot motor 56, the liquid-applier movement motor 42, the liquid-applier pivot motor 563, the edge binder movement motor 55, the stapling-part drive motor 62d, the stapler pivot motor 82, the staple binder movement motor 80, and the liquid supply pump 46. The controller 100b acquires detection results from the movement sensor 40a, the first liquid-level detector 43, the second liquid-level detector 58, the setting detection sensor 51, the standby position sensor 540, and the encoder sensor 541. Although FIG. 8 illustrates only the components related to the edge binder 25 and the staple binder 155 that perform the edge binding, the components related to the saddle binder 28 that performs the saddle binding are also controlled by the controller 100b.

As illustrated in FIG. 1, the image forming apparatus 2 includes the operation panel 110. The operation panel 110 includes an operation device that receives instructions input by an operator and a display serving as a notifier that notifies the operator of information. The operation device includes, for example, physical input buttons and a touch screen overlaid on a display. The operation panel 110 acquires information from the user through the operation device and provides information to the user through the display. A specific example of the notification unit is not limited to the display and may be a light emitting diode (LED) lamp or a speaker. The post-processing apparatus 3 may include an operation panel 110 similar to the above-described operation panel 110 of the image forming apparatus 2.

As described above, the post-processing apparatus 3 implements the function of performing operation control related to the liquid application by software (control programs) executed by the CPU 101 with hardware resources included in the controller 100b.

The liquid application performed by the post-processing apparatus 3 may be performed in a form in which the staple binder 155 is provided with only the stapler 62 and the liquid application is performed using the liquid applier 31 of the edge binder 25. By contrast, the edge binder 25 may include only the crimper 32, and the liquid application may be performed in a mode in which the second liquid applier 612 is used. In other words, the post-processing apparatus 3 may have a configuration in which the liquid applier 31 or the second liquid applier 612 performs the liquid application, regardless of the type of the binding process.

In the above description, the staple binder 155′ has a configuration of moving along the guide shaft 49 with the stapler 62 and the second liquid applier 612 being integrated, the embodiments of the present disclosure are not limited to the above-described configuration. For example, the stapler 62 and the second liquid applier 612 may have a configuration of moving separately from each other.

A description is given below of the binding process.

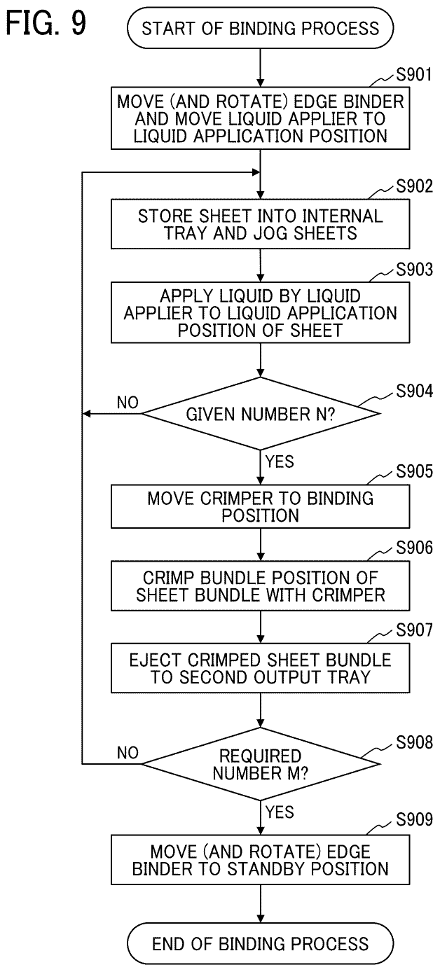

Specifically, a description is given below of the binding process executed by the edge binder 25 included in the post-processing apparatus 3. FIG. 9 is a flowchart of a process of one-point binding performed by the edge binder 25. FIGS. 10A, 10B, and 10C are diagrams illustrating the positions of the edge binder 25 (the liquid applier 31 and the crimper 32) during the one-point binding. FIGS. 10A, 10B, and 10C do not illustrate changes in the postures of the liquid applier 31 and the crimper 32. The liquid application position to which liquid is applied on a sheet P or a sheet bundle Pb by the liquid applier 31 corresponds to the binding position on the sheet bundle Pb to be crimped by the crimper 32. For this reason, in the following description, the liquid application position and the binding position are denoted by the same reference sign (B1 or B2).

For example, the controller 100b starts the binding process illustrated in FIG. 9 when the controller 100b acquires an instruction to execute the binding process from the image forming apparatus 2. In the following description, the instruction to execute the binding process may be referred to as a “binding command.”

The binding command includes, for example, the type of the sheet P (including information affecting the spread of liquid, such as material and thickness), the number of sheets P of the sheet bundle Pb, the number of sheet bundles Pb to be bound, the binding position on the sheet bundle Pb, and the binding posture of the edge binder 25. In the following description, the number of sheets P of the sheet bundle Pb may be referred to as “given number of sheets N” whereas the number of sheet bundles Pb to be bound may be referred to as “requested number of copies M.” The liquid applier 31 and the crimper 32 are assumed to be in a parallel binding posture and located at a standby position HP (FIG. 10A) that is a position shifted in the width direction from the sheets P placed on the internal tray 22 at the start of the binding process.

When the posture that is instructed by the binding command is the “inclined binding posture,” the controller 100b drives the liquid applier pivot motor 563 and the crimper pivot motor 56 to rotate the liquid applier 31 and the crimper 32 of the edge binder 25 into the inclined binding posture (step S901). When the posture is the “inclined binding posture”, the crimper 32 alone may be rotated to the inclined binding posture and the liquid applier 31 may be restricted not to rotate in the forward and reverse directions. As a result, the driving assembly may be simplified as compared with a case where both the liquid applier 31 and the crimper 32 are rotated in the forward and reverse directions, and thus effects of cost reduction, downsizing of the apparatus, and reduction of failure of the device are exhibited.

On the other hand, when the posture that is instructed by the binding command is the “parallel binding posture,” the controller 100b skips the aforementioned operation of rotating the liquid applier 31 and the crimper 32 of the edge binder 25 to the oblique binding posture.

The controller 100b drives the edge binder movement motor 55 to move the edge binder 25 in the main scanning direction so that the liquid applier 31 faces the first liquid application position B1 instructed by the binding command (step S901). The controller 100b executes the operation of step S901 before a first sheet P is conveyed to the internal tray 22 by the conveyance roller pairs 10, 11, 14, and 15.

In step S902, the controller 100b rotates the conveyance roller pairs 10, 11, 14, and 15 to store the sheet P, on which the image has been formed by the image forming apparatus 2, onto the internal tray 22. The controller 100b moves the side fences 24L and 24R in the main scanning direction to align the position of the sheet P or the sheet bundle Pb placed on the internal tray 22 in the main scanning direction (step S902). In short, the controller 100b performs so-called jogging.

In step S903, the controller 100b causes the liquid applier 31 facing the first liquid application position B1 to apply liquid to the first liquid application position B1 of the sheet P placed on the internal tray 22 in the immediately preceding step S902, based on the liquid application control data adjusted in advance. In other words, the controller 100b drives the liquid applier movement motor 42 to bring the liquid application member 501 into contact with the liquid application position B1 on the sheet P placed on the internal tray 22 (see FIG. 10B). In the liquid application process in step S903, the controller 100b adjusts the position at which the liquid applying member 501 applies liquid to the sheet P in accordance with the type of the sheet P and the binding position included in the binding command. The controller 100b adjusts the amount of pressing the liquid applying member 501 against the sheet P. In other words, the controller 100b controls the driving of the liquid applier movement motor 42 based on the adjusted control data, and adjusts the amount of movement of the liquid application member 501 with respect to the first liquid application position B1 of the sheet P placed on the internal tray 22 (see FIG. 10B).

The controller 100b determines whether the number of sheets P placed on the internal tray 22 has reached the given number of sheets N instructed by the binding command (step S904). When the controller 100b determines that the number of sheets P placed on the internal tray 22 has not reached the given number of sheets N (NO in step S904), the controller 100b executes the operations of steps S902 to S904 again until the number of sheets P placed on the internal tray 22 reaches the given number of sheets N (YES in step S904). In other words, the controller 100b executes the processing of steps S902 to S904 each time the sheet P is conveyed to the internal tray 22 by the conveyance roller pairs 10, 11, 14, and 15. The liquid application by the liquid application means 31 may be performed not only on all of the plurality of sheets P constituting the sheet bundle Pb but also on only some of the plurality of sheets P constituting the sheet bundle Pb.

When the controller 100b determines that the number of sheets P stored in the internal tray 22 has reached the given number of sheets N (YES in step S904), in step S905, the controller 100b drives the edge binder movement motor 55 to move the edge binder 25 in the main scanning direction such that the crimper 32 faces the first binding position B1 as illustrated in FIG. 10C.

In step S906, the controller 100b causes the crimper 32 to crimp the sheet bundle Pb placed on the internal tray 22. The controller 100b causes the conveyance roller pair 15 to eject the sheet bundle Pb thus crimped and bound by the crimper 32 to the second ejection tray 26 (step S907). Specifically, the controller 100b drives the contact-separation motor 32d to cause the upper crimping teeth 32a and the lower crimping teeth 32b to pinch the first binding position B1 on the sheet bundle Pb placed on the internal tray 22. The sheet bundle Pb is pressed and deformed between the upper crimping teeth 32a and the lower crimping teeth 32b. Thus, the crimper 32 crimps the sheet bundle Pb. Then, the controller 100b rotates the conveyance roller pair 15 to eject the sheet bundle Pb thus crimped and bound to the second ejection tray 26.

The sheet bundle Pb that is supported on the internal tray 22 has a crimping area (corresponding to the first binding position B1) sandwiched between the upper crimping teeth 32a and the lower crimping teeth 32b in step S906. The crimping area overlaps a liquid application area (corresponding to the first liquid application position B1) contacted by the end of the liquid application member 501 in step S903. In other words, the crimper 32 crimps an area to which liquid is applied by the liquid applier 31 on the sheet bundle Pb placed on the internal tray 22. The crimping area that is pinched by the upper crimping teeth 32a and the lower crimping teeth 32b may completely or partially overlaps the liquid application area contacted by the distal end of the liquid applying member 501, to obtain a sufficient binding strength.

The controller 100b determines whether the number of sheet bundles Pb thus ejected to the second ejection tray 26 has reached the requested number of copies M indicated by the binding command (step S908). When the controller 100b determines that the number of sheet bundles Pb thus ejected has not reached the requested number of copies M (NO in step S908), the controller 100b executes the operations of step S902 and the following steps again. In other words, when the controller 100b determines that the number of sheet bundles Pb thus ejected has not reached the requested number of copies M (NO in step S908), the controller 100b repeats the operations of steps S902 to S908 until the number of sheet bundles Pb ejected to the second ejection tray 26 reaches the requested number of copies M.

On the other hand, when the controller 100b determines that the number of sheet bundles Pb output to the second ejection tray 26 has reached the requested number of copies M (YES in step S908), the controller 100b drives the edge binder movement motor 55 to move the edge binder 25 (the liquid applier 31 and the crimper 32) to the standby position HP as illustrated in FIG. 10A (step S909) When the posture that is instructed by the binding command is the “oblique binding posture,” the controller 100b drives the liquid applier pivot motor 563 and the crimper pivot motor 56 to rotate the liquid applier 31 and the crimper 32 into the parallel binding posture (step S909). On the other hand, when the posture that is instructed by the binding command is the “parallel binding posture,” the controller 100b skips the aforementioned operation of rotating the liquid applier 31 and the crimper 32 to the parallel binding posture. As a result, the edge binder 25 (the liquid applier 31 and the crimper 32) returns to the standby position HP position illustrated in FIG. 10A. In steps S901 and S909, the execution order of the movement in the main scanning direction and the rotation in the forward and reverse directions of the liquid applier 31 and the crimper 32 is not limited to the aforementioned order and may be reversed.

A detailed description is given below of a second liquid storage tank 47.

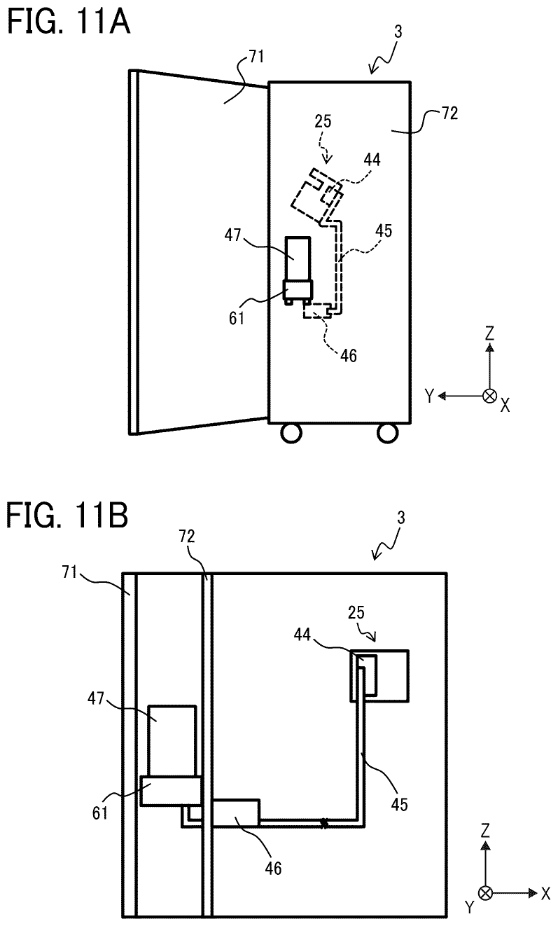

Referring now to FIGS. 11A, 11B, and 12, a description is given of the arrangement and configuration of the second liquid storage tank 47 in the post-processing apparatus 3. FIGS. 11A and 11B illustrate example location and configuration of the second liquid storage tank 47 as the main tank. FIG. 11A illustrates the post-processing apparatus 3 with a cover 71 opened. FIG. 11B is a cross-sectional side view of the post-processing apparatus 3, illustrating the post-processing apparatus 3 with the cover 71 closed. As illustrated in FIGS. 11A and 11B, the second liquid storage tank 47 is located so as to be accessible when the cover 71 of the post-processing apparatus 3 is opened. As illustrated in FIG. 11B, the second liquid storage tank 47 and the second-liquid-storage-tank fixer 61 are disposed on the near side in a depth direction (X direction) of the post-processing apparatus 3. The first liquid storage tank 44 is disposed on the far side in the depth direction (X direction) of the post-processing apparatus 3. A housing side plate 72 of the post-processing apparatus 3 is disposed between the location of the second liquid storage tank 47 and the second-liquid-storage-tank fixer 61 and the location of the first liquid storage tank 44. The second-liquid-storage-tank fixer 61 is attached to the housing side plate 72 of the post-processing apparatus 3.

FIG. 12 illustrates a configuration in which the second liquid storage tank 47 is attachable to and detachable from the second-liquid-storage-tank fixer 61 and a state in which liquid W is replenished to the second liquid storage tank 47. As illustrated in part (A) of FIG. 12, the second liquid storage tank 47 is attachable to and detachable from the second-liquid-storage-tank fixer 61 so as to be able to replenish the first liquid storage tank 44 with liquid W. As illustrated in part (B) of FIG. 12, the second liquid storage tank fixer 61 is provided with the setting detection sensor 51 serving as a setting detector that detects that the second liquid storage tank 47 is set on the second liquid storage tank fixer 61.

When the setting detection sensor 51 detects the set state of the second liquid storage tank 47 to the second liquid storage tank fixer 61 (see part (C) of FIG. 125, a signal indicating the set state is transmitted to the controller 100b. Thus, the controller 100b detects whether the second liquid storage tank 47 is set on the second-liquid-storage-tank fixer 61.

The second liquid-level detector 58 (serving as second liquid detector) that detects the amount of liquid L to be stored in the second liquid storage tank 47 is disposed in the second-liquid-storage-tank fixing portion 61. The output value (voltage) of the second liquid-level detector 58 is notified to the controller 100b. The controller 100b determines the output value (voltage) of the second liquid-level detector 58 to determine whether the amount of liquid stored in the second-liquid-storage-tank fixing portion 61 is a required amount of liquid. When the controller 100b determines that the second liquid storage tank 47 is set on the second liquid storage tank fixer 61 (i.e., is in a set state) based on the output signal of the setting detection sensor 51, the controller 100b turns on the second liquid-level detector 58 such that the remaining amount of liquid (the amount of the liquid stored) in the second-liquid-storage-tank fixing portion 61 can be detected.

When the second liquid storage tank 47 is not set on the second-liquid-storage-tank fixing portion 61 (i.e., is in a non-set state), a liquid discharge port 471a of the second liquid storage tank 47 is closed by a liquid supply valve 471 so that the liquid W does not leak. As illustrated in part (C) of FIG. 12, when the second liquid storage tank 47 is set to the second-liquid-storage-tank fixing portion 61, the liquid supply valve 471 is pushed up to open the liquid discharge port 471a of the second liquid storage tank 47. Thus, the liquid W can flow out from the second liquid storage tank 47 to the second liquid storage tank fixer 61. As a result, the liquid W stored in the second liquid storage tank 47 flows out to the second-liquid-storage-tank fixer 61. The liquid W flowing out of the second liquid storage tank 47 is stored in the second-liquid-storage-tank fixer 61.

As a measurement to prevent the liquid W from being frozen during maintenance of the post-processing apparatus 3, a liquid draining process may be performed to drain the liquid W in the post-processing apparatus 3. In the liquid draining process, the liquid W remaining in the first liquid storage tank 44 and the liquid supply passage 45 is supplied by the liquid supply pump 46 to the second liquid storage tank fixer 61 via the liquid supply passage 45 in the reverse direction. In order to deal with such a situation, the second-liquid-storage-tank fixer 61 is set to the amount to sufficiently store liquid W in the first liquid storage tank 44 and the liquid supply passage 45. As illustrated in parts (B) and (C) of FIG. 12, the second-liquid-storage-tank fixer 61 is provided with a liquid drain plug 611. After the liquid W remaining in the first liquid storage tank 44 and the liquid supply passage 45 is reversely fed by the liquid supply pump 46 to the second liquid storage tank fixer 61, the liquid drain plug 611 is opened to discharge the liquid W stored in the second liquid storage tank fixer 61 to the outside of the post-processing apparatus 3.

A description is given of a configuration of the liquid applier 31.

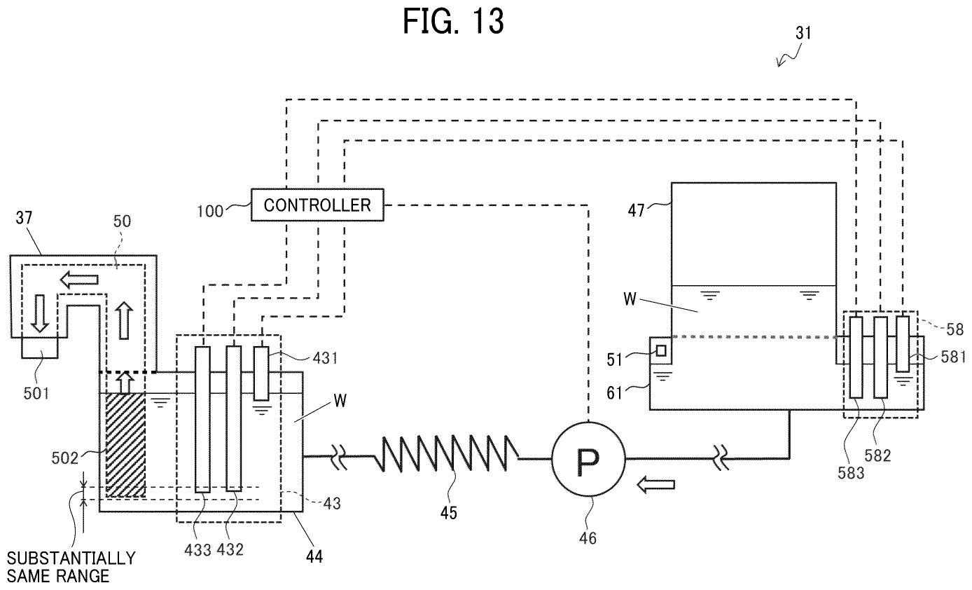

A configuration of the liquid applier 31 is described below with reference to FIG. 13. FIG. 13 is a diagram illustrating a configuration of the liquid applier 31. The liquid replenished to the second liquid storage tank 47 is supplied to the first liquid storage tank 44 via the liquid supply passage 45 by the liquid supply pump 46 as an example of the liquid supplier. A liquid supply member 50 (liquid supply portion) is disposed in the first liquid storage tank 44. A liquid applying member 501 is disposed at a distal end of the liquid supply member 50. The base end 502 of the liquid supply member 50 is immersed in liquid W in the first liquid storage tank 44. The liquid W in the first liquid storage tank 44 is sucked up from the base end 502 of the liquid supply member 50 by capillary action and sent to the liquid applying member 501.

A first liquid-level detector 43 (an example of a first liquid-level detector) that detects the liquid level of the liquid W is disposed in the first liquid storage tank 44. The controller 100b controls the start and stop of the operation of the liquid supply pump 46 based on the signal obtained by the first liquid-level detector 43. The first liquid-level detector 43 includes a plurality of first to third liquid-level detection sensors 431, 432, and 433. It is assumed that sensors such as electrode sensors, float sensors, and capacitance sensors that can detect the presence of liquid W are used as the first to third liquid-level detection sensors 431, 432, and 433. Since there has been a demand for reducing the apparatus size of the media processing apparatus and the image forming system 1 in recent years, a description is given below of an embodiment in which electrode sensors that can detect a liquid level in a space-saving manner are employed.

The electrode sensors are used to read a change in electric signal caused by energization between a pair of electrodes. When the pair of electrodes is brought into contact with liquid W and energized, the presence of the liquid W is detected based on a determination on whether an electric signal (e.g., resistance, voltage, or current) reaches a predetermined threshold value. In order to detect the presence of the liquid W, it is necessary that the pair of electrodes contacts the liquid W in a state where the electrodes are energized and a current flows between the electrodes. Therefore, at least one pair of electrodes is needed to detect the liquid level. Accordingly, at least three electrodes are needed when it is desired to detect two patterns of liquid level states, that is, a state where the liquid W in the first liquid storage tank 44 is full (in full amount state) and a state where the liquid W is depleted (in depleted state). When one electrode is disposed at a height at which the full amount state is to be detected and the remaining two electrodes near the bottom surface of the first liquid storage tank 44, the depleted state of the liquid W can be detected. The above description is about the case where three electrodes are used to detect two patterns of the liquid level states of the full amount state and the depleted state of the liquid W in the first liquid storage tank 44. However, for example, the number of electrodes may be increased to three or more, and the lower ends of the three or more electrodes may be arranged so as to be shifted from each other in the vertical direction. Such a configuration can also detect a state between the full amount state and the depleted state of the liquid W in the first liquid storage tank 44, e.g., a state where the liquid W in the first liquid storage tank 44 is 50% or 30%.

The first to third liquid-level detection sensors 431, 432, and 433 are include long rod-shaped electrodes. The first to third liquid-level detection sensors 431, 432, and 433 are extended in the vertical direction. The lower ends of the first to third liquid-level detection sensors 431, 432, and 433 are disposed in the first liquid storage tank 44. The first to third liquid-level detection sensors 431, 432, and 433 are electrically connected to a controller 100b described later. The first liquid-level detection sensor 431 is an example of a first liquid-level detecting member, the second liquid-level detection sensor 432 is an example of a second liquid-level detecting member, and the third liquid-level detection sensor 433 is an example of a third liquid-level detecting member.

The lower end of the first liquid-level detection sensor 431 is disposed above the lower ends of at least the second liquid-level detection sensor 432 and the third liquid-level detection sensor 433. As an example, as illustrated in FIG. 13, the lower ends of the second liquid-level detection sensor 432 and the third liquid-level detection sensor 433 are disposed in substantially the same range. On the other hand, the lower end of the first liquid-level detection sensor 431 is disposed above substantially the same range. The term “substantially the same range” is a predetermined range including the position of the base end 502 of the liquid supply member 50 in the vertical direction. More specifically, the term “substantially the same range” indicates a minute range in which the base end 502 of the liquid supply member 50 and the lower ends of the first to third liquid-level detection sensors 431, 432, and 433 can be evaluated as being substantially at the same position in the vertical direction.

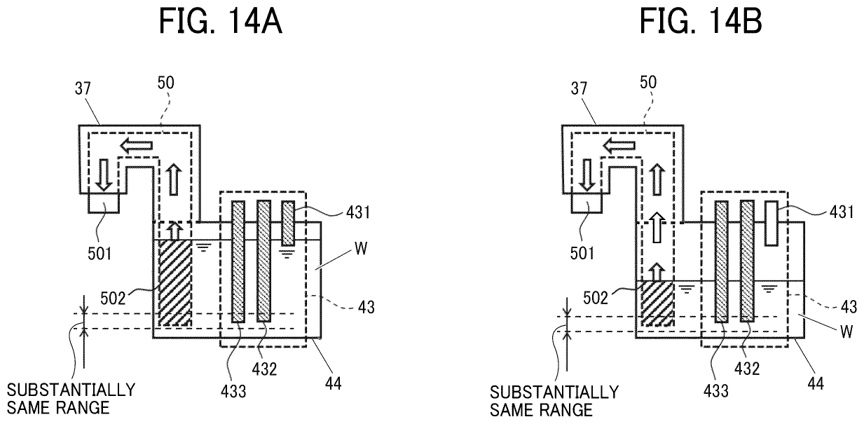

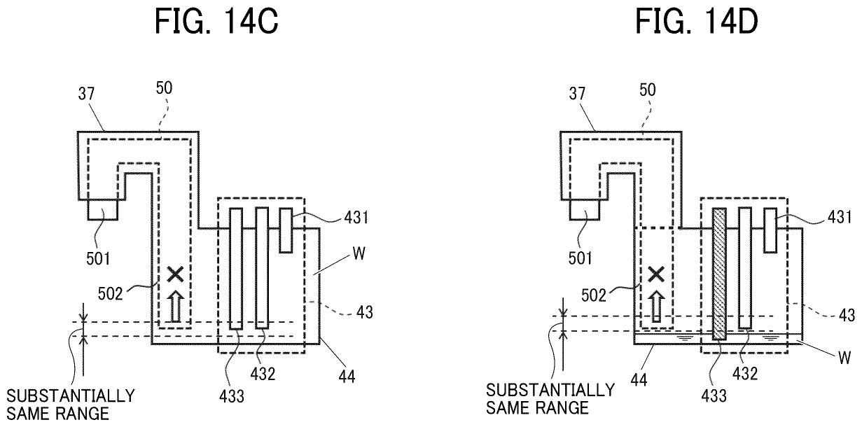

As another example, as illustrated in FIG. 14D, the lower end of the second liquid-level detection sensor 432 may be disposed in substantially the same range. The lower end of the first liquid-level detection sensor 431 may be disposed above substantially the same range. The lower end of the third liquid-level detection sensor 433 may be disposed below substantially the same range.

A description is given of a change in liquid level of a first liquid tank 44 and detection of the liquid level.

The liquid-level detection based on the liquid-level change in the first liquid storage tank 44 will be described below with reference to FIGS. 14A to 14D. FIGS. 14A to 14D are diagrams illustrating a change in the liquid level of the first liquid storage tank 44 and the detection of the liquid level.

FIG. 14A illustrates a case where liquid W in the first liquid storage tank 44 is in a full amount state. In other words, all of the first liquid-level detection sensor 431, the second liquid-level detection sensor 432, and the third liquid-level detection sensor 433 are in contact with the liquid W. Accordingly, the liquid level can be detected between all of the first liquid-level detection sensor 431, the second liquid-level detection sensor 432, and the third liquid-level detection sensor 433 when the electric current is supplied. In other words, the first liquid-level detection sensor 431, which is disposed above the lower ends of the second liquid-level detection sensor 432 and the third liquid-level detection sensor 433, the second liquid-level detection sensor 432, and the third liquid-level detection sensor 433 are all energized in a state where the first liquid-level detection sensor 431, the second liquid-level detection sensor 432, and the third liquid-level detection sensor 433 are all in contact with the liquid W. Thus, when an electric current flows between the first to third liquid-level detection sensors 431 to 433, it is detected that the liquid W in the first liquid storage tank 44 is in a full amount state.

FIG. 14B illustrates a state in which the liquid W is present in the first liquid storage tank 44 but is not in a full amount state. In other words, only the first liquid-level detection sensor 431 is not in contact with the liquid W, and the other second liquid-level detection sensor 432 and third liquid-level detection sensor 433 are in contact with the liquid W. When the electric current is supplied, the first liquid-level detection sensor 431 is not in contact with the liquid W and no electric current flows, so that the full amount state is not detected. However, an electric current flows between the other second liquid-level detection sensor 432 and third liquid-level detection sensor 433. Therefore, the controller 100b determines that the liquid W is present in the first liquid storage tank 44 in a state where the liquid W is not in a full amount.

FIG. 14C illustrates a case where the liquid W in the first liquid storage tank 44 is in a depleted state. In this case, the liquid W is not present in the first liquid storage tank 44. As a result, all of the first to third liquid-level detection sensors 431 to 433 are not in contact with the liquid W. Accordingly, even if the electric current is supplied, no electric current flows between the first to third liquid-level detection sensors 431 to 433, and the liquid level of the liquid W in the first liquid storage tank 44 is not detected. Therefore, the controller 100b determines that the liquid W is not present in the first liquid storage tank 44.

FIG. 14D illustrates a case where the liquid W in the first liquid storage tank 44 is in a depleted state, as in FIG. 14C. Although the third liquid-level detection sensor 433 is in contact with the liquid W, the other first liquid-level detection sensor 431 and second liquid-level detection sensor 432 are not in contact with the liquid W. Accordingly, no current flows between the first to third liquid-level detection sensors 431 to 433 even when the current is supplied. Therefore, the controller 100b determines that the liquid W is not present in the first liquid storage tank 44.

A description is given of an arrangement of the first to third liquid-level detection sensors 431 to 433.

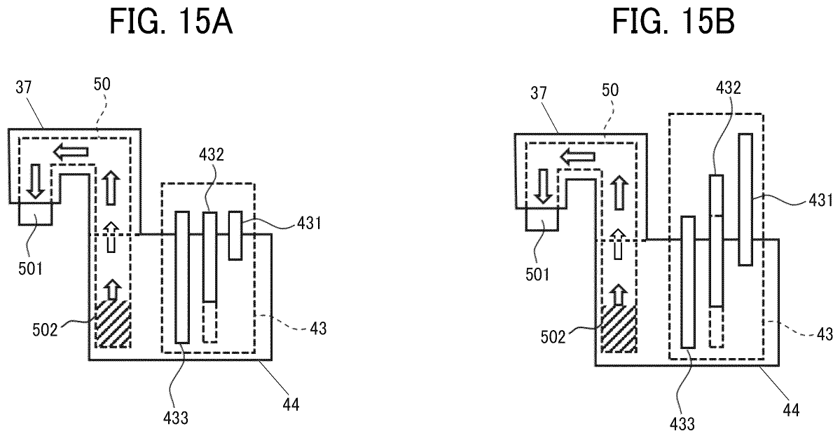

The arrangement of the first to third liquid-level detection sensors 431 to 433 of the first liquid storage tank 44 will be described below with reference to FIGS. 15A and 15B. FIGS. 15A and 15B are diagrams illustrating the arrangement of the first to third liquid-level detection sensors 431 to 433 of the first liquid storage tank 44. As an example, the first liquid-level detector 43 may include first to third liquid-level detection sensors 431 to 433 having different lengths, as illustrated in FIG. 15A. As another example, the first liquid-level detector 43 may arrange the first to third liquid-level detection sensors 431 to 433 having the same length at positions shifted from each other in the vertical direction as illustrated in FIG. 15B.

In FIG. 15A, the first liquid-level detection sensor 431 is shorter than each of the second liquid-level detection sensor 432 and the third liquid-level detection sensor 433. The second liquid-level detection sensor 432 is shorter than or equal in length to the third liquid-level detection sensor 433. In such a manner, the length of the first to third liquid-level detection sensors 431 to 433 is adjusted to adjust the range of the liquid-level detection.

In FIG. 15B, the first liquid-level detection sensor 431 is disposed at a position higher than the second liquid-level detection sensor 432 and the third liquid-level detection sensor 433. The second liquid-level detection sensor 432 is disposed at a position higher than or at the same height as the third liquid-level detection sensor 433. Since the installation heights of the first to third liquid-level detection sensors 431 to 433 having the same length in the vertical direction are changed in such a manner, the same components can be used for the first to third liquid-level detection sensors 431 to 433, thus allowing cost reduction.

A description is given of the determination on whether the liquid supply member 50 absorbs liquid.

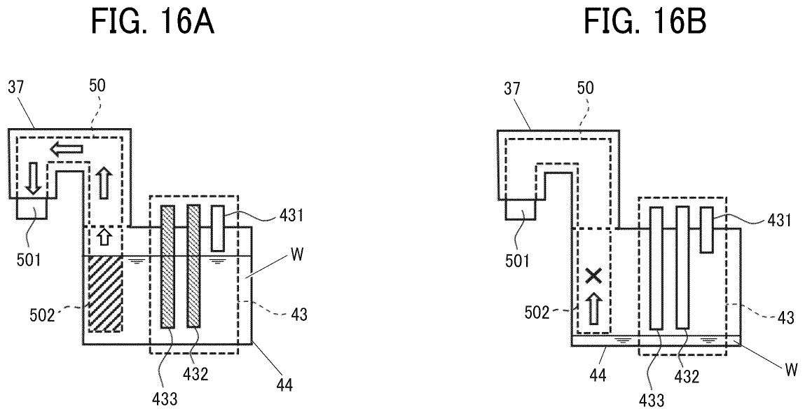

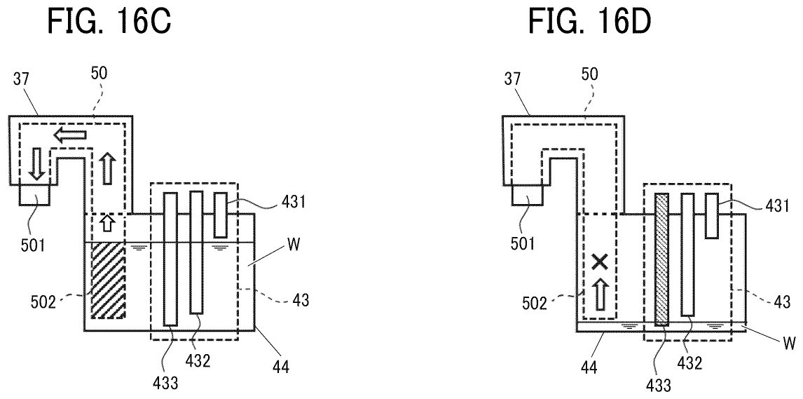

A method of determining whether the liquid supply member 50 absorbs liquid will be described with reference to FIGS. 16A to 16D. FIGS. 16A to 16D are diagrams illustrating the presence of liquid absorbed by the liquid supply member 50 and a configuration of the liquid-level detecting member.

In FIGS. 16A and 16C, liquid W is present but not in a full amount state in the first liquid storage tank 44, and the liquid supply member 50 is in contact with the liquid W and absorbs the liquid W. At this time, the first liquid-level detection sensor 431 is not in contact with the liquid W, and the second liquid-level detection sensor 432 and the third liquid-level detection sensor 433 are in contact with the liquid W. Even if the electric current is supplied in this state, no electric current flows between the first to third liquid-level detection sensors 431 to 433. Therefore, the controller 100b determines that the liquid W is present in the first liquid storage tank 44.

FIG. 16B illustrates a state in which liquid W is almost not present in the first liquid storage tank 44 and the liquid supply member 50 does not absorb the liquid W. The lower ends of the second liquid-level detection sensor 432 and the third liquid-level detection sensor 433 are disposed at substantially the same height as the base end 502 of the liquid supply member 50. Accordingly, all of the first to third liquid-level detection sensors 431 to 433 are not in contact with the liquid W. Even if the electric current is supplied in this state, no electric current flows between the first to third liquid-level detection sensors 431 to 433. As a result, the controller 100b can determine that the liquid W is not present in the first liquid storage tank 44, and can also detect that the liquid is not supplied to the liquid supply member 50. The term “substantially the same height” mentioned herein includes a height at which the lower ends of the first to third liquid-level detection sensors 431 to 433 are positioned slightly above or slightly below the base end 502 of the liquid supply member 50.

FIG. 16D illustrates a state in which the liquid W is almost not present in the first liquid storage tank 44 and the liquid supply member 50 does not absorb the liquid W. The lower end of the second liquid-level detection sensor 432 is disposed at substantially the same height as the base end 502 of the liquid supply member 50, and the lower end of the third liquid-level detection sensor 433 is disposed below the base end 502 of the liquid supply member 50. Therefore, the first liquid-level detection sensor 431 and the second liquid-level detection sensor 432 are not in contact with the liquid W, and only the third liquid-level detection sensor 433 is in contact with the liquid W. Even if the electric current is supplied in this state, no electric current flows between the first to third liquid-level detection sensors 431 to 433. As a result, the controller 100b can determine that the liquid W is not present in the first liquid storage tank 44, and can also detect that the liquid is not supplied to the liquid supply member 50.

A description is given of filling supply control.

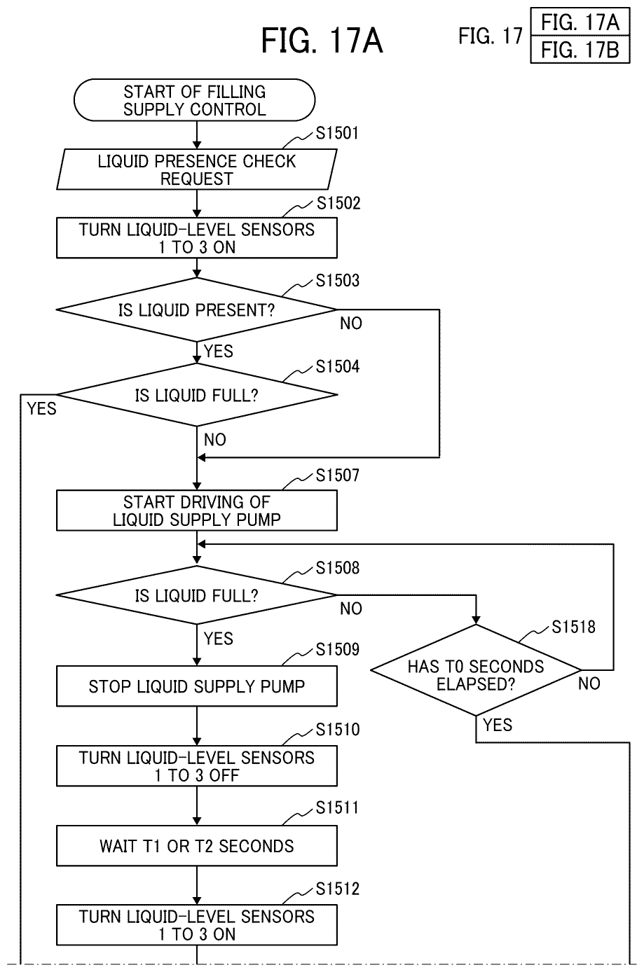

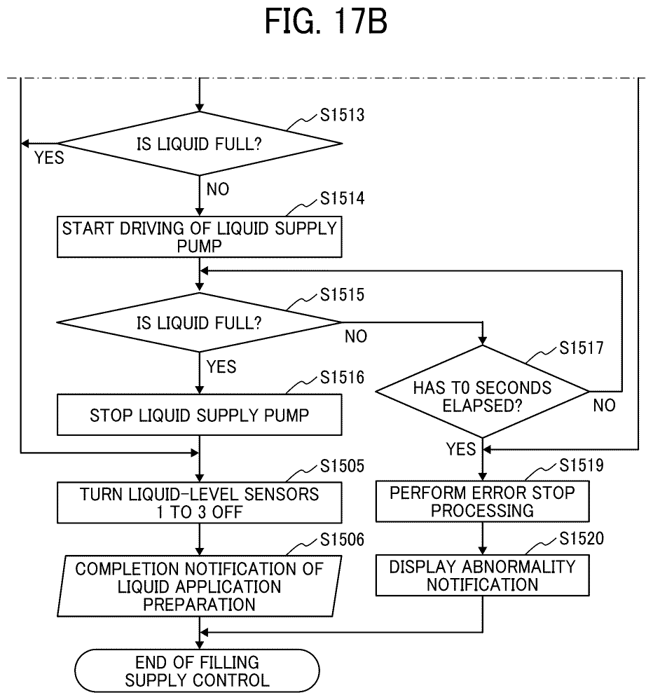

Specifically, a description is given below of the control of a filling supply operation (hereinafter referred to as “filling supply control”) for replenishing the first liquid storage tank 44 with liquid W in an amount corresponding to the amount of liquid W absorbed by the liquid supply member 50. FIG. 17 including FIGS. 17A and 17B is a flowchart of filling supply control. In the flowchart of the filling supply control illustrated in FIG. 17, the first liquid-level detection sensor 431, the second liquid-level detection sensor 432, and the third liquid-level detection sensor 433 are referred to as “liquid-level sensor 1”, “liquid-level sensor 2”, and “liquid-level sensor 3”, respectively. The filling supply control illustrated in FIG. 17 is executed, for example, when the post-processing apparatus 3 is started or when a stapleless binding job is started. The filling supply control is a control for supplying liquid W again to the first liquid storage tank 44 in a case where, after the liquid supply is performed until the output voltage is detected between the liquid-level sensor 1 and the liquid-level sensor 2, the liquid level drops due to absorption of the liquid W with the liquid supply member 50 and the liquid W is no longer detected by the output voltage detected between the liquid-level sensor 1 and the liquid-level sensor 2.

When the post-processing apparatus 3 makes a liquid presence check request (step S1501), the controller 100b supplies electric energization of the liquid-level sensors 1 to 3 (hereinafter, referred to as “energization ON”) (step S1502), and checks whether the liquid W is present in the first liquid storage tank 44 (step S1503). When the output voltage detected between the liquid-level sensors 2 and 3 is equal to or greater than the threshold value Vs, the controller 100b determines that the liquid W is present in the first liquid storage tank 44 (YES in step S1503). When the output voltage detected between the liquid-level sensor 1 and the liquid-level sensor 2 is equal to or greater than the threshold value Vs, the controller 100b also determines that the liquid W in the first liquid storage tank 44 is in the full amount state (YES in step S1504). At this time, the controller 100b stops the supply of electric energization of the liquid-level sensors 1 to 3 (hereinafter, referred to as “energization OFF”) (step S1505), notifies the completion of the preparation for applying liquid (step S1506), and ends the filling supply control.

On the other hand, when the output voltage detected between the liquid-level sensor 2 and the liquid-level sensor 3 is equal to or greater than the threshold value Vs (YES in step S1503) and the output voltage detected between the liquid-level sensor 1 and the liquid-level sensor 2 is lower than the threshold value Vs (NO in step S1504), the controller 100b determines that the liquid W is present in the first liquid storage tank 44 but is not in the full amount state. At this time, the controller 100b drives the liquid supply pump 46 to perform a liquid supply operation of supplying the liquid W from the second liquid storage tank 47 to the first liquid storage tank 44 (step S1507). The controller 100b continues to drive the liquid supply pump 46 until the controller 100b determines that the liquid W in the first liquid storage tank 44 is in the full amount state based on the output voltage detected between the liquid-level sensor 1 and the liquid-level sensor 2 (NO in step S1508).

When the controller 100b determines that the liquid W is in the full amount state in the first liquid storage tank 44 based on the output voltage detected between the liquid-level sensors 1 and 2 (YES in step S1508), the controller 100b stops the liquid supply pump 46 (step S1509) and turns off the energization of the liquid-level sensors 1 to 3 (step S1510). The controller 100b stops the liquid supply operation until a supply waiting time T1 seconds (sec) for the completion of the liquid supply to the liquid supply member 50 elapses (step S1511), turns on the energization of the liquid-level sensors 1 to 3 again after the supply waiting time T1 elapses (step S1512), and checks whether liquid W is in the full amount state in the first liquid storage tank 44 based on the output voltage detected between the liquid-level sensor 1 and the liquid-level sensor 2 (step S1513).

When the controller 100b determines that the liquid W in the first liquid storage tank 44 is in the full amount state (YES in step S1513), the controller 100b turns off the energization of the liquid-level sensors 1 to 3 (step S1505), notifies the completion of the liquid application preparation (step S1506), and ends the filling supply control.

Even if the supply waiting time T1 has elapsed (step S1511) and the liquid-level sensors 1 to 3 are energized on again (step S1512), in step S1514, the controller 100b again drives the liquid supply pump 46 to perform the liquid supply operation when the controller 100b determines that the liquid W in the first liquid storage tank 44 is not in the full amount state (NO in step S1513). When the controller 100b determines that the liquid W in the first liquid storage tank 44 is in the full amount state (YES in step S1515), the controller 100b stops the liquid supply pump 46 (step S1516), turns off the energization of the liquid-level sensors 1 to 3 (step S1505), notifies the completion of the liquid application preparation (step S1506), and ends the filling supply control.

When the output voltage detected between the liquid-level sensor 2 and the liquid-level sensor 3 is less than the threshold value Vs, the controller 100b determines that the liquid W is not present in the first liquid storage tank 44 (NO in step S1503), and executes the processing from step S1507. In this case, however, the supply waiting time in step 1511 is set to T2 seconds (T2>T1), which is different from T1.

In other words, the controller 100b determines whether the liquid supply member 50 is in the liquid absorbing state or the dried state, based on whether the liquid W is present in the first liquid storage tank 44 illustrated in FIGS. 16A and 16C or not present in the first liquid storage tank 44 illustrated in FIGS. 16B and 16D. When the liquid W is present in the first liquid storage tank 44 (e.g., when the controller 100b determines that the liquid supply member 50 is in a liquid absorbing state), the supply waiting time is set to T1 seconds. When the liquid W is not present in the first liquid storage tank 44 (e.g., when the controller 100b determines that the liquid supply member 50 is in a dried state), the supply waiting time is set to T2 seconds. In other words, the controller 100b changes the supply waiting times T1 and T2 depending on whether the liquid W is detected between the liquid-level sensors 2 and 3.

When the liquid W is detected by the output voltage detected between the liquid-level sensor 2 and the liquid-level sensor 3, the liquid W in the first liquid storage tank 44 is not in the full amount state, but the liquid W remains and the liquid supply member 50 sucks up and holds a certain amount of liquid W. Therefore, the supply waiting time T1 (sec) can be set to be shorter than the supply waiting time T2 (sec) when the liquid W is not detected by the output voltage detected between the liquid-level sensors 2 and 3 (e.g., when the liquid W does not almost remain in the first liquid storage tank 44). For example, T1=10 (sec) and T2=30 (sec).

Further, when the liquid W in the first liquid storage tank 44 is not in the full amount state even after the supply time T0 (sec) has elapsed from the start of driving the liquid supply pump 46 in step S1507 or S1514 (in the case of NO in step S1508 and YES in step S1518, or in the case of NO in step S1515 and YES in step S1517), the controller 100b determines that the first liquid-level detector 43 is faulty, executes error stop processing (step S1519) to perform processing for stopping the liquid supply pump 46 and turning off the energization of the liquid-level sensors 1 to 3, displays an abnormality notification on the operation panel 110 indicating that the first liquid-level detector 43 is faulty (step S1520), and ends the filling supply control.

A description is given of additional supply control.

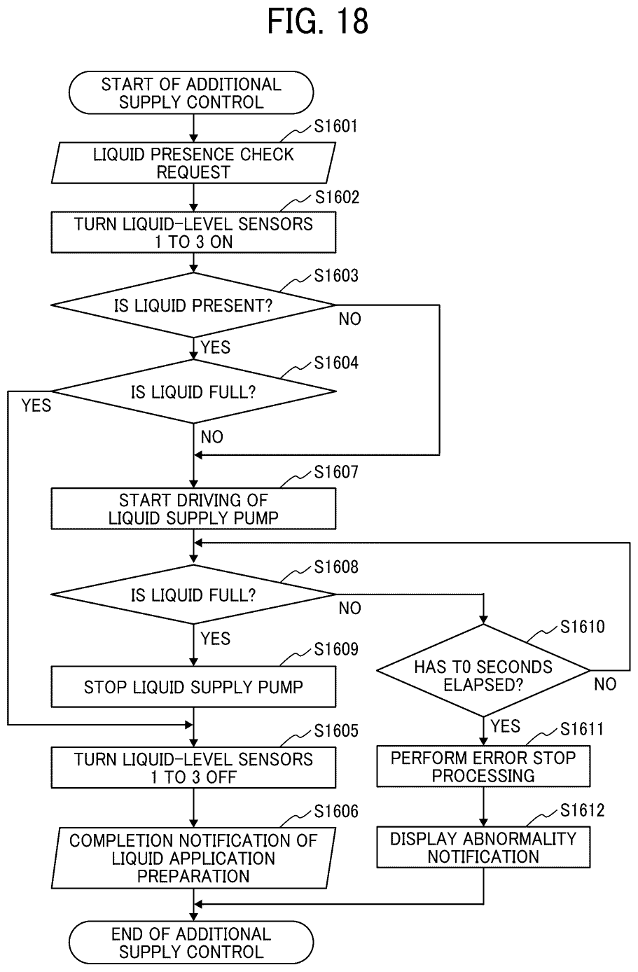

Specifically, the control of additional supply operation (referred to as additional supply control) will be described with reference to FIG. 18. FIG. 18 is a flowchart of the additional supply control. In the flowchart of the additional supply control illustrated in FIG. 18, the first liquid-level detection sensor 431, the second liquid-level detection sensor 432, and the third liquid-level detection sensor 433 are referred to as “liquid-level sensor 1”, “liquid-level sensor 2”, and “liquid-level sensor 3”, respectively. The additional supply control is executed at a timing when the additional supply control is requested, for example, at the time of starting the post-processing apparatus 3, at the start of a stapleless binding job, or during a job (e.g., when the liquid application of X sheets is performed).

When the post-processing apparatus 3 makes a liquid presence check request (step S1601), the controller 100b turns on the energization of the liquid-level sensors 1 to 3 (step S1602), and checks the remaining amount of liquid W in the first liquid storage tank 44 (step S1603). When the controller 100b determines that the liquid W in the first liquid storage tank 44 is present based on the output voltage detected between the liquid-level sensor 2 and the liquid-level sensor 3 (YES in step S1603) and determines that the liquid W is in the full amount state based on the output voltage detected between the liquid-level sensor 1 and the liquid-level sensor 2 (YES in step S1604), the controller 100b turns off the energization of the liquid-level sensors 1 to 3 (step S1605), notifies the completion of liquid application preparation (step S1606), and ends the additional supply control.

When the controller 100b determines that the liquid W in the first liquid storage tank 44 is present based on the output voltage detected between the liquid-level sensor 2 and the liquid-level sensor 3 (YES in step S1603) and determines that the liquid W in the first liquid storage tank 44 is not in the full amount state based on the output voltage detected between the liquid-level sensor 1 and the liquid-level sensor 2 (NO in step S1604), the controller 100b drives the liquid supply pump 46 to perform the liquid supply operation (step S1607). The controller 100b continues to drive the liquid supply pump 46 until the controller 100b determines that the liquid W in the first liquid storage tank 44 is in the full amount state based on the output voltage detected between the liquid-level sensor 1 and the liquid-level sensor 2 (NO in step S1608).

When the controller 100b determines that the liquid W in the first liquid storage tank 44 is in the full amount state based on the output voltage detected between the liquid-level sensor 1 and the liquid-level sensor 2 (YES in step S1608), the controller 100b stops the liquid supply pump 46 (step S1609), turns off the energization of the liquid-level sensors 1 to 3 (step S1605), notifies the completion of liquid application preparation (step S1606), and ends the additional supply control. Similarly, when the controller 100b determines that the liquid W is not present in the first liquid storage tank 44 based on the output voltage detected between the liquid-level sensors 2 and 3 (NO in step S1603), the controller 100b executes the processing from step 1607.

Further, when the liquid W in the first liquid storage tank 44 is not in the full amount state after the supply time TO (sec) has elapsed from the start of driving the liquid supply pump 46 in step S1607 (in the case of NO in step S1608 and YES in step S1610), the controller 100b determines that the first liquid-level detector 43 is faulty, executes error stop processing (step S1611) to perform processing for stopping the liquid supply pump 46 and turning off the energization of the liquid-level sensors 1 to 3, displays an abnormality notification on the operation panel 110 to indicate that the first liquid-level detector 43 is faulty (step S1612), and ends the additional supply control.

A description is given of the selection of liquid supply operation.

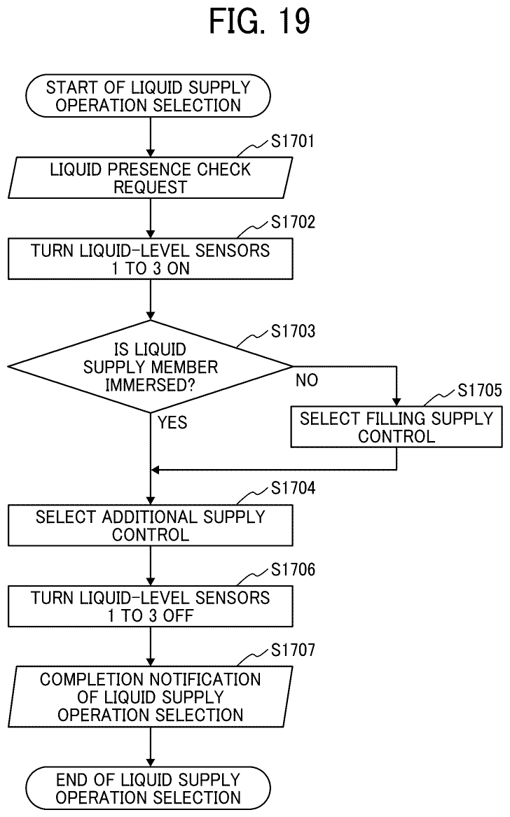

A description is given of a method of selecting a liquid supply operation will be described with reference to FIG. 19. FIG. 19 is a flowchart of the selection of liquid supply operation. The selection of liquid supply operation is executed, for example, when the post-processing apparatus 3 is started or when a stapleless binding job is started. In the flowchart of the selection of liquid supply operation illustrated in FIG. 19, the first liquid-level detection sensor 431, the second liquid-level detection sensor 432, and the third liquid-level detection sensor 433 are referred to as “liquid-level sensor 1”, “liquid-level sensor 2”, and “liquid-level sensor 3”, respectively.

First, when the post-processing apparatus 3 makes a liquid presence check request (step S1701), the controller 100b turns on the energization of the liquid-level sensors 1 to 3 (step S1702), and checks the liquid supply state to the liquid supply member 50 (step S1703).

When the controller 100b determines that the liquid W in the first liquid storage tank 44 is present based on the output voltage detected between the liquid-level sensors 2 and 3, the controller 100b determines that the base end 502 of the liquid supply member 50 is immersed in the liquid W (YES in S1703), selects the additional supply control (step S1704), turns off the energization of the liquid-level sensors 1 to 3 (step S1706), notifies the completion of the selection of liquid supply operation through the operation panel 110 (step S1707), and ends the selection of liquid supply operation. In other words, the controller 100b sets the operation mode for defining the liquid supply operation to the additional supply operation. Accordingly, the processing of steps 1607 to 1612 in FIG. 18 is executed.

On the other hand, when the controller 100b determines that the liquid W in the first liquid storage tank 44 is not present based on the output voltage detected between the liquid-level sensors 2 and 3, the controller 100b determines that the base end 502 of the liquid supply member 50 is not immersed in the liquid W (NO in step S1703), selects filling supply control (step S1705), turns off the energization of the liquid-level sensors 1 to 3 (step S1706), notifies the completion of the selection of liquid supply opeartion through the operation panel 110 (step S1707), and ends the selection of liquid supply operation. In other words, the controller 100b sets the operation mode for defining the liquid supply operation to the filling supply operation. Accordingly, the processing of steps 1507 to 1520 in FIG. 17 is executed.

A description is given below of an operation of checking the failure of a liquid-level detecting member.

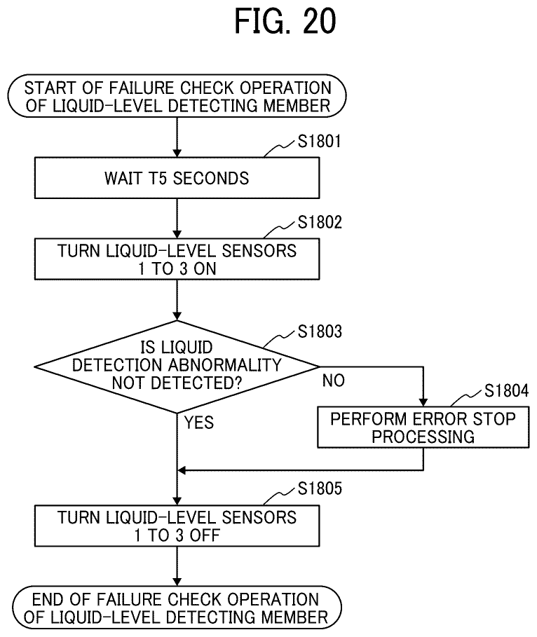

FIG. 20 is a flowchart of the operation of checking the failure of the liquid-level detecting member. The operation of checking the failure of the liquid-level detecting member is mainly performed when the liquid is supplied. In the flowchart of the operation of checking the failure of the liquid-level detecting member illustrated in FIG. 20, the first liquid-level detection sensor 431, the second liquid-level detection sensor 432, and the third liquid-level detection sensor 433 are referred to as “liquid-level sensor 1”, “liquid-level sensor 2”, and “liquid-level sensor 3”, respectively.

After the controller 100b waits for a waiting time T5 (sec) (step S1801) from the start of the operation of the liquid supply pump 46, the controller 100b turns on the energization of the liquid-level sensors 1 to 3 (step S1802), and determines whether the liquid detection of the liquid-level sensors 1 to 3 is abnormal (step S1803). The waiting time T5 is set to a time when the amount of liquid W stored in the first liquid storage tank 44 becomes a liquid amount at which the output voltage detected between the liquid-level sensors 2 and 3 is equal to or greater than the threshold value Vs. When the output voltage between the liquid-level sensor 2 and the liquid-level sensor 3 is equal to or greater than the threshold value Vs, the controller 100b determines that the liquid detection by the first liquid-level detector 43 is normal (YES in step S1803), turns off the energization of the liquid-level sensors 1 to 3 (step S1805), and ends the operation of checking the failure of th liquid-level detecting member.

On the other hand, when the output voltage between the liquid-level sensor 2 and the liquid-level sensor 3 is less than the threshold value Vs, that is, when the first liquid-level detector 43 determines that the liquid W has not stored in the first liquid storage tank 44 to such an extent even though the liquid W has stored in the first liquid storage tank 44 by the amount of liquid that the output voltage detected between the liquid-level sensor 2 and the liquid-level sensor 3 is equal to or greater than the threshold value Vs under normal conditions, the controller 100b determines that the liquid detection by the first liquid-level detector 43 is abnormal because there is a possibility that the liquid W overflows from the first liquid storage tank 44 if the liquid supply is continued as it is (NO in step S1803). In this case, the controller 100b determines that a part or all of the first to third liquid-level detection sensors 431 to 433 is faulty, executes error stop processing for stopping the liquid supply pump 46 (step S1804), turns off the energization of the liquid-level sensors 1 to 3 (step S1805), and ends the operation of checking the failure of th liquid-level detecting member.

A description is given of a configuration of the second liquid-level detector 58.

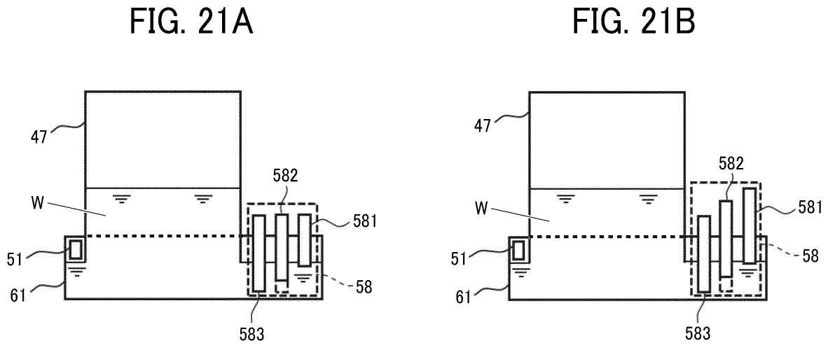

The configuration of the second liquid-level detector 58 (second liquid-level detector) of the second-liquid-storage-tank fixer 61 will be described with reference to FIGS. 21A and 21B. FIGS. 21A and 21B are diagrams illustrating the configuration of the second liquid-level detector 58 of the second-liquid-storage-tank fixer 61. The second liquid-level detector 58 is a sensor that detects the amount of liquid W stored in the second-liquid-storage-tank fixer 61. The specific configuration and arrangement of the second liquid-level detector 58 are the same as those of the first liquid-level detector 43 of the first liquid storage tank 44. The second liquid-level detector 58 includes, for example, fourth to sixth liquid-level detection sensors 581, 582, and 583. The fourth liquid-level detection sensor 581 is an example of a fourth liquid-level detecting member, the fifth liquid-level detection sensor 582 is an example of a fifth liquid-level detecting member, and the sixth liquid-level detection sensor 583 is an example of a sixth liquid-level detecting member.

The fourth liquid-level detection sensor 581 is disposed above the fifth liquid-level detection sensor 582 and the sixth liquid-level detection sensor 583. The fifth liquid-level detection sensor 582 is disposed above or at the same height as the sixth liquid-level detection sensor 583. Thus, when the output voltage detected between the fourth liquid-level detection sensor 581 and the fifth liquid-level detection sensor 582 is equal to or greater than the threshold value Vs, the controller 100b determines that the second-liquid-storage-tank fixer 61 is in the full amount state. When the output voltage detected between the fifth liquid-level detection sensor 582 and the sixth liquid-level detection sensor 583 is equal to or greater than the threshold value Vs, it is determined that the liquid W is present in the second-liquid-storage-tank fixer 61.

As an example, the second liquid-level detector 58 may include fourth to sixth liquid-level detection sensors 581 to 583 having different lengths as illustrated in FIG. 21A. In FIG. 21A, the length of the fourth liquid-level detection sensor 581 is shorter than the length of each of the fifth liquid-level detection sensor 582 and the sixth liquid-level detection sensor 583. The length of the fifth liquid-level detection sensor 582 is shorter than or equal to the length of the sixth liquid-level detection sensor 583. The lengths of the fourth to sixth liquid-level detection sensors 581 to 583 are adjusted in such a manner, thus allowing adjustment of the range in which the second liquid-level detector 58 detects the liquid level of liquid W in the second-liquid-storage-tank fixer 61.

As another example, the second liquid-level detector 58 may be arranged such that the fourth to sixth liquid-level detection sensors 581 to 583 having the same length are shifted from each other in the vertical direction as illustrated in FIG. 21B. In FIG. 21B, the fourth liquid-level detection sensor 581 is disposed at a position higher than the fifth liquid-level detection sensor 582 and the sixth liquid-level detection sensor 583. The fifth liquid-level detection sensor 582 is disposed at a position higher than or at the same height as the sixth liquid-level detection sensor 583. Since the installation heights of the fourth to sixth liquid-level detection sensors 581 to 583 having the same length in the vertical direction are changed in such a manner, the same components can be used for the fourth to sixth liquid-level detection sensors 581 to 583, thus allowing cost reduction.

A description is given of liquid supply control from the second liquid storage tank to the first liquid storage tank 44.

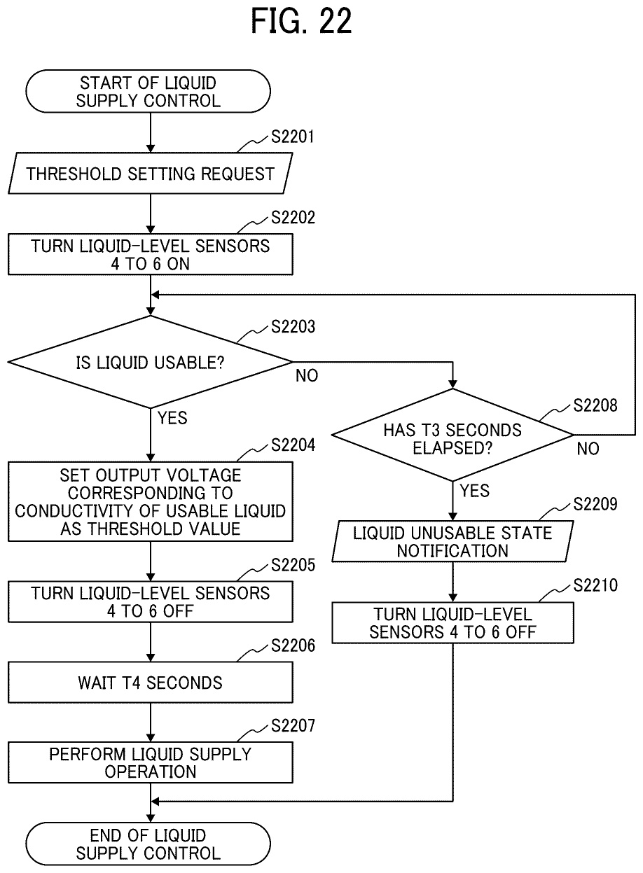

A description is given below of the control of the liquid supply operation from the second liquid storage tank to the first liquid storage tank 44 (referred to as liquid supply control). FIG. 22 is a flowchart of the liquid supply control. In the liquid supply control, when the second liquid storage tank 47 is set in the second-liquid-storage-tank fixer 61, the controller 100b determines whether liquid W is usable. After the controller 100b determines that the liquid W is usable, the controller 100b performs liquid supply to the first liquid storage tank 44. In the flowchart of the liquid supply control illustrated in FIG. 22, the fourth liquid-level detection sensor 581, the fifth liquid-level detection sensor 582, and the sixth liquid-level detection sensor 583 are referred to as a liquid-level sensor 4, a liquid-level sensor 5, and a liquid-level sensor 6, respectively.

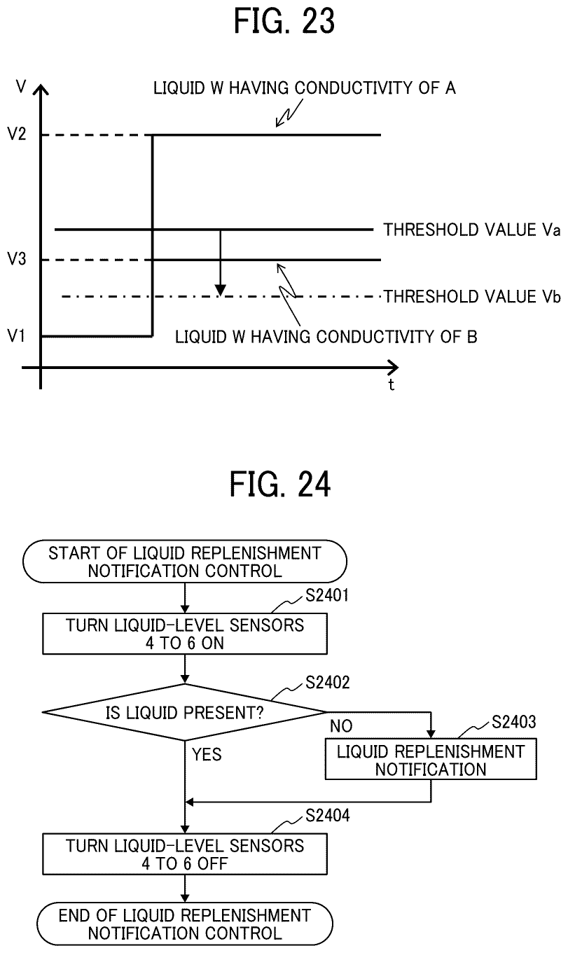

When the setting detection sensor 51 detects that the second liquid storage tank 47 is set in the second-liquid-storage-tank fixer 61, a threshold-value setting request is executed (step S2201). Accordingly, the controller 100b turns on the energization of the liquid-level sensors 4 to 6 (step S2202), and determines whether the liquid W supplied from the second liquid storage tank 47 to the second-liquid-storage-tank fixer 61 is usable (step S2203). The reason why the controller 100b determines whether the liquid W is usable is that, if the conductivity of the liquid W is too low when the liquid-level sensors 4 to 6 are energized, the difference in the output voltage detected between the liquid-level sensors 4 to 6 before and after the liquid-level sensors 4 to 6 come into contact with the liquid W is small. As a result, the liquid level of the liquid W in the second-liquid-storage-tank fixer 61 is not accurately detected. Then, a method of determining whether the liquid can be used in step 2203 of FIG. 22 will be described with reference to FIG. 23.

As illustrated in FIG. 23, when the liquid-level sensors 4 to 6 are energized (step S2202), only air is present between the liquid-level sensors 4 to 6 before the liquid-level sensors 4 to 6 contact the liquid W. Therefore, the output voltage detected between the liquid-level sensor 5 and the liquid-level sensor 6 becomes an output voltage V1 quite close to zero. For example, in a case where the liquid W having the conductivity of A is used, when the liquid-level sensors 5 and 6 come into contact with the liquid W supplied to the second-liquid-storage-tank fixer 61, the output voltage detected between the liquid-level sensors 5 and 6 changes from V1 to V2 as illustrated in FIG. 23. Therefore, as an output voltage for determining the presence of liquid, a threshold value Va is set between the output voltages V1 and V2. The controller 100b determines that only the liquid W having the conductivity at which the output voltage exceeding the threshold value Va is detected can be used. In other words, as illustrated in FIG. 23, for example, when the liquid W having the conductivity of B (B<A) is used, the output voltage detected between the liquid-level sensor 5 and the liquid-level sensor 6 is V3 and does not exceed the threshold value Va. As a result, the controller 100b determines that the liquid W is not usable when the conductivity of the liquid W is B. It is preferable that the threshold value Va is set to be between the output voltages V1 and V2 in consideration of, e.g., the detection accuracy (detection variation) of the liquid-level sensors 5 and 6 and noise.

When the output voltage detected between the liquid-level sensor 5 and the liquid-level sensor 6 exceeds a threshold value Va, the controller 100b determines that the liquid W is usable (YES in step S2203), and sets the output voltage (threshold value Va) corresponding to the conductivity of the liquid W at this time as the threshold value Vs (step S2204). The controller 100b turns off the energization of the liquid-level sensors 4 to 6 (step S2205). After the controller 100b waits for a waiting time T4 (sec) until the second-liquid-storage-tank fixer 61 is filled with liquid (step S2206), the controller 100b performs the liquid supply operation (filling supply operation) illustrated in FIG. 17 (step S2207).

A method of setting the threshold value Vs in the case where the type (conductivity) of the liquid supplied to the second-liquid-storage-tank fixer 61 is changed by replacement of the second liquid tank 47 will be described below with reference to FIG. 23. For example, it is assumed that the conductivity of the liquid W stored in the second-liquid-storage-tank fixer 61 is A, and the liquid W in the second-liquid-storage-tank fixer 61 is depleted by the supply of the liquid W from the second-liquid-storage-tank fixer 61 to the first liquid storage tank 44. In this case, the second liquid storage tank 47 set in the second-liquid-storage-tank fixer 61 is replaced with a new one, and the liquid W is supplied. When the conductivity of the newly supplied liquid W is B (B<A), the output voltage detected between the liquid-level sensors 5 and 6 is V3 and does not exceed the threshold value Va. Accordingly, if the threshold value Vs remains at the threshold value Va. the presence or absence of the liquid W is not detected. For this reason, as illustrated in FIG. 23, when the conductivity of the liquid W changes to B, the controller 100b sets the threshold value Vb as an output voltage for determining the presence of the liquid between the output voltages V1 and V3, and sets an output voltage (threshold value Vb) corresponding to the conductivity of the newly supplied liquid W as the threshold value Vs.

On the other hand, when the output voltage detected between the liquid-level sensor 5 and the liquid-level sensor 6 is equal to or less than a threshold value Vs even after the waiting time T3 (sec) has elapsed, the controller 100b determines that the liquid W is not usable (in the case of NO in step S2203 and YES in S2208), notifies the unusable state of the liquid through the operation panel 110 (step S2209), turns off the energization of the liquid-level sensors 4 to 6 (step S2210), and ends the liquid supply control without performing the liquid supply operation of step S2207.

A description is given of liquid replenishment notification.

Specifically, a description is given below of the control of liquid replenishment notification in a case where the second liquid-level detector 58 of the second-liquid-storage-tank fixer 61 does not detect the liquid W. FIG. 24 is a flowchart of liquid replenishment notification control. The liquid replenishment notification control is performed, for example, at the end of a job or after liquid is supplied to the first liquid storage tank 44. In the flowchart of the liquid replenishment notification control illustrated in FIG. 24, the fourth liquid-level detection sensor 581, the fifth liquid-level detection sensor 582, and the sixth liquid-level detection sensor 583 are referred to as a liquid-level sensor 4, a liquid-level sensor 5, and a liquid-level sensor 6, respectively.

The controller 100b turns on the energization of the liquid-level sensors 4 to 6 (step S2401), and checks the output voltage detected between the liquid-level sensor 5 and the liquid-level sensor 6 (step S2402). When the output voltage detected between the liquid-level sensor 5 and the liquid-level sensor 6 is equal to or greater than a threshold value Vs, the controller 100b determines that the liquid W is present in the second-liquid-storage-tank fixer 61 (YES in step S2402), turns off the energization of the liquid-level sensors 4 to 6 (step S2404), and ends the liquid replenishment notification control.

On the other hand, when the output voltage detected between the liquid-level sensor 5 and the liquid-level sensor 6 is less than the threshold value Vs, the controller 100b determines that the liquid W is not present in the second-liquid-storage-tank fixer 61 (NO in step S2402), notifies that the liquid W needs to be replenished to the second liquid storage tank 47 through the operation panel 110 (step S2403), turns off the energization of the liquid-level sensors 4 to 6 (step S2404), and ends the liquid replenishment notification control.

A description is given of liquid supply operation check.

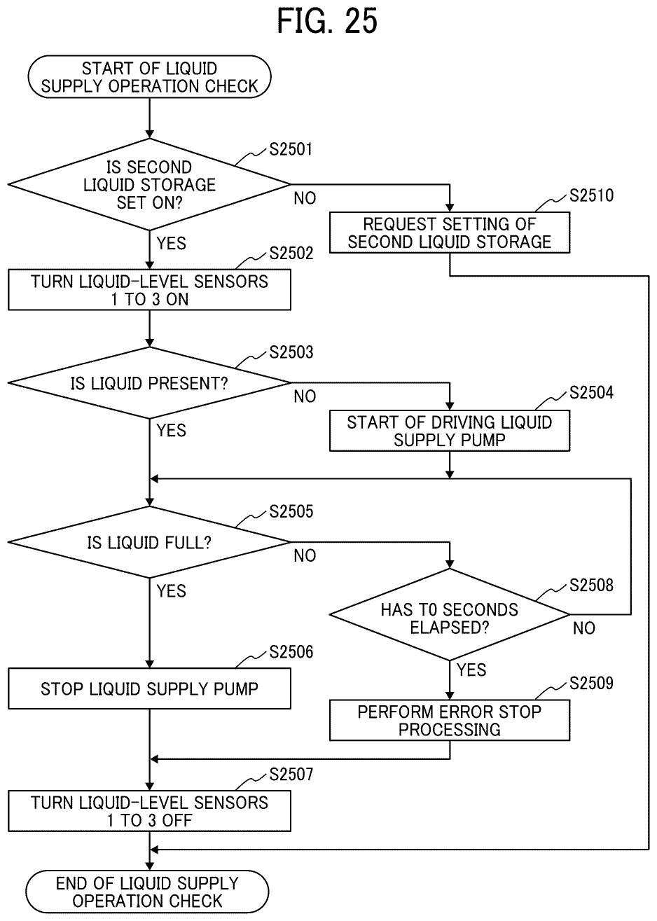

Specifically, a description is given below of the check of the liquid supply operation to the first liquid storage tank 44, which is performed when the second liquid storage tank 47 is set in the second-liquid-storage-tank fixer 61. FIG. 25 is a flowchart of the liquid supply operation check. In the flowchart of the liquid supply operation check illustrated in FIG. 25, the first liquid-level detection sensor 431, the second liquid-level detection sensor 432, and the third liquid-level detection sensor 433 are referred to as a liquid-level sensor 1, a liquid-level sensor 2, and a liquid-level sensor 3, respectively.

When the setting detection sensor 51 detects that the second liquid storage tank 47 is set in the second-liquid-storage-tank fixer 61 (YES in step S2501), the controller 100b turns on the energization of the liquid-level sensors 1 to 3 (step S2502), and determines whether the liquid W is present in the first liquid storage tank 44 (step S2503). When the output voltage detected between the liquid-level sensor 2 and the liquid-level sensor 3 is less than the threshold value Vs, the controller 100b determines that the liquid W is not present in the first liquid storage tank 44 (NO in step S2503), and starts driving the liquid supply pump 46 (step S2504). The controller 100b continues to drive the liquid supply pump 46 until the controller 100b determines that the liquid W is in the full amount state based on the output voltage detected between the liquid-level sensor 1 and the liquid-level sensor 2 (NO in step S2505).

When the output voltage detected between the liquid-level sensor 1 and the liquid-level sensor 2 is equal to or greater than the threshold value Vs, the controller 100b determines that the first liquid storage tank 44 is in the full amount state (YES in step S2505), stops the liquid supply pump 46 (step S2506), turns off the energization of the liquid-level sensors 1 to 3 (step S2507), and ends the liquid supply operation check.

If the liquid W in the first liquid storage tank 44 is not in the full state even after the supply time T0 (sec) has elapsed from the start of driving the liquid supply pump 46 in step S2504 (in the case of NO in step S2505 and YES in step S2508), the controller 100b determines that the first liquid-level detector 43 has failed, executes error stop processing (step S2509) for stopping the liquid supply pump 46, turns off the energization of the liquid-level sensors 1 to 3 (step S2507), and ends the liquid supply operation check.

Further, when the setting detection sensor 51 does not detect that the second liquid storage tank 47 is set in the second-liquid-storage-tank fixer 61 (NO in step S2501), the controller 100b executes a setting request of the second liquid storage tank 47 through the operation panel 110 (step S2510), and ends the liquid supply operation check.

A description is given of an outline of a liquid discharge operation and a process of control of the liquid discharge operation.

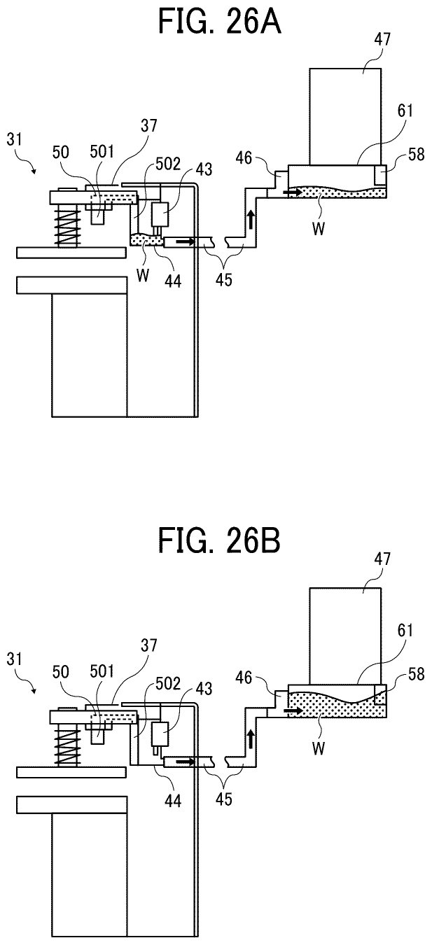

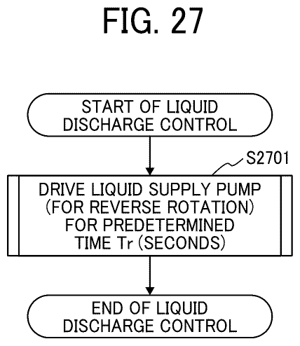

Specifically, a description is given below of a liquid discharge control of controlling a liquid discharge operation executable in the post-processing apparatus 3. FIG. 26 is a diagram illustrating an outline of the liquid discharge operation. FIG. 27 is a flowchart illustrating a process of control of the liquid discharge operation (referred to as “liquid discharge control”). The term “liquid discharge operation” used herein refers to feeding of the liquid W stored in the first liquid storage tank 44 to the second liquid storage tank 47 by the liquid supply pump 46. In other words, the liquid discharge operation is to feed the liquid W in a direction opposite to the supply direction of the liquid W in the above-described liquid supply operation.

Although the first liquid storage tank 44 and the liquid supply member 50 are filled with the liquid W during use, the liquid may need to be drained to prevent leakage of the liquid when the liquid supply member 50 is removed for maintenance or to prevent contamination by the liquid W when the liquid supply member 50 is not used for a long period of time.

When a liquid discharge mode is selected, the liquid supply pump 46 rotates in reverse to suck up the liquid W from the first liquid storage tank 44 (FIG. 26A). As a result, the liquid W is sent to the second-liquid-storage-tank fixer 61. Then, the liquid W is discharged from the first liquid storage tank 44, and the first liquid storage tank 44 becomes empty (FIG. 26B). An operation time Tr of the liquid supply pump 46 is set to a time period during which the liquid W in the first liquid storage tank 44 and the liquid supply member 50 can be sufficiently discharged (step S2701).

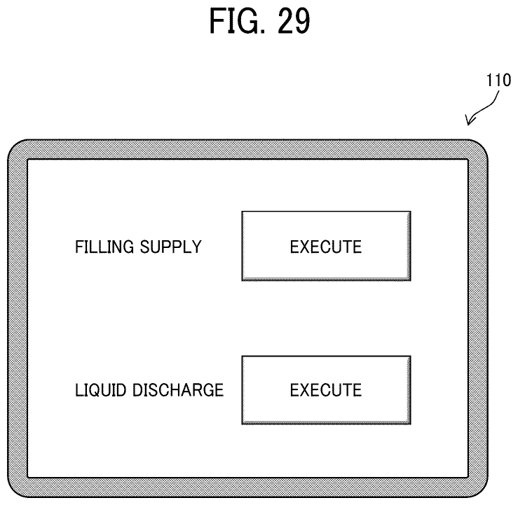

The liquid discharge control may be executed by the user's arbitrary selection on the operation screen of the operation panel 110 as illustrated in FIG. 29. The user can also optionally issue an execution command for the filling supply control through the operation panel 110.

A description is given of a detailed description of the process of control of liquid discharge operation.

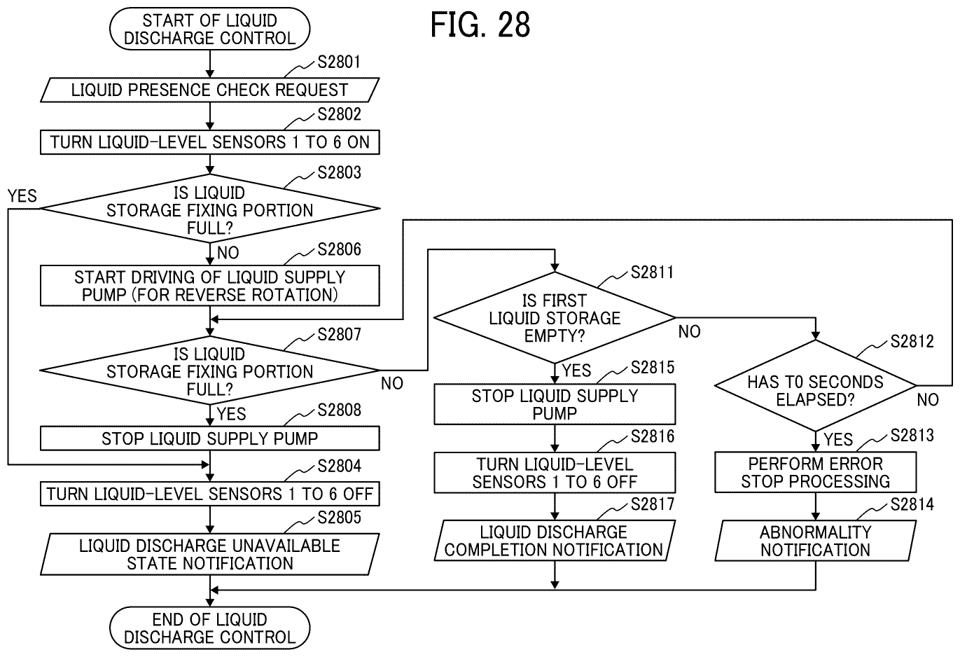

The control of the liquid discharge operation (referred to as “liquid discharge control”) is described below with reference to FIG. 28. FIG. 28 is a detailed flowchart of the liquid discharge control. In the flowchart of the liquid discharge control illustrated in FIG. 28, the first liquid-level detection sensor 431, the second liquid-level detection sensor 432, the third liquid-level detection sensor 433, the fourth liquid-level detection sensor 581, the fifth liquid-level detection sensor 582, and the sixth liquid-level detection sensor 583 are respectively referred to as a liquid-level sensor 1, a liquid-level sensor 2, a liquid-level sensor 3, a liquid-level sensor 4, a liquid-level sensor 5, and a liquid-level sensor 6.

When a liquid presence check request is executed (step S2801), the controller 100b turns on the energization of the liquid-level sensors 1 to 6 (step S2802), and determines whether the liquid W in the second-liquid-storage-tank fixer 61 is in a full amount state (step S2803). When the output voltage detected between the liquid-level sensor 4 and the liquid-level sensor 5 is equal to or greater than a threshold value Vs, the controller 100b determines that the liquid W in the second-liquid-storage-tank fixer 61 is in the full amount state (YES in step S2803), turns off the energization of the liquid-level sensors 1 to 6 (step S2804), notifies that liquid discharge is not executable through the operation panel 110 (step S2805), and ends the liquid discharge control.

When the output voltage detected between the liquid-level sensor 4 and the liquid-level sensor 5 is less than the threshold value Vs, the controller 100b determines that the liquid W in the second-liquid-storage-tank fixer 61 is not in the full amount state (NO in step S2803), and starts the reverse rotation drive of the liquid supply pump 46 (step S2806). The controller 100b continues the reverse rotation drive (liquid discharge operation) of the liquid supply pump 46 until the controller 100b determines that the liquid W in the second-liquid-storage-tank fixer 61 is in the full amount state based on the output voltage detected between the liquid-level sensor 4 and the liquid-level sensor 5 (NO in step S2807).

When the output voltage detected between the liquid-level sensor 4 and the liquid-level sensor 5 is equal to or greater than the threshold value Vs, the controller 100b determines that the liquid W in the second-liquid-storage-tank fixer 61 is in the full amount state (YES in step S2807), stops the liquid supply pump 46 (step S2808), turns off the energization of the liquid-level sensors 1 to 6 (step S2804), notifies the non-executable state of the liquid discharge through the operation panel 110 (step S2805), and ends the liquid discharge control.

If the output voltage detected between the liquid-level sensor 2 and the liquid-level sensor 3 becomes less than the threshold value Vs before the output voltage detected between the liquid-level sensor 4 and the liquid-level sensor 5 becomes equal to or greater than the threshold value Vs, the controller 100b determines that the liquid W in the first liquid storage tank 44 has become absent (in the case of NO in step S2807 and YES in step S2811), stops the liquid supply pump 46 (step S2815), turns off the energization of the liquid-level sensors 1 to 6 (step S2816), notifies the completion of the liquid discharge through the operation panel 110 (step S2817), and ends the liquid discharge control.

Further, when the liquid W in the second-liquid-storage-tank fixer 61 is not in the full amount state and the liquid W in the first liquid storage tank 44 is not present even after the supply time T0 (sec) has elapsed after the start of driving the liquid supply pump 46 in step S2806 (in the case of NO in step S2807 and YES in step S2812), the controller 100b determines that either or both of the first liquid-level detector 43 and the second liquid-level detector 58 is faulty, executes error stop processing (step S2813) to perform processing for stopping the liquid supply pump 46 and turning off the energization of the liquid-level sensors 1 to 6, notifies an abnormality through the operation panel 110 (step S2814), and ends the liquid discharge control.

According to the above-described embodiment, for example, the following operational effects can be obtained.

According to the above-described embodiment, a first liquid level (for example, the full amount state) can be detected between the first liquid-level detection sensor 431 and the second liquid-level detection sensor 432, and a second liquid level lower than the first liquid level can be detected between the second liquid-level detection sensor 432 and the third liquid-level detection sensor 433. Further, the lower ends of the second liquid-level detection sensor 432 and the third liquid-level detection sensor 433 are arranged in substantially the same range including the base end 502 of the liquid supply member 50, thus allowing appropriate detection of whether the base end 502 of the liquid supply member 50 is immersed in the liquid W.

The detection of whether the base end 502 of the liquid supply member 50 is immersed in the liquid W can also be achieved by the arrangement in which the lower end of the second liquid-level detection sensor 432 is located in substantially the same range and the lower end of the third liquid-level detection sensor 433 is located below substantially the same range.

According to the above-described embodiment, the liquid supply member 50 is determined to be in the liquid absorbing state or the dried state according to the determination result of whether the liquid W is present in the first liquid storage tank 44 in step S1503. Changing the supply waiting time T1 or T2 in step S1511 allows the liquid W to be supplied to the liquid applying member 501 while shortening the downtime.

According to the above-described embodiment, the filling supply operation and the additional supply operation are selected according to the determination result of step S1703 for determining whether the base end 502 of the liquid supply member 50 is immersed in the liquid W. Thus, the liquid W can be supplied to the liquid applying member 501 while shortening the downtime.

According to the above-described embodiment, when the liquid W in the first liquid storage tank 44 is not in the full amount state even after the supply time T0 (sec) has elapsed (in the case of NO in step S1508 and YES in step S1518), the controller 100b determines that the first liquid-level detector 43 is faulty, and stops the liquid supply pump 46. Thus, the liquid W can be prevented from overflowing from the first liquid storage tank 44.

According to the above-described embodiment, the second liquid-level detector 58 is also disposed in the second-liquid-storage-tank fixer 61. Thus, the timing of supplying the liquid W to the second liquid storage tank 47 can be appropriately determined. Further, the configuration and arrangement of the fourth to sixth liquid-level detection sensors 581 to 583 are the same as those of the first liquid-level detector 43. Thus, variations in the liquid level of the second-liquid-storage-tank fixer 61 that can be detected by the second liquid-level detector 58 can be increased.

According to the above-described embodiment, when the second liquid storage tank 47 is set in the second-liquid-storage-tank fixer 61 (YES in step S2501), the liquid supply operation is executed (S2504) after the liquid level of the liquid W in the first liquid storage tank 44 is determined (NO in step S2503). Thus, the liquid W can be prevented from being excessively supplied to the first liquid storage tank 44.

In addition, according to the above-described embodiment, executing the liquid discharge control allows the liquid W in the first liquid storage tank 44 to be emptied, for example, at the time of maintenance.

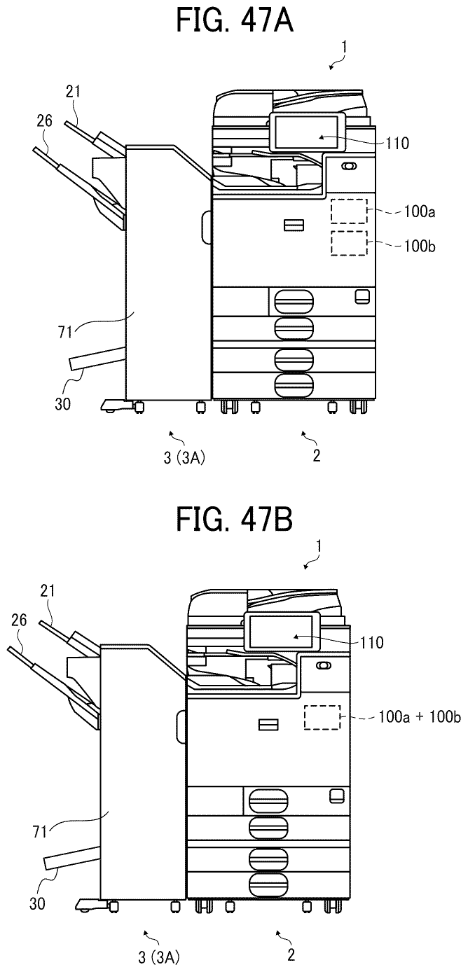

In the above description, the controller 100b of the post-processing apparatus 3 is provided separately from the controller 100a of the image forming apparatus 2 as illustrated in FIG. 1. However, the present disclosure is not limited to the above-described configuration. For example, as illustrated in FIG. 47A, the controller 100b of the post-processing apparatus 3 may be located in the image forming apparatus 2. Further, as illustrated in FIG. 47B, the controller 100b of the post-processing apparatus 3 may be integrated with the controller 100a of the image forming apparatus 2.

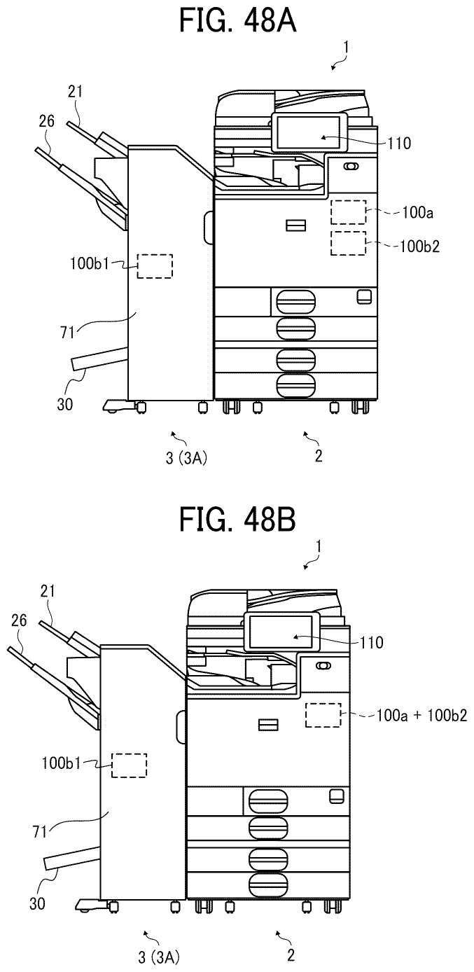

As illustrated in FIG. 48A, the controller 100b of the post-processing apparatus 3 may be divided into a controller 100b1 (of, e.g., a drive system such as a motor) and a controller 100b2 (of, e.g., a detector system such as a sensor) according to the function, and only the controller 100b2 of the post-processing apparatus 3 may be located in the image forming apparatus 2. Further, as illustrated in FIG. 48B, the controller 100b2 of the post-processing apparatus 3 located in the image forming apparatus 2 may be integrated with the controller 100a of the image forming apparatus 2.

A description is given of an edge binder 25 according to another embodiment.

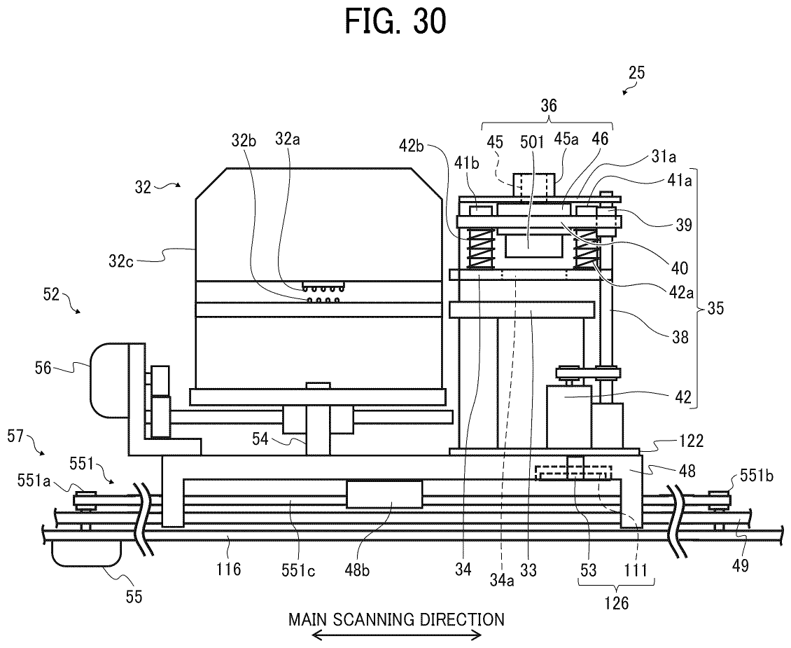

FIG. 30 is an overall view of another embodiment of the edge binder 25 illustrated in FIG. 3. As illustrated in FIG. 30, the crimper 32 includes a crimper pivot assembly 52. The crimper pivot assembly 52 rotates the crimper 32, which includes upper crimping teeth 32a and lower crimping teeth 32b, in the forward and reverse directions about the crimper shaft 54 extending in the thickness direction of the sheet P or sheet bundle Pb supported on the internal tray 22. The crimper pivot assembly 52 includes the crimper shaft 54 and the crimper pivot motor 56. Further, the liquid applier 31 is made rotatable in the forward and reverse directions about a liquid applier shaft 53 extending in the thickness direction of the sheet P or the sheet bundle Pb supported on the internal tray 22. A posture changing lever 111, which is a component of a liquid applier pivot assembly 126 to be described below, is integrally attached to the liquid applier shaft 53.

In other words, the liquid applier shaft 53 and the crimper shaft 54 extend parallel to each other at positions apart from each other in the main scanning direction. The liquid applier shaft 53 rotatably supports the liquid application frame 31a and the liquid application base 122 in forward and reverse directions with respect to the base 48. The crimper shaft 54 rotatably supports the crimping frame 32c in forward and reverse directions with respect to the base 48.

The crimper pivot motor 56 generates a driving force to rotate the crimper 32 in the forward and reverse directions. The driving force of the crimper pivot motor 56 is transmitted to the crimper shaft 54 via a pulley and a timing belt. As a result, the crimping frame 32c is pivoted about the crimper shaft 54 in the forward and reverse directions together with the upper crimping teeth 32a and the lower crimping teeth 32b.

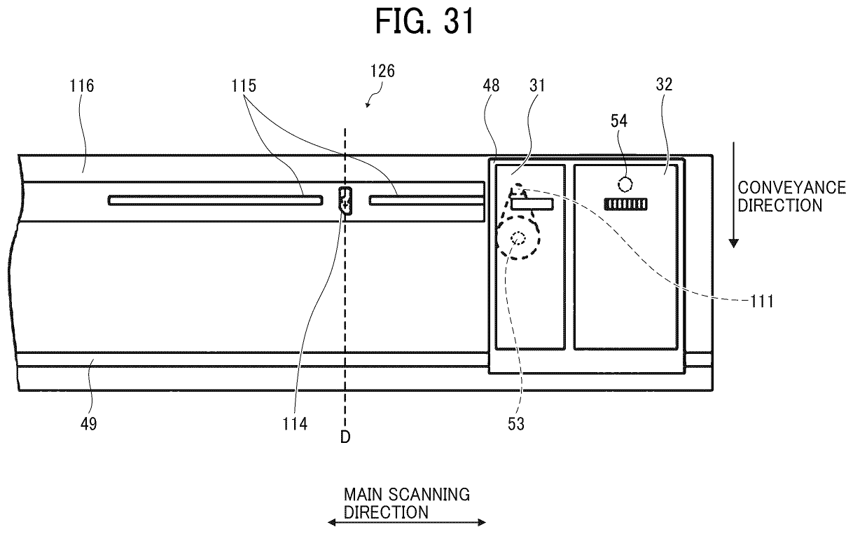

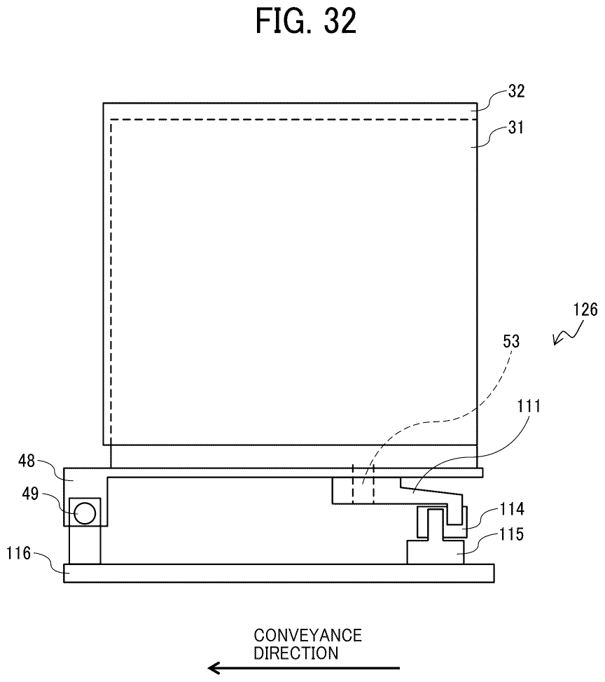

FIGS. 31 and 32 are diagrams illustrating a liquid applier pivot assembly 126 that rotates the above-described liquid applier 31 in the forward and reverse directions. The liquid applier pivot assembly 126 includes the liquid applier shaft 53 and a posture changing lever 111 that is rotatable with the liquid applier shaft 53 as a single unit. The crimper 32 and the liquid applier 31 are supported by the base 48. This base 48 is driven by the edge binder movement motor 55 to move in the main scanning direction on the binding assembly base 116 along the guide shaft 49. The binding assembly base 116 includes a posture changing member 114 and a guide rail 115. The posture changing member 114 is rotatably attached to the binding assembly base 116 at an application posture changing position D in the main scanning direction. As the liquid applier 31 is driven by the edge binder movement motor 55 and moves in the main scanning direction via the base 48, the posture changing lever 111 is rotated.

The posture switching lever 111, the posture changing member 114, and the guide rail 115 are included in the liquid applier rotating mechanism 126 for switching the posture of the liquid applier 31 in accordance with the movement of the liquid applier 31 in the main scanning direction. The posture changing lever 111 is an example of a posture changing member that rotates with the liquid applier 31 as a single unit. The posture changing member 114 and the guide rail 115 are an example of a posture changing member that contacts the posture changing lever 111 and changes the posture of the posture changing lever 111 when the liquid applier 31 moves in the main scanning direction.

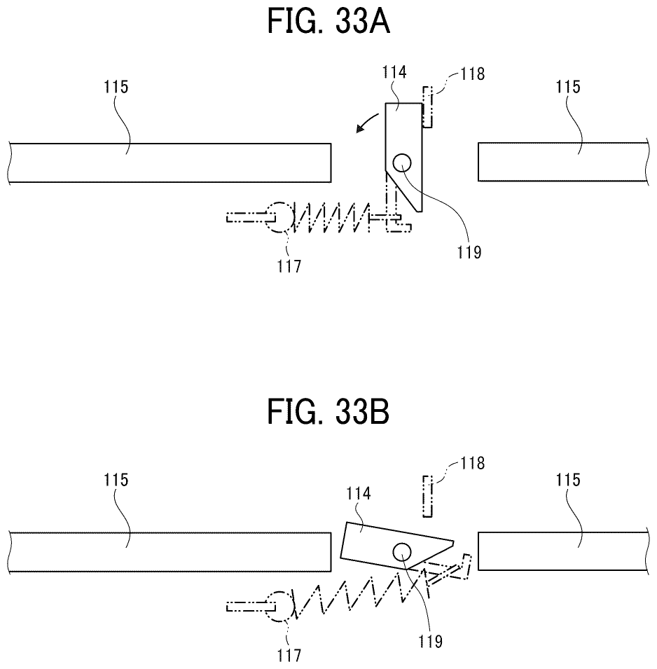

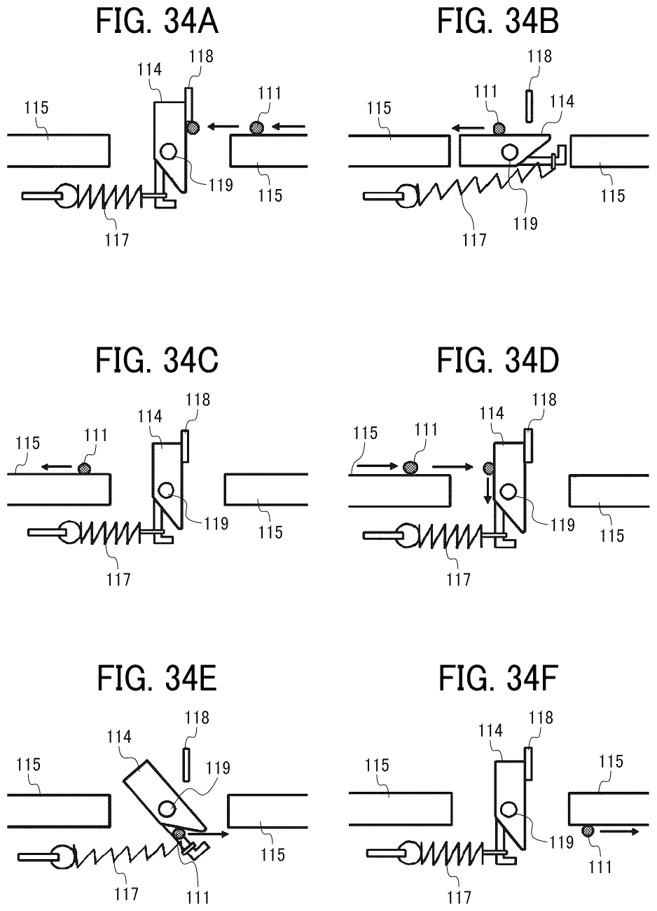

FIGS. 33A and 33B are diagrams each illustrating the configuration of the posture changing member 114 disposed on the binding assembly base 116. FIGS. 34A, 34B, 34C, 34D, 34E, and 34F are diagrams illustrating a series of operations of the posture changing lever 111 by the posture changing member 114.

The posture changing member 114 is rotatably held by a posture changing member rotation shaft 119 disposed on the binding assembly base 116. On the other hand, the posture changing member 114 has one end that is attached to the binding assembly base 116 and the other hand that is biased in one direction (the clockwise direction of the posture changing member rotation shaft 119 in FIGS. 33A and 33B) by a biasing spring 117 that is attached to the posture changing member 114. A posture changing member stopper 118 is disposed on the binding assembly base 116. As illustrated in FIG. 33A, the posture changing member 114 is restricted to rotate in the clockwise direction and is allowed to rotate in the counterclockwise direction (i.e., a direction indicated by arrow A in FIG. 33A).

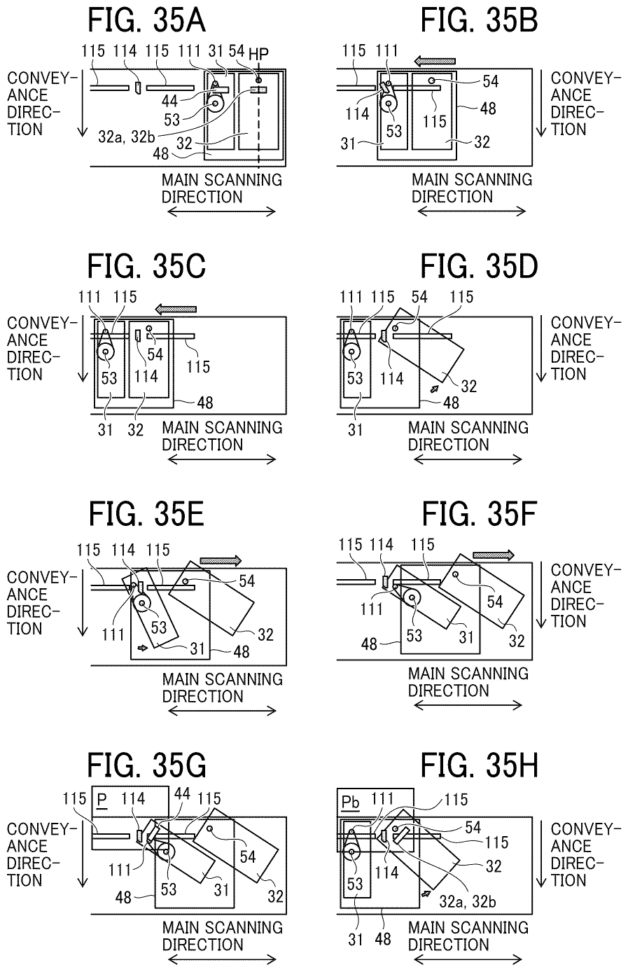

The liquid applier 31 can be changed or pivoted by the liquid applier pivot assembly 126 between a “parallel application posture” illustrated in FIGS. 35A, 35B, 35C, 35D, and 35H and an “inclined application posture” illustrated in FIGS. 35E, 35F, and 35G. The “parallel application posture” is a posture of the liquid applier 31 when the lateral direction of the liquid applier 31 (the longitudinal direction of the liquid applying member 501) is in the main scanning direction. The “inclined application posture” is a posture of the liquid applier 31 when the lateral direction of the liquid applier 31 is inclined to the main scanning direction.

The crimper 32 can be changed or pivoted by the crimper pivot assembly 52 between a “parallel binding posture” illustrated in FIGS. 35A, 35B, and 35C and an “inclined binding posture” illustrated in FIGS. 35D, 35E, 35F, 35G, and 35H. The “parallel binding posture” is a posture of the crimper 32 when the lateral direction of the crimper 32 (the longitudinal direction of the upper crimping teeth 32a and the lower crimping teeth 32b) is in the main scanning direction. The “inclined binding posture” is a posture of the crimper 32 when the lateral direction of the crimper 32 is inclined to the main scanning direction.

The liquid application position of the liquid applier 31 in the parallel application posture and the binding position of the crimper 32 in the parallel binding posture have the longitudinal directions facing the same direction. Similarly, the liquid application position of the liquid applier 31 in the inclined application posture and the binding position of the crimper 32 in the inclined binding posture have the longitudinal directions facing the same direction. In other words, the liquid applier 31 and the crimper 32 rotate between the two postures by the same angle of rotation. The liquid application position of the liquid applier 31 in the parallel application posture and the binding position of the crimper 32 in the parallel binding posture are overlaid on one after another. Similarly, the liquid application position of the liquid applier 31 in the inclined application posture and the binding position of the crimper 32 in the inclined binding posture are overlaid on one after another.

FIGS. 35A, 35B, 35C, 35D, 35E, 35F, 35G, and 35H are diagrams illustrating the operation procedure for changing the crimper 32 and the liquid applier 31 to the “inclined binding posture” and “inclined application posture,” respectively.

As illustrated in FIG. 35A, the crimper 32 and the liquid applier 31 are located at the standby position HP outside the sheet width area. The posture changing lever 111 is disposed above the guide rail 115. Then, as illustrated in FIG. 35B, the crimper 32 and the liquid applier 31 are moved in the left side direction (the direction in the arrow illustrated in FIG. 35B) while pushing and opening the posture changing member 114.

When the liquid applier 31 is changed to the inclined application posture, the edge binder movement motor 55 is driven to move the base 48 holding the crimper 32 and the liquid applier 31 to the left side direction. Since the pivot of the posture changing member 114 in the counterclockwise direction is not restricted, the posture changing lever 111 is pushed to climb over the posture changing member 114 (see FIGS. 34A and 34B).

Then, as illustrated in FIG. 35C, after the posture changing lever 111 has passed over the posture changing member 114, the driving of the edge binder movement motor 55 is stopped to temporarily stop the movement of the base 48 to the left side in the main scanning direction. At this time, the posture changing member 114 is biased by the biasing spring and returns to the pivot restricting posture (see FIG. 34C).

Then, as illustrated in FIG. 35D, the crimper pivot motor 56 generates a driving force to rotate the crimper 32 in the forward and reverse directions. The driving force of the crimper pivot motor 56 is transmitted to the crimper shaft 54 via a pulley and a timing belt. As a result, the crimping frame 32c is pivoted about the crimper shaft 54 in the forward and reverse directions together with the upper crimping teeth 32a and the lower crimping teeth 32b. As a result, the crimper 32 changes the posture to the inclined binding posture.

Then, as illustrated in FIG. 35E, the base 48 holding the crimper 32 and the liquid applier 31 is moved to the right side (the direction indicated by arrow in FIG. 35E) in the main scanning direction. Even if the posture changing lever 111 contacts the posture changing member 114, the posture changing member 114 is restricted not to rotate in the clockwise direction. Due to such a configuration, even if the base 48 is moved to the right-side direction, the posture changing lever 111 is not allowed to move in the right side and starts to rotate to the inclined posture (see FIGS. 34D and 34E).

Then, as illustrated in FIG. 35F, the base 48 holding the crimper 32 and the liquid applier 31 is moved to the right side in the main scanning direction. The posture changing lever 111 is moved, while rotating, toward the lower side of the guide rail 115. The posture changing lever 111 is moved toward the lower side of the guide rail 115 (lower than the posture changing member shaft 119 of the posture changing lever 111) and is moved in the main scanning direction. As a result, the posture changing member 114 is rotated in the counterclockwise direction against the biasing force of the biasing spring 117. Further, as the base 48 is moved in the right side, the posture changing lever 111 is moved to the right side while the posture changing lever 111 climbs over the posture changing member 114 (see FIGS. 34E and 34F). As a result, the rotation of the liquid applier 31 to the inclined application posture completes.

In other words, when the posture changing lever 111 passes the posture changing member 114 from one end (on the left side) to the other end (on the right side) in the main scanning direction, the liquid applier 31 is rotated from the parallel application posture to the inclined application posture. Further, when the liquid applier 31 is rotated from the parallel application posture to the inclined application posture, the crimper 32 is rotated to the inclined binding posture in advance, and then the liquid applier 31 is rotated to the inclined application posture.

Then, as illustrated in FIG. 35G, the base 48 holding the crimper 32 and the liquid applier 31 is moved to the right side. When the liquid applier 31 in the inclined application posture is moved to the liquid application position, the liquid applying member 501 is brought into contact with and separated from the sheet P to execute liquid application.

Then, as illustrated in FIG. 35H, after the stack of the sheet bundle Pb including a given number N of multiple sheets P is completed, the base 48 holding the crimper 32 and the liquid applier 31 is moved to the left side. After the crimper 32 in the inclined binding posture is moved to the binding position, the upper crimping teeth 32a and the lower crimping teeth 32b are brought into contact with and separated from the sheet bundle Pb to execute the crimp binding operation.

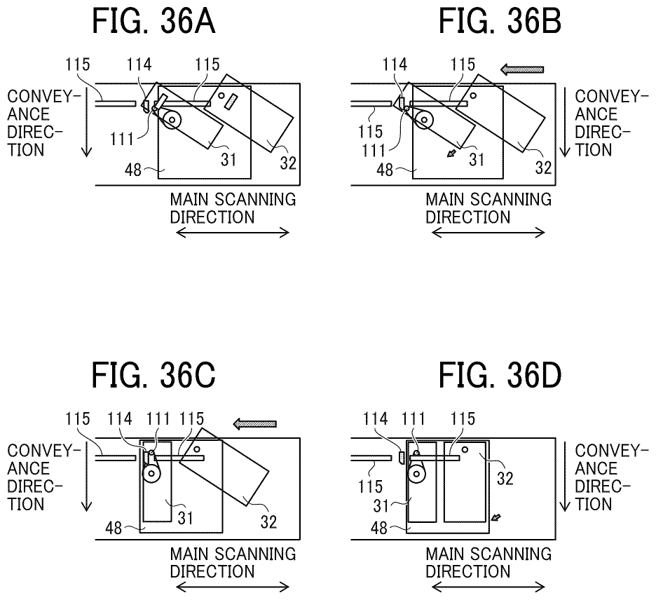

FIGS. 36A, 36B, 36C, and 36D are diagrams illustrating the operation procedure for changing the crimper 32 and the liquid applier 31 to the “parallel binding posture” and the “parallel application posture” (also the postures at the standby position HP). As illustrated in FIG. 36A, first, the crimper 32 and the liquid applier 31 are in the inclined binding position and the parallel application posture.

Then, as illustrated in FIG. 36B, the base 48 holding the crimper 32 and the liquid applier 31 is moved to the left side (the direction indicated by the arrow in FIG. 36B). Even if the posture changing lever 111 contacts the posture changing member 114, the posture changing member 114 is restricted not to rotate in the clockwise direction. Due to such a configuration, even if the base 48 is moved to the left side direction, the posture changing lever 111 is not allowed to move in the left side and starts to rotate in the clockwise direction in FIG. 36B.

Then, as illustrated in FIG. 36C, the base 48 is moved to the left side. The posture changing lever 111 is moved, while rotating, toward the upper side of the guide rail 115. When the posture changing lever 111 is moved to the upper side of the guide rail 115, the base 48 is moved to the right side at a timing at which the posture changing lever 111 does not climb over the posture changing member 114, to complete the rotation of the liquid applier 31 to the parallel application posture.

In other words, when the posture changing lever 111 passes the posture changing member 114 from the other end (the right side) to the one end (the left side) in the main scanning direction, the liquid applier 31 is rotated from the inclined application posture to the parallel application posture. Further, when the liquid applier 31 is rotated from the inclined application posture to the parallel application posture, the liquid applier 31 is rotated to the parallel application posture in advance, and then the crimper 32 is rotated to the parallel binding posture.

With the configuration of described above, the rotation to the parallel binding posture (parallel application posture) and the inclined binding posture (inclined application posture) can be achieved with the posture changing lever 111 and the posture changing member 114. Further, shifting the rotation timings of the liquid applier 31 and the crimper 32 from each other can achieve simpler control than in a case where the liquid applier 31 and the crimper 32 are rotated together. Furthermore, when the crimper 32 and the liquid applier 31 are rotated to the inclined binding posture and the inclined application posture, the liquid applier 31 is rotated after the crimper 32. When the crimper 32 and the liquid applier 31 are rotated to the parallel binding posture and the parallel application posture, the crimper 32 is rotated after the liquid applier 31. Thus, interference between the liquid applier 31 and the crimper 32 can be avoided.

Then, as illustrated in FIG. 36D, the crimper 32 is rotated clockwise in FIG. 36D by driving the crimper pivot motor 56, and the movement of the crimper 32 to the parallel binding posture is completed.

The liquid applier shaft 53 has a configuration of rotating together with the posture changing lever 111 in the above-described embodiment. However, the liquid applier shaft 53 may have a configuration of rotating in conjunction with the posture changing lever 111 at a place separated from the posture changing lever 111 via a gear train or a timing belt.

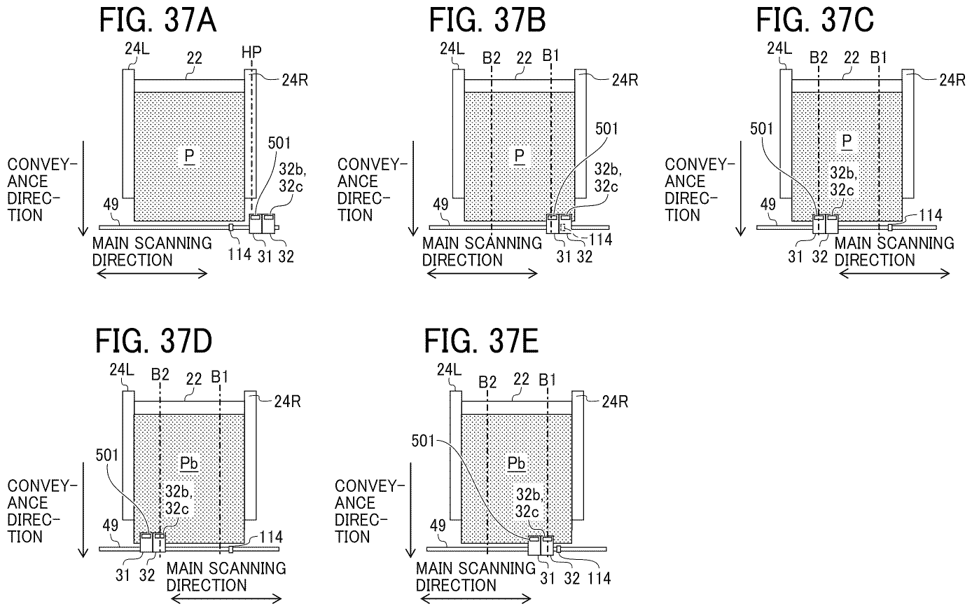

FIGS. 37A, 37B, 37C, 37D, and 37E illustrate a case of performing parallel binding on a plurality of positions of a sheet bundle Pb in the width direction of the sheet bundle Pb in a “parallel binding posture” (first binding posture) in which a longitudinal direction (i.e., the long side) of a front edge of each of the upper crimp teeth 32a, the lower crimp teeth 32b, and the liquid applying member 501 is aligned with the main scanning direction.

First, before a sheet P is conveyed to the internal tray 22, the edge binder 25 is moved from the standby position HP illustrated in FIG. 37A to the first liquid application position B1 illustrated in FIG. 37B such that the liquid applier 31 is located at the first liquid application position B1.

Then, when the alignment of the sheet P supported by the internal tray 22 in the main scanning direction and the conveyance direction ends, the liquid applier 31 located at the first liquid application position B1 executes the liquid application to the sheet P. When the liquid application at the first liquid application position B1 ends, the liquid applier 31 moves to the second liquid application position B2 as illustrated in FIG. 37C. When the movement ends, the liquid applier 31 executes the liquid application on the sheet P at the second liquid application position B2.

The above-described liquid application process illustrated in FIGS. 37B and 37C is repeatedly executed until the number of sheets P stored in the internal tray 22 reaches a given number N (the number of sheets constituting the sheet bundle Pb).

When the number of sheets P stored in the internal tray 22 reaches the given number N, as illustrated in FIG. 37D, the edge binder 25 is moved in the main scanning direction such that the crimper 32 is located at the second binding position B2. When the movement ends, the crimper 32 executes crimp binding on the sheet bundle Pb at the second binding position B2. When the crimp binding at the second binding position B2 ends, as illustrated in FIG. 37E, the edge binder 25 is moved in the main scanning direction such that the crimper 32 is positioned at the first binding position B1. When the movement ends, the crimper 32 executes crimp binding on the sheet bundle Pb at the first binding position B1.

When the crimp binding process at the first binding position B1 ends, the edge binder 25 is moved to the standby position HP in FIG. 37A and the binding process ends.

Although the example with one liquid applier 31 and one crimper 32 has been described in the above-described embodiment, the number of the liquid applier 31 and the crimper 32 are not limited to the above-described example. In another example, two liquid appliers 31L and 31R and two crimpers 32 L and 32R may be provided.

According to the above-described embodiment, the liquid supply control is performed in response to the state of the liquid storage in the post-processing apparatus 3, thus appropriately holding the liquid in the liquid storage. In other words, the replenishing operation of liquid is controlled in accordance with the operation status of the post-processing apparatus 3. As a result, the liquid is stably supplied to the liquid applier, thus allowing enhancement of binding qualities. In addition, since the time required for the crimp binding operation can be shortened, the wait time of the user can be optimized, thus allowing enhancement of the convenience for the user.

A description is given below of a post-processing apparatus 3 according to a second embodiment.

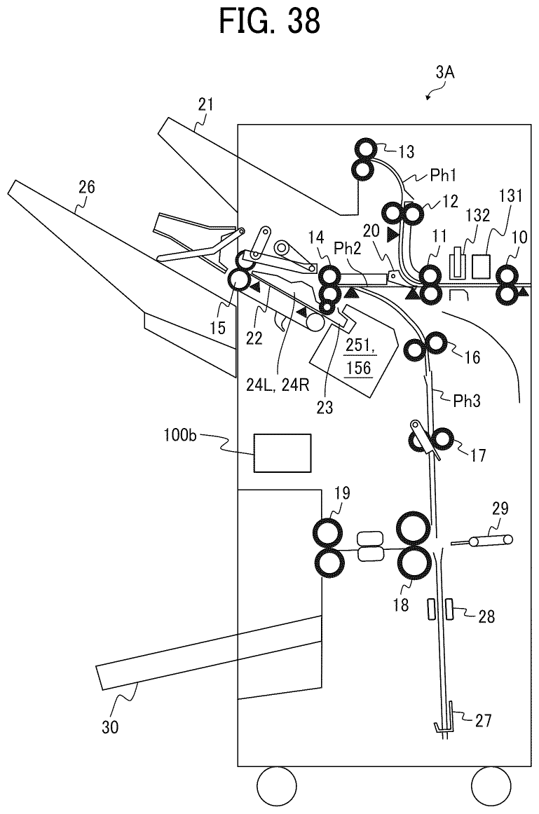

A post-processing apparatus 3A according to the second embodiment is described with reference to FIGS. 38 to 46. In the following description, components like those of the post-processing apparatus 3 according to the first embodiment are denoted by like reference numerals, and redundant descriptions thereof may be omitted.

The post-processing apparatus 3A according to the second embodiment includes an edge binder 251. The edge binder 251 is different from the edge binder 25 of the post-processing apparatus 3 according to the first embodiment, in which the liquid applier 31 and the crimper 32 are arranged side by side, in that the edge binder 251 includes a crimper 32′ and a liquid applier 131 is disposed at an upstream position in a direction in which a sheet P is conveyed. Such a configuration allows a given number of sheets P to be stacked after the liquid application process and conveyed to the crimper 32′ of the edge binder 251 disposed at a downstream position in the direction in which the sheet P is conveyed. Accordingly, the productivity of the binding process performed by the crimper 32′ is enhanced.

Since the direction in which the conveyance roller pairs 10, 11, and 14 convey the sheet P is opposite to the “conveyance direction” defined above, the direction in which the conveyance roller pairs 10, 11, and 14 convey the sheet P is defined as an “opposite conveyance direction” in the following description. A direction that is orthogonal to both the opposite conveyance direction and the thickness direction of the sheet P is defined as the “main scanning direction” or the “width direction of the sheet P.” The liquid application position to which the liquid is applied on the sheet P or the sheet bundle Pb by the liquid applier 131 corresponds to the binding position on the sheet bundle Pb to be crimped by the crimper 32. For this reason, in the following description, the liquid application position and the binding position are denoted by the same reference sign (B1).

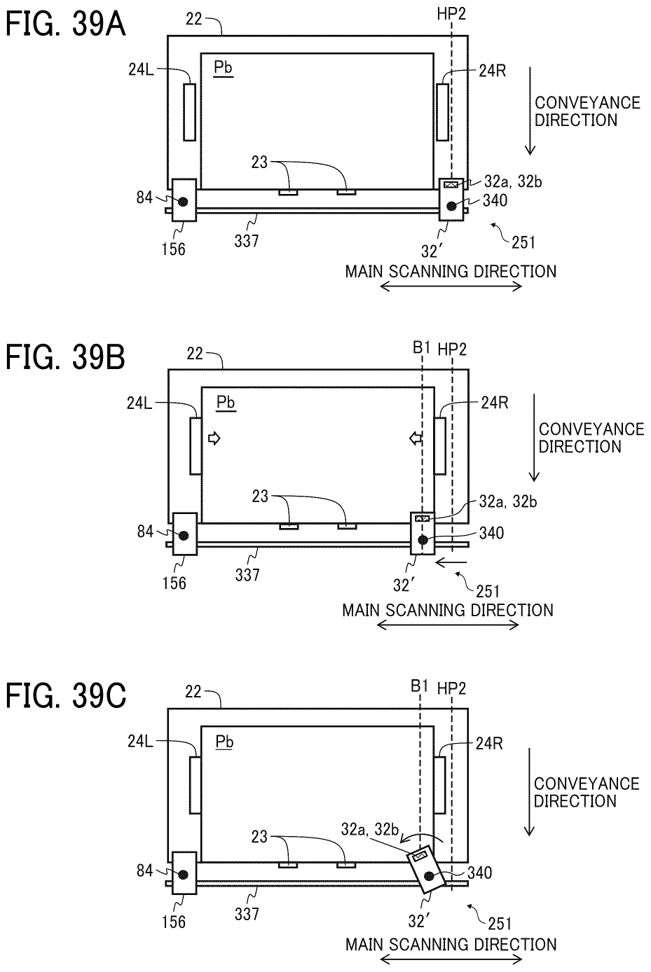

FIG. 38 is a diagram illustrating an internal configuration of the post-processing apparatus 3A according to the second embodiment. As illustrated in FIGS. 39A, 39B, and 39C, the edge binder 251 includes only the crimper 32′. As illustrated in FIGS. 38A, 38B, and 38C, the crimper 32′ and a staple binder 156 are disposed downstream from the internal tray 22 in the conveyance direction. In addition, the crimper 32′ and the staple binder 156 are located to face a downstream end, in the conveyance direction, of the sheet bundle Pb placed on the internal tray 22 and is movable in the main scanning direction.

Further, the crimper 32′ and the staple binder 156 are respectively rotatable in the forward and reverse directions about a crimper shaft 340 and a stapler shaft 84 both extending in the thickness direction of the sheet bundle Pb placed on the internal tray 22. In other words, the crimper 32′ and the staple binder 156 bind, at a desired angle, a desired position in the main scanning direction on the sheet bundle Pb placed on the internal tray 22 in, for example, corner oblique binding, parallel one-point binding, or parallel two-point binding.

The crimper 32′ presses and deforms the sheet bundle Pb with the serrate upper crimping teeth 32a and the serrate lower crimping teeth 32b to bind the sheet bundle Pb. In the following description, such a binding way may be referred to as “crimping.” In other words, the crimper 32′ crimps and binds the sheet bundle Pb or performs the crimping on the sheet bundle Pb. On the other hand, the staple binder 156 passes the staple through a binding position on the sheet bundle Pb placed on the internal tray 22 to staple the sheet bundle Pb.

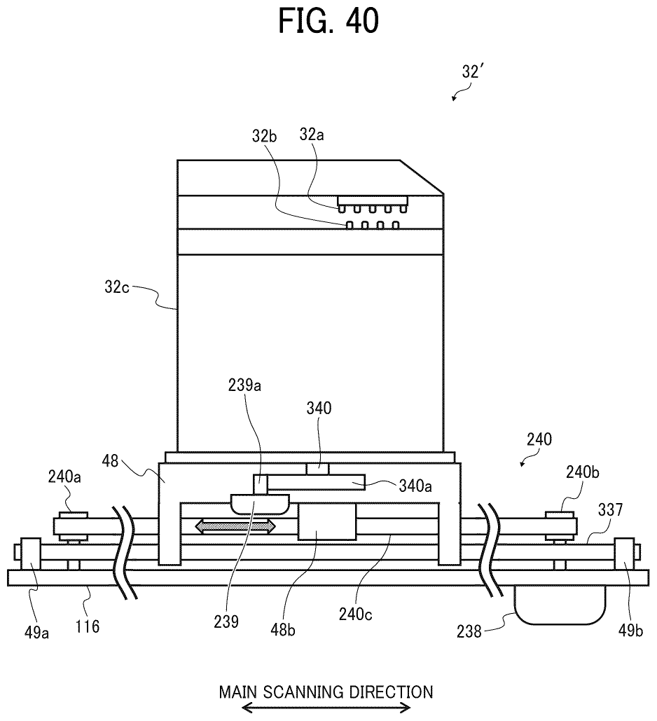

FIGS. 39A, 39B, and 39C are schematic views of the internal tray 22 as viewed from the thickness direction of the sheet bundle Pb. FIG. 40 is a schematic view of the crimper 32′ as viewed from the conveyance direction. As illustrated in FIGS. 39A, 39B, and 39C, the crimper 32′ and a staple binder 156 are disposed downstream from the internal tray 22 in the conveyance direction. The crimper 32′ is movable in the main scanning direction along the surface of the sheet bundle Pb placed on the internal tray 22. Further, the crimper 32′ is rotatable in the forward and reverse directions about a crimper shaft 340 extending in the thickness direction of the sheet bundle Pb placed on the internal tray 22.

Similarly, the staple binder 156 is movable in the main scanning direction of the sheet bundle Pb. Further, the staple binder 156 is rotatable in the forward and reverse directions about a stapler shaft 84 extending in thickness direction of the sheet bundle Pb. The other components of the staple binder 156 are similar to, even if not the same as, those of the staple binder 155 (see FIG. 6) of the post-processing apparatus 3 according to the first embodiment. For this reason, a detailed description thereof is omitted.

As illustrated in FIG. 40, the crimper 32′ includes a guide rail 337 extending in the main scanning direction at a position downstream from the internal tray 22 in the conveyance direction. The crimper 32′ includes a crimper movement motor 238 as a driving source. The base 48 supporting the crimping frame 32c has a fastening portion 48b for fastening the timing belt 240c at the bottom of the base 48. The driving force of the crimper movement motor 238 is transmitted to the base 48 by the drive transmission assembly 240 that includes the pullies 240a and 240b, the timing belt 240c, and the fastening portion 48b. By so doing, the crimper 32′ is moved in the main scanning direction along the surface of the sheet bundle Pb placed on the internal tray 22, in other words, along the guide rail 337. A crimper shaft 340 including a drive transmission gear 340a is fixed to a bottom face of the crimping frame 32c that holds the components of the crimper 32.

The crimper shaft 340 and the drive transmission gear 340a are held by the base 48 on which the crimping frame 32c is disposed, so as to be rotatable in the forward and reverse directions. The drive transmission gear 340a meshes with an output gear 239a of a crimper pivot motor 239. When the driving force of the crimper pivot motor 239 is transmitted to the crimper shaft 340 via the output gear 239a and the drive transmission gear 340a, the crimper 32′ rotates in the forward and reverse directions on the base 48 about the crimper shaft 340 extending in the thickness direction of the sheet P placed on the internal tray 22. The guide rail 337, the crimper movement motor 238, the crimper pivot motor 239, the crimper shaft 340, and the drive transmission assembly 240 constitute at least part of a driving assembly of the crimper 32′ according to the present embodiment.

The crimper 32′ is movable between a standby position HP illustrated in FIG. 39A and a position where the crimper 32′ faces the first binding position B1 illustrated in FIGS. 39B and 39C. The standby position HP2 is away in the main scanning direction from the sheet bundle Pb placed on the internal tray 22. For example, in FIGS. 39A, 39B, and 39C, the standby position HP is distanced to the right of the sheet bundle Pb along the main scanning direction. The first binding position B1 is a position on the sheet bundle Pb placed on the internal tray 22. However, the specific position of the first binding position B1 is not limited to the position illustrated in FIGS. 39B and 39C. The first binding position B1 may be one or more positions along the main scanning direction at the downstream end, in the conveyance direction, of the sheet P.

The posture of the crimper 32′ changes or is pivoted between a parallel binding posture illustrated in FIG. 39B and an oblique binding posture illustrated in FIG. 39C. In other words, the crimper 32′ is rotatable in the forward and reverse directions about the crimper shaft 340. The parallel binding posture is a posture of the crimper 32′ in which the longitudinal direction of the upper crimping teeth 32a and the lower crimping teeth 32b (in other words, a rectangular crimp binding trace) is along the main scanning direction. The oblique binding posture is a posture of the crimper 32′ in which the longitudinal direction of the upper crimping teeth 32a and the lower crimping teeth 32b (i.e., the rectangular crimp binding trace) is inclined with respect to the main scanning direction.

The pivot angle, which is an angle of the upper crimping teeth 32a and the lower crimping teeth 32b with respect to the main scanning direction, in the oblique binding posture is not limited to the angle illustrated in FIG. 39C. The pivot angle in the oblique binding posture may be any angle provided that the upper crimping teeth 32a and the lower crimping teeth 32b face the sheet bundle Pb placed on the internal tray 22.

The post-processing apparatus 3A includes the liquid applier 131 and a hole punch 132 serving as a processor. The liquid applier 131 and the hole punch 132 are disposed upstream from the internal tray 22 in the opposite conveyance direction. In addition, the liquid applier 131 and the hole punch 132 are disposed at different positions in the opposite conveyance direction to simultaneously face one sheet P that is conveyed by the conveyance roller pairs 10 to 19.

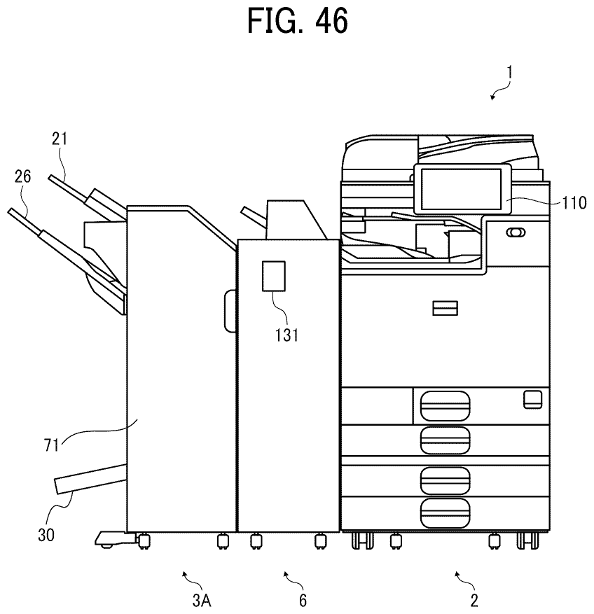

The liquid applier 131 and the hole punch 132 according to the present embodiment are disposed between the conveyance roller pairs 10 and 11. However, the arrangement of the liquid applier 131 is not limited to the example of FIG. 38. For example, in a case where an inserter 6 is disposed between the image forming apparatus 2 and the post-processing apparatus 3A as illustrated in FIG. 46, the liquid applier 131 may be disposed inside the inserter 6 located upstream from the post-processing apparatus 3A in a direction in which the sheet P is conveyed from the image forming apparatus 2 to the post-processing apparatus 3A. Examples of the inserter 6 include, but are not limited to, an apparatus that allows a pre-printed medium, which is to be conveyed to the post-processing apparatus 3A together with the sheet P conveyed from the image forming apparatus 2, to be fed as a cover sheet, an insertion sheet, or a partition sheet without passing through the image forming apparatus 2.

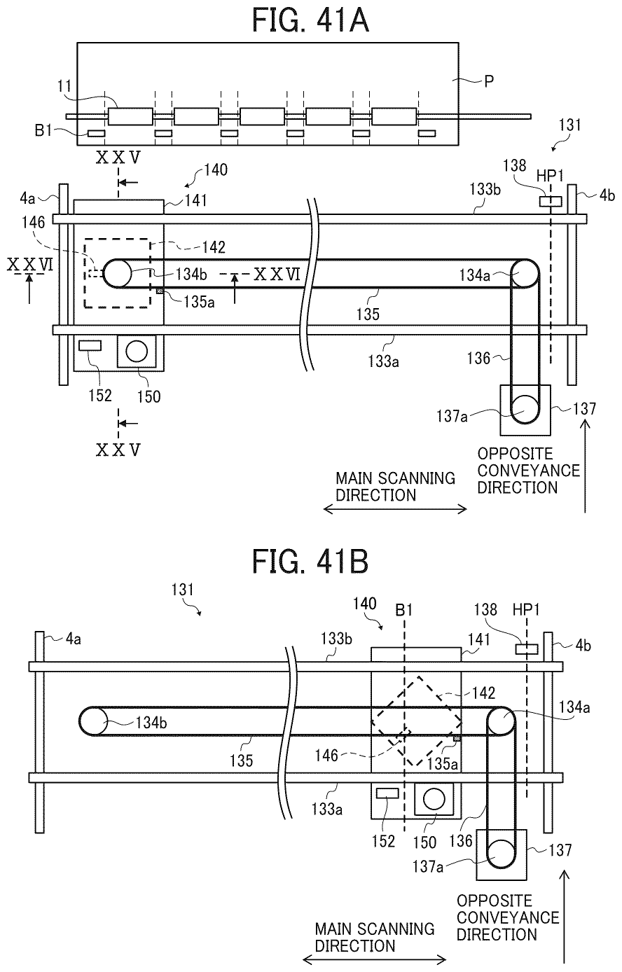

As illustrated in FIG. 41A, the conveyance roller pair 11 is located so as not to overlap, in the main scanning direction, the first liquid application position B1 on the sheet P to which the liquid has been applied by a liquid application head 146 of the liquid applier 131. This arrangement is to prevent the amount of liquid at the first liquid application position B1 from decreasing due to the multiple roller pairs pressing the first liquid application position B1 when the conveyance roller pair 11 conveys the sheet P. As a result, when the sheet P reaches the crimper 32′ disposed downstream from the liquid applier 131 in the opposite conveyance direction, the amount of liquid at the first liquid application position B1 is sufficient to maintain the binding strength. Accordingly, the binding strength of the sheet bundle Pb is prevented from decreasing due to a decrease in the amount of liquid at the first liquid application position B1 (corresponding to the first binding position B1) while the sheet P is conveyed.

In addition, the multiple roller pairs of the conveyance roller pair 11 that is located so as not to overlap the first liquid application position B1 on the sheet P in the main scanning direction prevents the conveying performance of the sheet P from being worse due to the adhesion of liquid to the multiple roller pairs and further prevents a conveyance jam caused by the worsened conveying performance of the sheet P.

Although only the conveyance roller pair 11 has been described above, the multiple roller pairs of the conveyance roller pairs 14 and 15 are preferably located so as not to overlap the first liquid application position B1 on the sheet P in the main scanning direction, like the multiple roller pairs of the conveyance roller pair 11.

The liquid applier 131 applies liquid to the sheet P that is conveyed by the conveyance roller pairs 10 and 11. In the following description, the application of liquid may be referred to as “liquid application.” The hole punch 132 punches a hole in the sheet P that is conveyed by the conveyance roller pairs 10 and 11 such that the hole penetrates the sheet P in the thickness direction of the sheet P. The processor disposed near the liquid applier 131 is not limited to the hole punch 132. Alternatively, the processor may be an inclination corrector that corrects an inclination or skew of the sheet P that is conveyed by the conveyance roller pairs 10 and 11.

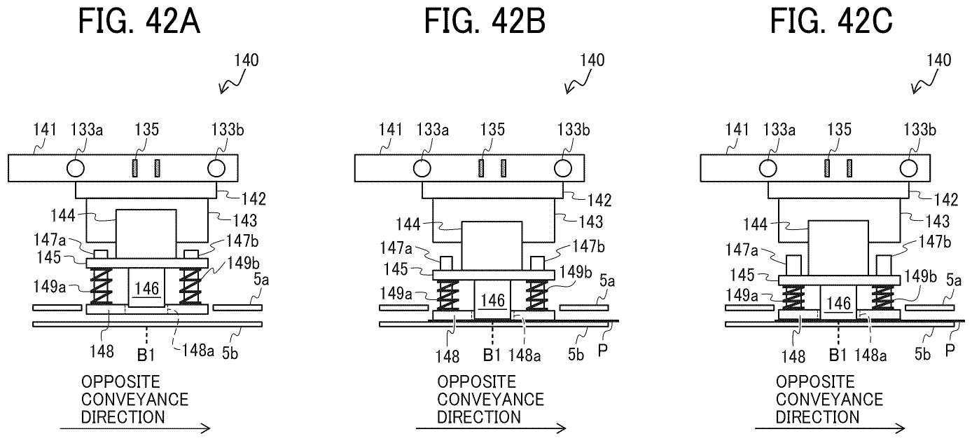

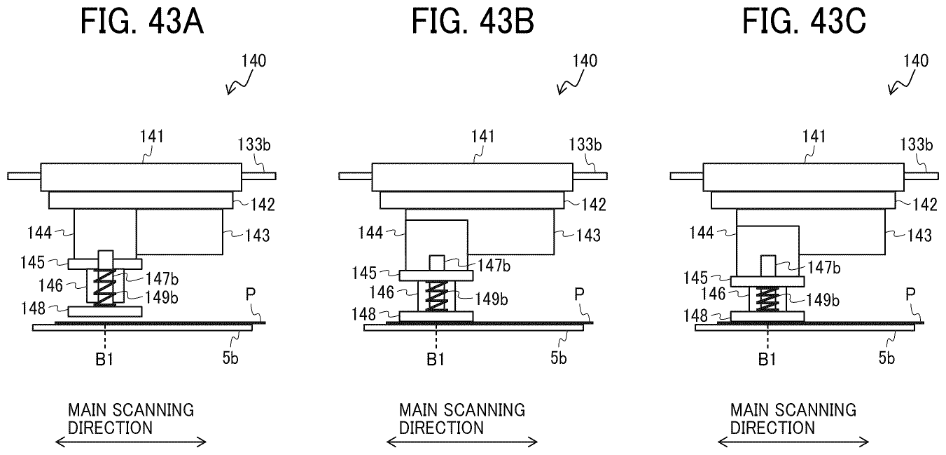

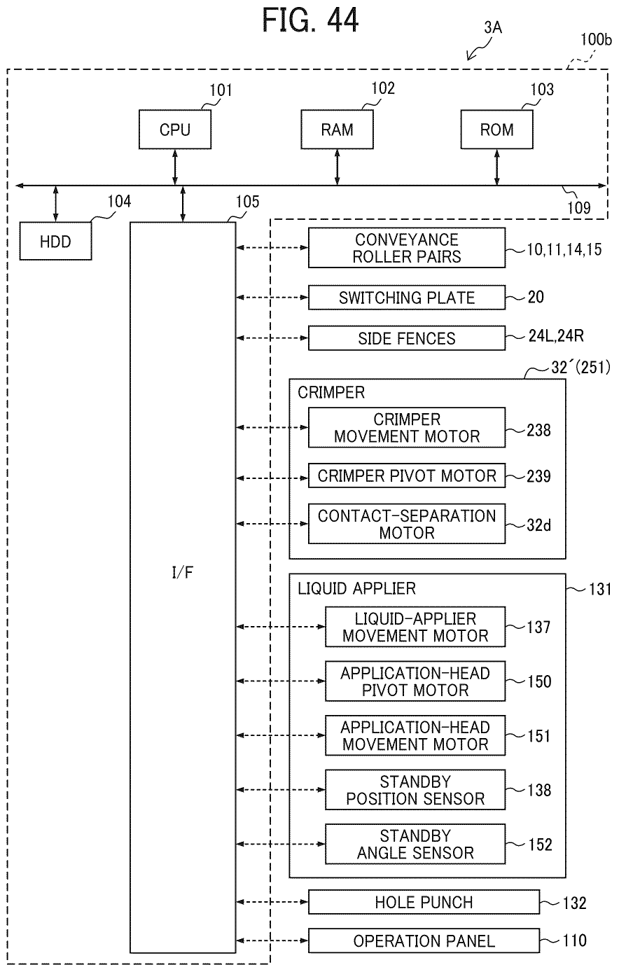

FIGS. 41A and 41B are views of the liquid applier 131 in the thickness direction of the sheet P, according to the second embodiment. FIGS. 42A, 42B, and 42C are cross-sectional views of the liquid applier 131 taken along line XXV-XXV of FIG. 41A. FIGS. 43A, 43B, and 43C are cross-sectional views of the liquid applier 131 taken along line XXVI-XXVI of FIG. 41A. As illustrated in FIGS. 41A to 43C, the liquid applier 131 includes a pair of guide shafts 133a and 133b, a pair of pulleys 134a and 134b, endless annular belts 135 and 136, a liquid-applier movement motor 137, a standby-position sensor 138 (see FIG. 44), and a liquid application unit 140.

The guide shafts 133a and 133b, each extending in the main scanning direction, are spaced apart from each other in the opposite conveyance direction. The pair of guide shafts 133a and 133b are supported by a pair of side plates 4a and 4b of the post-processing apparatus 3A. The pair of guide shafts 133a and 133b support the liquid application unit 140 such that the liquid application unit 140 can move in the main scanning direction.

The pair of pulleys 134a and 134b is disposed between the guide shafts 133a and 133b in the opposite conveyance direction. The pulleys 134a and 134b are spaced apart from each other in the main scanning direction. The pair of pulleys 134a and 134b are supported by a frame of the post-processing apparatus 3A so as to be rotatable about an axis extending in the thickness direction of the sheet P.

The endless annular belt 135 is looped around the pair of pulleys 134a and 134b. The endless annular belt 135 is coupled to the liquid application unit 140 by a connection 135a. The endless annular belt 136 is looped around the pulley 134a and a driving pulley 137a that is fixed to an output shaft of the liquid-applier movement motor 137. The liquid-applier movement motor 137 generates a driving force to move the liquid application unit 140 in the main scanning direction.

As the liquid-applier movement motor 137 rotates, the endless annular belt 136 circulates around the pulley 134a and the driving pulley 137a to rotate the pulley 134a. As the pulley 134a rotates, the endless annular belt 135 circulates around the pair of pulleys 134a and 134b. As a result, the liquid application unit 140 moves in the main scanning direction along the pair of guide shafts 133a and 133b. The liquid application unit 140 reciprocates in the main scanning direction in response to switching of the rotation direction of the liquid-applier movement motor 137.

The standby position sensor 138 detects that the liquid application unit 140 has reached a standby position HP1 (see FIGS. 41A and 41B) in the main scanning direction. The standby position sensor 138 then outputs a standby position signal indicating the detection result to the controller 100b, which will be described below with reference to FIG. 44. The standby position sensor 138 is, for example, an optical sensor including a light emitter and a light receiver. At the standby position HP, the liquid application unit 140 blocks an optical path between the light emitter and the light receiver. The standby position sensor 138 outputs the standby position signal in response to the light output from the light emitter not being received by the light receiver. The specific configuration of the standby position sensor 138 is not limited to the configuration described above.

As illustrated in FIGS. 42A, 42B, and 42C, the conveyance passage inside the post-processing apparatus 3A is defined by an upper guide plate 5a and a lower guide plate 5b, which are spaced apart from each other in the thickness direction of the sheet P. The liquid application unit 140 is located at a position to face an opening of the upper guide plate 5a. In other words, the liquid application unit 140 is disposed to face the conveyance passage (a position (at which the liquid application unit 140 is to face the sheet P conveyed along the conveyance passage) through the opening of the upper guide plate 5a.

As illustrated in FIGS. 41A to 43C, the liquid application unit 140 includes a base 141, a rotary bracket 142, a liquid storage tank 143, an application head mover 144, a holder 145, the liquid application head 146, columns 147a and 147b, a pressure plate 148, coil springs 149a and 149b, the application head pivot motor 150, the application head movement motor 151 (see FIG. 44), and a standby angle sensor 152 (see FIG. 44).

The base 141 is supported by the pair of guide shafts 133a and 133b so as to be slidable in the main scanning direction. The base 141 is coupled to the endless annular belt 135 by the connection 135a. The base 141 supports the components of the liquid application unit 140 such as the rotary bracket 142, the liquid storage tank 143, the application head mover 144, the holder 145, the liquid application head 146, the columns 147a and 147b, the pressure plate 148, the coil springs 149a and 149b, the application head pivot motor 150, the application head movement motor 151, and the standby angle sensor 152.

The rotary bracket 142 is attached to the lower face of the base 141 so as to be rotatable in the forward and reverse directions about a rotation shaft extending in the thickness direction of the sheet P. The rotary bracket 142 is rotated with respect to the base 141 by a driving force transmitted from the application head pivot motor 150. The rotary bracket 142 retains the liquid storage tank 143, the application head mover 144, the holder 145, the liquid application head 146, the columns 147a and 147b, the pressure plate 148, and the coil springs 149a and 149b.

The standby angle sensor 152, which is also illustrated in FIG. 44, detects that the rotary bracket 142 has reached a standby angle. The standby angle sensor 152 then outputs a standby angle signal indicating the detection result to the controller 100b. The standby angle is, for example, an angle for the parallel binding. The standby angle sensor 152 is, for example, an optical sensor including a light emitter and a light receiver. The rotary bracket 142 at the standby angle blocks an optical path between the light emitter and the light receiver. The standby angle sensor 152 outputs the standby angle signal in response to the light output from the light emitter not being received by the light receiver. The specific configuration of the standby angle sensor 152 is not limited to the configuration described above.

FIG. 41A illustrates the rotary bracket 142 in a position for the parallel binding that is performed by the crimper 32′ disposed downstream from the liquid applier 131 in a direction in which the sheet P is conveyed. FIG. 41B illustrates the rotary bracket 142 in a position for the oblique binding (i.e., corner binding) that is performed by the crimper 32′ disposed downstream from the liquid applier 131 in the direction in which the sheet P is conveyed.

The liquid storage tank 143 stores liquid to be applied to the sheet P. The application head mover 144 is attached by the liquid storage tank 143 so as to be movable (e.g., up and down) in the thickness direction of the sheet P. The application head mover 144 is moved with respect to the liquid storage tank 143 by a driving force transmitted from the application head movement motor 151. The holder 145 is attached to a lower end of the application head mover 144. The liquid application head 146 projects from the holder 145 toward the conveyance passage (downward in the present embodiment). The liquid that is stored in the liquid storage tank 143 is supplied to the liquid application head 146. The liquid application head 146 is made of a material having a relatively high liquid absorption (e.g., sponge or fiber).

The columns 147a and 147b project downward from the holder 145 around the liquid application head 146. The columns 147a and 147b are movable relative to the holder 145 in the thickness direction. The columns 147a and 147b have respective lower ends holding the pressure plate 148. The pressure plate 148 has a through hole 148a at a position where the through hole 148a faces the liquid application head 146. The coil springs 149a and 149b are fitted around the columns 147a and 147b, respectively, between the holder 145 and the pressure plate 148. The coil springs 149a and 149b bias the columns 147a and 147b and the pressure plate 148 in a direction away from the holder 145.

As illustrated in FIGS. 42A and 43A, before the sheet P is conveyed to the position where the sheet P faces the opening of the upper guide plate 5a, the pressure plate 148 is positioned at or above the opening. Subsequently, when the sheet P that is conveyed by the conveyance roller pairs 10 and 11 stops at a position where the first liquid application position B1 on the sheet P faces the opening, the application head movement motor 151 is rotated in a first direction. As a result, the application head mover 144, the holder 145, the liquid application head 146, the columns 147a and 147b, the pressure plate 148, and the coil springs 149a and 149b are moved down together to allow the pressure plate 148 to contact the sheet P. The first liquid application position B1 corresponds to the first binding position B1 to be crimped and bound by the edge binder 251, specifically, the crimper 32′.

As the application head movement motor 151 keeps rotating in the first direction after the pressure plate 148 contacts the sheet P, the coil springs 149a and 149b are compressed to further move down the application head mover 144, the holder 145, the liquid application head 146, and the columns 147a and 147b. As a result, as illustrated in FIGS. 42B and 43B, a lower face of the liquid application head 146 contacts the sheet P through the through hole 148a. Then, the liquid contained in the liquid application head 146 is applied to the sheet P.

Further rotation of the application head movement motor 151 in the first direction further strongly presses the liquid application head 146 against the sheet P as illustrated in FIGS. 42C and 43C. Accordingly, the amount of liquid that is applied to the sheet P increases. In short, the liquid applier 131 changes the pressing force of the liquid application head 146 against the sheet P to adjust the amount of liquid that is applied to the sheet P.

On the other hand, the rotation of the application head movement motor 151 in the second direction opposite to the first direction moves up the application head mover 144, the holder 145, the liquid application head 146, the columns 147a and 147b, the pressure plate 148, and the coil springs 149a and 149b together. As a result, as illustrated in FIGS. 42A and 43A, the liquid application head 146 and the pressure plate 148 are separated from the sheet P. In other words, the liquid applier 131 includes the liquid application head 146 that can be separated from the sheet P.

FIG. 44 is a block diagram illustrating a hardware configuration of the post-processing apparatus 3A to control the operation of the post-processing apparatus 3A according to the second embodiment. As illustrated in FIG. 44, the post-processing apparatus 3A includes a central processing unit (CPU) 101, a random-access memory (RAM) 102, a read-only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic device and controls the overall operation of the post-processing apparatus 3A. The RAM 102 is a volatile storage medium that allows data to be read and written at high speed. The CPU 101 uses the RAM 102 as a working area for data processing. The ROM 103 is a read-only non-volatile storage medium that stores programs such as firmware. The HDD 104 is a non-volatile storage medium that allows data to be read and written and has a relatively large storage capacity. The HDD 104 stores, for example, an operating system (OS), various control programs, and application programs.

The post-processing apparatus 3 processes, by an arithmetic function of the CPU 101, e.g., a control program stored in the ROM 103 and an information processing program (or application program) loaded into the RAM 102 from a storage medium such as the HDD 104. Such processing configures a software controller including various functional modules of the post-processing apparatus 3A. The software controller thus configured cooperates with hardware resources of the post-processing apparatus 3A to construct functional blocks that implement functions of the post-processing apparatus 3A. In other words, the CPU 101, the RAM 102, the ROM 103, the HDD 104, and the I/F 105 constitute at least part of a controller 100b serving as a control device that controls the operation of the post-processing apparatus 3A.

The I/F 105 is an interface that connects the conveyance roller pairs 10, 11, 14, and 15, the switching member 20, the side fences 24L and 24R, the crimper movement motor 238, the crimper pivot motor 239, a contact-separation motor 32d, a liquid applier movement motor 137, an application head pivot motor 150, an application head movement motor 151, a standby position sensor 138, a standby angle sensor 152, a hole punch 132, and an operation panel 110 to the common bus 109.

The controller 100b controls, via the I/F 105, the operations of the conveyance roller pairs 10, 11, 14, and 15, the switching member 20, the side fences 24L and 24R, the crimper movement motor 238, the crimper pivot motor 239, the contact-separation motor 32d, the liquid applier movement motor 137, the application head pivot motor 150, the application head movement motor 151, and the hole punch 132. The controller 100b acquires detection results from the standby position sensor 138 and the standby angle sensor 152 through the I/F 105.

Although FIG. 44 illustrates the components of the liquid applier 131 and the edge binder 251 (the crimper 32′) that executes the edge binding, the components of the saddle binder 28 that executes the saddle binding are controlled by the controller 100b like the components of the liquid applier 131 and the edge binder 251 (the crimper 32′) that executes the edge binding.

As illustrated in FIG. 46, the image forming apparatus 2 includes the operation panel 110. The operation panel 110 includes an operation device that receives instructions input by an operator and a display serving as a notifier that notifies the operator of information. The operation device includes, for example, physical input buttons and a touch screen overlaid on a display. The operation panel 110 acquires information from the user through the operation device and provides information to the user through the display. The post-processing apparatus 3A may include an operation panel 110 similar to the above-described operation panel 110 of the image forming apparatus 2.

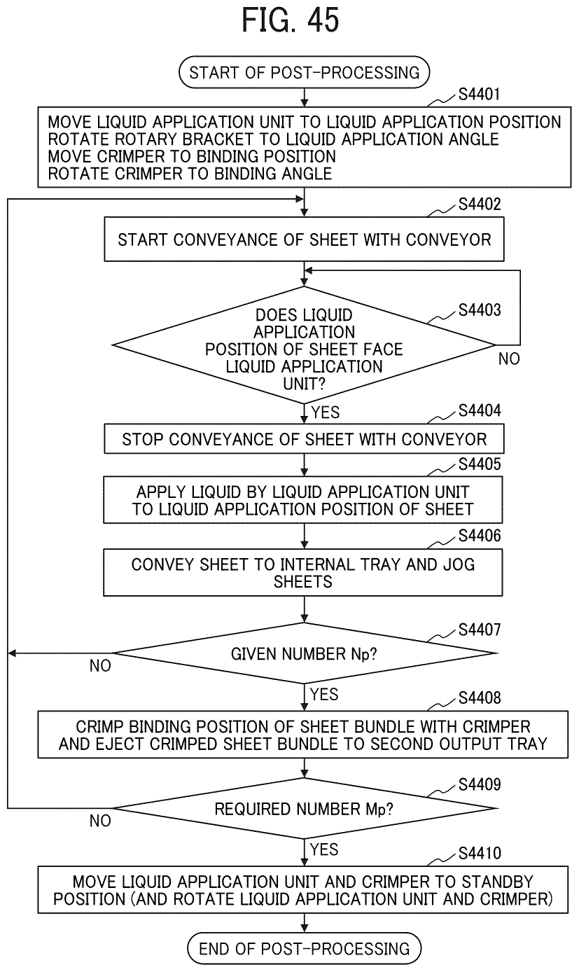

FIG. 45 is a flowchart of post-processing performed by the post-processing apparatus 3A according to the second embodiment. Specifically, FIG. 45 is a flowchart of a process to execute the one-point binding illustrated in FIGS. 39A, 39B, and 39C.

For example, the controller 100b executes the post-processing illustrated in FIG. 45 when the controller 100b acquires an instruction to execute the post-processing from the image forming apparatus 2. In the following description, the instruction to execute the post-processing may be referred to as a “post-processing command.” The post-processing command includes, for example, the number of sheets P of the sheet bundle Pb (referred to as “given number of sheets Np”), the number of sheet bundles Pb to be subjected to binding processing, the first binding position B1 (corresponding to the first liquid application position B1), the angle of the first binding position B1 (corresponding to the angle of the first liquid application position B1), the type of binding process (parallel binding process or oblique binding process), and a process that is executed in parallel with the liquid application process (i.e., punching a hole in the present embodiment). In the following description, the number of sheets P of the sheet bundle Pb may be referred to as a “given number of sheets Np,” and the number of sheet bundles Pb to be subjected to binding processing may be referred to as “requested number of copies Mp.” At the start of the post-processing, the liquid application unit 140 is at the standby position HP1 illustrated in FIGS. 41A and 41B, and the rotary bracket 142 is held at the standby angle (corresponding to the parallel binding posture) at the standby position HP1.

First, the controller 100b drives the liquid applier movement motor 137 to move the liquid application unit 140 (corresponding to a liquid applier) in the main scanning direction such that a liquid application head 146 moves from the standby position HP1 to a position where the liquid application head 146 can face the first liquid application position B1 (see FIG. 41B) corresponding to the first binding position B1 illustrated in FIGS. 39B and 39C. If the type of the binding process instructed by the post-processing command is “oblique binding process,” in step S4401, the controller 100b drives the application head pivot motor 150 to rotate the rotary bracket 142. Thus, the liquid application head 146 is rotated from the standby angle to the liquid application angle corresponding to the “oblique binding posture.” It is ascertained, based on a pulse signal output from a rotary encoder of the liquid applier movement motor 137, that the liquid application head 146 has reached the position where the liquid application head 146 can face the first liquid application position B1. Similarly, it is ascertained, based on a pulse signal output from a rotary encoder of the application head pivot motor 150, that the liquid application head 146 has reached the liquid application angle. If the type of the binding process instructed by the post-processing command is “parallel binding process”, the controller 100b omits the above-described operation of rotating the rotary bracket 142. In other words, the liquid application unit 140 moves in the main scanning direction while holding the rotary bracket 142 at the standby angle.

Further, the controller 100b drives the crimper movement motor 238 to move the crimper 32′ from the standby position HP2 to the position where the crimper 32′ can face the first binding position B1 as illustrated in FIGS. 39A and 39B (step S4401). Alternatively, if the type of the binding process instructed by the post-processing command is “oblique binding process,” in step S4401, the controller 100b drives the crimper pivot motor 239 to rotate the crimper 32′ from the standby angle to the crimping angle corresponding to the “oblique binding posture.” It is ascertained, based on a pulse signal output from a rotary encoder of the crimper movement motor 238, that the crimper 32′ has reached the position where the crimper 32′ can face the first binding position B1. Similarly, it is ascertained, based on a pulse signal output from a rotary encoder of the crimper pivot motor 239, that the crimper 32′ has reached the crimping angle. If the type of the binding process instructed by the post-processing command is “parallel binding process,” the controller 100b omits the above-described operation of rotating the crimper 32′. In other words, the crimper 32′ moves in the main scanning direction while maintaining the standby angle.

Subsequently, in step S4402, the controller 100b drives the conveyance roller pairs 10 and 11 to start conveying the sheet P on which an image is formed by the image forming apparatus 2. The controller 100b determines whether the first liquid application position B1 on the sheet P faces first the liquid application unit 140 (more specifically, the liquid application head 146) (step S4403). In other words, the controller 100b determines whether the liquid application unit 140 has faced the first liquid application position B1 on the sheet P. When the first liquid application position B1 on the sheet P has not faced the liquid application unit 140 (NO in step S4403), the controller 100b continues driving the conveyance roller pairs 10 and 11 until the first liquid application position B1 on the sheet P faces the liquid application unit 140 (YES in step S4403). When the controller 100b determines that the first liquid application position B1 on the sheet P has faced the liquid application head 146 (YES in step S4403), the controller 100b causes the conveyance roller pairs 10 and 11 (step S4403) to stop conveying the sheet P. It is ascertained, based on a pulse signal output from a rotary encoder of a motor that drives the conveyance roller pairs 10 and 11, that the first liquid application position B1 on the sheet P has faced the liquid application head 146.

The controller 100b causes the liquid application unit 140 to execute the process of applying liquid to the first liquid application position B1 on the sheet P (step S4405). More specifically, the controller 100b rotates the application-head movement motor 151 in the first direction to bring the liquid application head 146 into contact with the first liquid application position B1 on the sheet P. The controller 100b changes the pressing force of the liquid application head 146 (i.e., the amount of rotation or rotation speed of the application head movement motor 151) depending on the amount of liquid to be applied to the sheet P.

The amount of liquid that is applied to the sheet P may be the same for all the sheets P of the sheet bundle Pb or may be different for each sheet P. For example, the controller 100b may decrease the amount of liquid applied to a sheet P conveyed later. The amount of rotation of the application head movement motor 151 may be ascertained based on a pulse signal output from a rotary encoder of the application head movement motor 151.

In step S4406, the controller 100b drives the conveyance roller pairs 10, 11, 14, and 15 to place a sheet P on the internal tray 22. The controller 100b moves the side fences 24L and 24R in the main scanning direction to align the position of the sheet P or the sheet bundle Pb placed on the internal tray 22 in the main scanning direction (step S4402). In short, the controller 100b performs so-called jogging.

The controller 100b determines whether the number of sheets P placed on the internal tray 22 has reached the given number of sheets Np indicated by the post-processing command (step S4407). When the controller 100b determines that the number of sheets P placed on the internal tray 22 has not reached the given number of sheets Np (NO in step S4407), the controller 100b executes the operations of steps S4402 to S4407 again until the number of sheets P placed on the internal tray 22 reaches the given number of sheets Np (YES in step S4407).

By contrast, when the controller 100b determines that the number of sheets P that are placed on the internal tray 22 has reached the given number of sheets Np (YES in step S4407), the controller 100b causes the crimper 32′ to crimp the first binding position B1 (corresponding to the first liquid application position B1) on the sheet bundle Pb to which the liquid has been applied by the liquid application unit 140 (step S4408). In addition, in step S4408, the controller 100b rotates the conveyance roller pair 15 to eject the crimped sheet bundle Pb to the second ejection tray 26.

The controller 100b determines whether the number of sheet bundles Pb thus ejected to the second ejection tray 26 has reached the requested number of copies Mp indicated by the post-processing command (step S4409). When the controller 100b determines that the number of the sheet bundles Pb ejected to the second ejection tray 26 has not reached the requested number of copies Mp (NO in step S4409), the controller 100b repeats the processing of steps S4402 to S4409 until the number of the sheet bundles Pb ejected to the second ejection tray 26 reaches the requested number of copies Mp (YES in step S4409).

When the controller 100b determines that the number of sheet bundles Pb ejected to the second ejection tray 26 reaches the requested number of copies Mp (YES in step S4409), the controller 100b drives the liquid applier movement motor 137 to move the liquid application unit 140 to the standby position HP1 (see FIG. 41B) and drives the crimper movement motor 238 to move the crimper 32′ to the standby position HP2 (see FIG. 39A) (step S4410). When the posture that is instructed by the post-processing operation is the “oblique binding posture,” the controller 100drives the application head pivot motor 150 and the crimper pivot motor 239 to rotate the liquid application unit 140 and crimper 32′ and the parallel binding posture (standby angle) into the parallel binding posture (step S4410). By contrast, when the posture that is instructed by the post-processing command is the “parallel binding posture,” the controller 100b skips the aforementioned operation of rotating the liquid application unit 140 and the crimper 32′ to the parallel binding posture (standby angle). In steps S4401 and S4410, the execution order of the movement in the main scanning direction and the rotation in the forward and reverse directions of the liquid application unit 140 and the crimper 32′ is not limited to the aforementioned order and may be reversed.

The embodiments of the present disclosure are applied to the edge binder 25 that executes the edge stitching as described above. However, the embodiments of the present disclosure may be applied to the saddle binder 28 that executes the saddle stitching.

The controller 100b of the post-processing apparatus 3A according to the second embodiment illustrated in FIG. 38 is provided separately from the controller 100a of the image forming apparatus 2 as in the configuration of FIG. 1. However, embodiments of the present disclosure are not limited to the above-described configuration. For example, as illustrated in FIG. 47A, the controller 100b of the post-processing apparatus 3 may be disposed in the image forming apparatus 2. Further, as in the configuration of FIG. 47B, the controller 100b of the post-processing apparatus 3 may be integrated with the controller 100a of the image forming apparatus 2.

As in the configuration of FIG. 48A, the controller 100b of the post-processing apparatus 3A may be divided into a controller 100b1 (e.g., a driver system such as a motor) and a controller 100b2 (a detector such as a sensor) according to the function, and the controller 100b2 of the post-processing apparatus 3A may be disposed in the image forming apparatus 2. Further, as in the configuration of FIG. 48B, the controller 100b2 of the post-processing apparatus 3A disposed in the image forming apparatus 2 may be integrated with the controller 100a of the image forming apparatus 2.

As described above, the control method by the controller 100b described above is implemented by cooperation between hardware resources of a computer and a program as computer software. In other words, the control method may be executed by causing an arithmetic device, a storage device, an input device, an output device, and a control device to operate in cooperation with each other based on a program. The program may be written in, for example, a storage device or a storage medium and distributed with the storage device or the storage medium, or may be distributed through, for example, an electric communication line.

Embodiments of the present disclosure are not limited to the above-described embodiments and modifications, and numerous additional modifications and variations are possible in light of the teachings. The technical contents included in the technical ideas described in the appended claims are included within the technical scope of the appended claims. It is therefore to be understood that the above-described embodiments of the present disclosure may be practiced otherwise by those skilled in the art than as specifically described herein. Such modifications and variations are included in the technical scope described in the appended claims.

### Aspects of the Present Disclosure Are, for Example, As Follows.

### First Aspect

A media processing apparatus includes: a liquid applier including a liquid applying member to apply liquid to a medium; a post-processing device to process a plurality of media including the medium to which the liquid has been applied by the liquid applier; a first liquid storage to store the liquid applied to the medium by the liquid applier; a liquid supply portion including: a distal end connected to the liquid applying member; and a base end to be immersed in the liquid stored in the first liquid storage; and a first liquid-level detector to detect a liquid level of the liquid stored in the first liquid storage, the first liquid-level detector including: a first liquid-level detecting member; a second liquid-level detecting member; and a third liquid-level detecting member. A lower end of the second liquid-level detecting member and a lower end of the third liquid-level detecting member are disposed in substantially a same range including a position of the base end of the liquid supply portion in a vertical direction. A lower end of the first liquid-level detecting member is disposed above substantially the same range.

### Second Aspect

A media processing apparatus includes: a liquid applier including a liquid applying member to apply liquid to a medium; a post-processing device to process a plurality of media including the medium to which the liquid has been applied by the liquid applier; a first liquid storage to store the liquid applied to the medium by the liquid applier; a liquid supply portion including: a distal end connected to the liquid applying member; and a base end to be immersed in the liquid stored in the first liquid storage; and a first liquid-level detector to detect a liquid level of the liquid stored in the first liquid storage, the first liquid-level detector including: a first liquid-level detecting member; a second liquid-level detecting member; and a third liquid-level detecting member. A lower end of the second liquid-level detecting member is disposed in substantially a same range including a position of the base end of the liquid supply portion in a vertical direction. A lower end of the first liquid-level detecting member is disposed above substantially the same range. A lower end of the third liquid-level detecting member is disposed below substantially the same range.

### Third Aspect

The media processing apparatus according to the first or second aspect further includes: a second liquid storage to store the liquid supplied to the first liquid storage; a liquid supplier to perform a liquid supply operation of supplying the liquid from the second liquid storage to the first liquid storage; and a controller to cause the liquid supplier to perform the liquid supply operation based on an operation mode defining the liquid supply operation. When the operation mode is a filling supply operation, the controller continues the liquid supply operation until the liquid is detected between the first liquid-level detecting member and the second liquid-level detecting member, stops the liquid supply operation from when the liquid is detected between the first liquid-level detecting member and the second liquid-level detecting member until a supply waiting time in which the liquid is supplied to the liquid applying member through the liquid supply portion elapses, and causes the liquid supplier to perform the liquid supply operation again when the liquid is not detected between the first liquid-level detecting member and the second liquid-level detecting member after the supply waiting time elapses.

### Fourth Aspect

In the media processing apparatus according to the third aspect, when the operation mode is an additional supply operation, the controller continues the liquid supply operation until the liquid is detected between the first liquid-level detecting member and the second liquid-level detecting member, and stops the liquid supply operation when the liquid is detected between the first liquid-level detecting member and the second liquid-level detecting member.

### Fifth Aspect

In the media processing apparatus according to the third or fourth aspect, the controller changes the supply waiting time based on whether the liquid is detected between the second liquid-level detecting member and the third liquid-level detecting member.

### Sixth Aspect

In the media processing apparatus according to the fourth aspect, the controller sets the operation mode to the filling supply operation when the liquid is not detected between the second liquid-level detecting member and the third liquid-level detecting member, and sets the operation mode to the additional supply operation when the liquid is detected between the second liquid-level detecting member and the third liquid-level detecting member.

### Seventh Aspect

In the media processing apparatus according to any one of the third to sixth aspects, when the liquid is not detected between the first liquid-level detecting member and the second liquid-level detecting member after a supply time has elapsed from a start of the liquid supply operation, the controller determines that the first liquid-level detector is abnormal and stops the liquid supply operation.

### Eighth Aspect

The media processing apparatus according to any one of the third to seventh aspects further includes: a liquid storage fixer connected to the first liquid storage via the liquid supplier, the second liquid storage detachably attached to the liquid storage fixer; and a second liquid-level detector to detect a liquid level of the liquid stored in the liquid storage fixer. The second liquid-level detector includes at least three liquid-level detecting members.

### Ninth Aspect

In the media processing apparatus according to the eighth aspect, the second liquid-level detector further includes, as the liquid-level detecting members, a fourth liquid-level detecting member, a fifth liquid-level detecting member, and a sixth liquid-level detecting member. A lower end of the fourth liquid-level detecting member is disposed above a lower end of the fifth liquid-level detecting member and a lower end of the sixth liquid-level detecting member. The lower end of the fifth liquid-level detecting member is disposed above or at a same height as the lower end of the sixth liquid-level detecting member.

### Tenth Aspect

In the media processing apparatus according to the ninth aspect, the fourth liquid-level detecting member is shorter than the fifth liquid-level detecting member and the sixth liquid-level detecting member. The fifth liquid-level detecting member is shorter than or equal in length to the sixth liquid-level detecting member.

### Eleventh Aspect

The media processing apparatus according to the ninth aspect further includes a notifier to notify information. The controller causes the notifier to notify replenishment of the second liquid storage when the liquid is not detected between the fifth liquid-level detecting member and the sixth liquid-level detecting member.

### Twelfth Aspect

The media processing apparatus according to any one of the eighth to eleventh aspects further includes a setting detector to detect that the second liquid storage is set in the liquid storage fixer. When the setting detector detects that the second liquid storage is set in the liquid storage fixer, the controller causes the liquid supplier to perform the liquid supply operation when the first liquid-level detector does not detect the liquid in the first liquid storage, and does not cause the liquid supplier to perform the liquid supply operation when the first liquid-level detector detects the liquid in the first liquid storage.

### Thirteenth Aspect

In the media processing apparatus according to any one of the ninth to eleventh aspects, the controller causes the liquid supplier to perform a liquid discharge operation for discharging the liquid from the first liquid storage toward the liquid storage fixer, when the liquid is not detected between the fourth liquid-level detecting member and the fifth liquid-level detecting member.

### Fourteenth Aspect

An image forming system includes: the media processing apparatus according to any one of the first to eleventh aspects; and an image forming apparatus to form an image on the medium.

According to this, it is possible to provide a liquid discharge apparatus that increases the number of nozzles per unit area and reducing the crosstalk. The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

This patent application is based on and claims priority to Japanese Patent Application Nos. 2023-090506, filed on May 31, 2023, and 2024-060765, filed on Apr. 4, 2024, in the Japan Patent Office, the entire disclosure of each of which is hereby incorporated by reference herein.

### REFERENCE SIGNS LIST

1: Image forming system
2: Image forming apparatus
3: Post-processing apparatus
3: Post-processing apparatus
10 to 19: Conveyance roller pairs
21: First ejection tray
26: Second ejection tray
30: Third ejection tray
22: Internal Tray
25: Edge binder
31: Liquid applier
32: Crimper
43: First liquid-level detector
58: Second liquid-level detector
44: First liquid storage tank
46: Liquid supply pump
47: Second liquid storage tank
50: Liquid supply member
51: Setting detection sensor
61: Second liquid storage tank fixer
110: Operation panel
431: First liquid-level detection sensor
432: Second liquid-level detection sensor
433: Third liquid-level detection sensor
581: Fourth liquid-level detection sensor
582: Fifth liquid-level detection sensor
583: Sixth liquid-level detection sensor

1. A media processing apparatus, comprising:
a liquid applier including a liquid applying member, the liquid applier configured to apply liquid to a medium;
a post-processing device configured to process a plurality of media including the medium to which the liquid has been applied;
a first liquid storage configured to store the liquid applied to the medium;
a liquid supply portion including:
a distal end connected to the liquid applying member, and
a base end configured to be immersed in the liquid stored in the first liquid storage; and
a first liquid-level detector configured to detect a liquid level of the liquid stored in the first liquid storage, the first liquid-level detector including:
a first liquid-level detecting member,
a second liquid-level detecting member, and
a third liquid-level detecting member, wherein
a lower end of the second liquid-level detecting member and a lower end of the third liquid-level detecting member are in a substantially same range including a position of the base end of the liquid supply portion in a vertical direction, and
a lower end of the first liquid-level detecting member is above the substantially same range.

2. A media processing apparatus, comprising:
a liquid applier including a liquid applying member, the liquid applier configured to apply liquid to a medium;
a post-processing device configured to process a plurality of media including the medium to which the liquid has been applied;
a first liquid storage configured to store the liquid applied to the medium;
a liquid supply portion including:
a distal end connected to the liquid applying member, and
a base end configured to be immersed in the liquid stored in the first liquid storage; and
a first liquid-level detector configured to detect a liquid level of the liquid stored in the first liquid storage, the first liquid-level detector including:
a first liquid-level detecting member,
a second liquid-level detecting member, and
a third liquid-level detecting member, wherein
a lower end of the second liquid-level detecting member is disposed in a substantially same range including a position of the base end of the liquid supply portion in a vertical direction,
a lower end of the first liquid-level detecting member is above the substantially same range, and
a lower end of the third liquid-level detecting member is below the substantially same range.

3. The media processing apparatus according to claim 1, further comprising:
a second liquid storage configured to store the liquid supplied to the first liquid storage;
a liquid supplier configured to perform a liquid supply operation of supplying the liquid from the second liquid storage to the first liquid storage; and
processing circuitry configured to cause the liquid supplier to perform the liquid supply operation based on an operation mode defining the liquid supply operation, wherein
in response to the operation mode being a filling supply operation, the processing circuitry is further configured to continue the liquid supply operation until the liquid is detected between the first liquid-level detecting member and the second liquid-level detecting member,
stop the liquid supply operation in response to the liquid being detected between the first liquid-level detecting member and the second liquid-level detecting member until a supply waiting time elapses, the supply waiting time being a time in which the liquid is supplied to the liquid applying member through the liquid supply portion, and
cause the liquid supplier to perform the liquid supply operation again in response to the liquid not being detected between the first liquid-level detecting member and the second liquid-level detecting member after the supply waiting time elapses.

4. The media processing apparatus according to claim 3, wherein in response to the operation mode being an additional supply operation, the processing circuitry is further configured to:
continue the liquid supply operation until the liquid is detected between the first liquid-level detecting member and the second liquid-level detecting member; and
stop the liquid supply operation in response to the liquid being detected between the first liquid-level detecting member and the second liquid-level detecting member.

5. The media processing apparatus according to claim 3, wherein the processing circuitry is further configured to:
change the supply waiting time based on whether the liquid is detected between the second liquid-level detecting member and the third liquid-level detecting member.

6. The media processing apparatus according to claim 4, wherein the processing circuitry is further configured to:
set the operation mode to the filling supply operation in response to the liquid not being detected between the second liquid-level detecting member and the third liquid-level detecting member; and
set the operation mode to the additional supply operation in response to the liquid being detected between the second liquid-level detecting member and the third liquid-level detecting member.

7. The media processing apparatus according to claim 3, wherein in response to the liquid not being detected between the first liquid-level detecting member and the second liquid-level detecting member after a supply time has elapsed from a start of the liquid supply operation;
the processing circuitry is further configured to determine that the first liquid-level detector is abnormal and stops the liquid supply operation.

8. The media processing apparatus according to claim 3, further comprising:
a liquid storage fixer connected to the first liquid storage via the liquid supplier, the second liquid storage detachably attached to the liquid storage fixer; and
a second liquid-level detector configured to detect a liquid level of the liquid stored in the liquid storage fixer,
wherein the second liquid-level detector includes at least three liquid-level detecting members.

9. The media processing apparatus according to claim 8, wherein
the second liquid-level detector further includes a fourth liquid-level detecting member, a fifth liquid-level detecting member, and a sixth liquid-level detecting member;
a lower end of the fourth liquid-level detecting member is above a lower end of the fifth liquid-level detecting member and a lower end of the sixth liquid-level detecting member; and
the lower end of the fifth liquid-level detecting member is above or at a same height as the lower end of the sixth liquid-level detecting member.

10. The media processing apparatus according to claim 9, wherein
the fourth liquid-level detecting member is shorter than the fifth liquid-level detecting member and the sixth liquid-level detecting member; and
the fifth liquid-level detecting member is shorter than or equal in length to the sixth liquid-level detecting member.

11. The media processing apparatus according to claim 9, further comprising:
a notifier configured to output notification information,
wherein the processing circuitry is further configured to cause the notifier to notify replenishment of the second liquid storage the liquid not being detected between the fifth liquid-level detecting member and the sixth liquid-level detecting member.

12. The media processing apparatus according to claim 8, further comprising:
a setting detector configured to detect that the second liquid storage is set in the liquid storage fixer,
wherein in response to the setting detector detecting that the second liquid storage is set in the liquid storage fixer, the processing circuitry is further configured to,
cause the liquid supplier to perform the liquid supply operation in response to the first liquid-level detector not detecting the liquid in the first liquid storage, and
does not cause the liquid supplier to perform the liquid supply operation in response to the first liquid-level detector detecting the liquid in the first liquid storage.

13. The media processing apparatus according to claim 9, wherein the processing circuitry is further configured to cause the liquid supplier to perform a liquid discharge operation in response to the liquid not being detected between the fourth liquid-level member and the fifth liquid-level detecting member, the liquid discharge operation including discharging the liquid from the first liquid storage toward the liquid storage fixer.

14. An image forming system, comprising:
the media processing apparatus according to claim 1; and
an image forming apparatus configured to form an image on the medium.
